(19) United States
(12) Patent Application Publication
(10) Pub. No.: US 2015/0145406 A1
(43) Pub. Date: May 28, 2015

(54) SOLID-STATE LINEAR LIGHTING ARRANGEMENTS INCLUDING LIGHT EMITTING PHOSPHOR

(71) Applicant: Intematix Corporation, Fremont, CA (US)

(72) Inventors: Yi-Qun Li, Danville, CA (US); Haitao Yang, San Jose, CA (US); Hyung-Chul Lee, Fremont, CA (US); Charles Edwards, Pleasanton, CA (US)

(73) Assignee: Intematix Corporation, Fremont, CA (US)

(21) Appl. No.: 14/607,032

(22) Filed: Jan. 27, 2015

Related U.S. Application Data
(63) Continuation-in-part of application No. 14/157,501, filed on Jan. 16, 2014.
Application No. 14/157,501 is a continuation-in-part of application No. 13/931,669, filed on Jun. 28, 2013.
(60) Provisional application No. 61/932,231, filed on Jan. 27, 2014.
(60) Provisional application No. 61/665,843, filed on Jun. 28, 2012.

(51) Int. Cl. B29C 47/00; F21V 9/16

(52) U.S. Cl. CPC B29C 47/0004; F21V 9/16; F21Y 2101/02
USPC 313/502; 264/1.7

(57) ABSTRACT

A method is described for manufacturing an LED lamp module, where the individual LEDs in the lamp module do not include a conventional package structure and/or integrated encapsulation on the individual LEDs. The lamp module includes a co-extruded component, the co-extruded component comprising an elongate lens and a layer of photoluminescent material. The elongate lens is for shaping light emitted from the lamp and comprises an elongate interior cavity. The layer of a photoluminescent material is located on an interior wall of the elongate interior cavity. An optical medium is provided as part of the manufacturing process for the lamp module, where the optical medium surrounds the LEDs in an array of LEDs. The optical medium can be co-extruded over the LEDs. In addition, a liquid optical medium can be applied in the assembly process to remove air interfaces between the LEDs and component.

### CROSS REFERENCE TO RELATED APPLICATIONS

This application claims the benefit of U.S. Provisional Application No. 61/932,231, filed on Jan. 27, 2014, and is also a continuation-in-part of U.S. application Ser. No. 14/157,501, filed on Jan. 16, 2014, which is a continuation-in-part of U.S. application Ser. No. 13/931,669, filed on Jun. 28, 2013, which claims the benefit of U.S. Provisional Application No. 61/665,843, filed on Jun. 28, 2012, all of which are hereby incorporated by reference in their entireties.

### BACKGROUND OF THE INVENTION

1. Field of the Invention

This invention relates to solid-state linear lighting applications which comprise a light emitting phosphor, photoluminescent material, to generate light of a desired color that is in a different part of the wavelength spectrum from the solid-state light emitter(s). In particular, although not exclusively, the invention concerns LED-based lighting arrangements which generate light in the visible part of the spectrum and in particular, although not exclusively white light. Moreover the invention provides an optical component for such a lighting arrangement and methods of fabricating a lighting arrangement and an optical component.

2. State of the Art

White light emitting diodes (LEDs) are known in the art and are a relatively recent innovation. It was not until LEDs emitting in the blue/ultraviolet of the electromagnetic spectrum were developed that it became practical to develop white light sources based on LEDs. As is known, white light generating LEDs (“white LEDs”) include a phosphor that is a photoluminescent material, which absorbs a portion of the radiation emitted by the LED and re-emits radiation of a different color (wavelength). For example the LED emits blue light in the visible part of the spectrum and the phosphor re-emits yellow light. Alternatively the phosphor can emit a combination of green and red light, green and yellow or yellow and red light. The portion of the visible blue light emitted by the LED which is not absorbed by the phosphor mixes with the yellow light emitted to provide light which appears to the eye as being white. It is predicted that white LEDs could potentially replace incandescent light sources due to their long operating lifetimes, typically many 100,000 of hours, and their high efficiency. Already high brightness LEDs are used in vehicle brake lights and indicators as well as traffic lights and flash lights.

To increase the intensity of light emitted from an LED it is known to include a lens made of a plastics material or glass to focus the light emission and to thereby increase intensity. Referring to FIG. 1 a high brightness white LED 2 is shown. The LED 2 comprises an LED chip 4 which is mounted within a plastic or metal reflection cup 6 and the LED chip is then encapsulated within an encapsulating material, typically an epoxy resin 8. The encapsulation material includes the phosphor material for providing color conversion. Typically the inner surface of the cup 6 is silvered to reflect stray light towards a lens 10 which is mounted on the surface of the encapsulating epoxy resin 8.

It is appreciated that such an arrangement has limitations and the present invention arose in an endeavor to mitigate, at least in part, these limitations. For example for high intensity LEDs having a high intensity output larger than 1 W, the high temperature at the output of the LED combined with its close proximity the phosphor material can give rise to a light characteristic which is temperature dependent and in some cases thermal degradation of the phosphor material can occur. Moreover the uniformity of color of light emitted by such LEDs can be difficult to maintain with the phosphor distributed within the epoxy resin since light passing through different path lengths will encounter and be absorbed by differing amounts of phosphor. Furthermore the fabrication of such LEDs is time consuming due to the encapsulation and subsequent placement of the lens.

### SUMMARY OF THE INVENTION

In accordance with some embodiments, a method is provided for manufacturing an LED lamp module, where the individual LEDs in the lamp module do not include a conventional package structure and/or integrated encapsulation on the individual LEDs. According to an embodiment of the invention a method of fabricating a lamp module comprises extruding an elongated wavelength conversion component onto an array of LEDs, wherein the elongated optical component comprises a photoluminescent wavelength conversion material such as a phosphor. The wavelength conversion component can further comprise an optical layer, such as for example a lens, and an optical medium that surrounds the LEDs. The various portions of the elongated wavelength conversion component are preferably co-extruded onto the array of LEDs. The optical layer can be for shaping light emitted from the lamp module and can comprise an elongated interior cavity. The photoluminescent material can be provided as a layer located on an interior wall of the elongate interior cavity.

An optical medium is provided as part of the manufacturing process for the lamp module, where the optical medium surrounds the LEDs in an array of LEDs. The optical medium can be co-extruded over the LEDs. In addition, a liquid optical medium can be applied in the assembly process to remove air interfaces between the LEDs and co-extruded component.

The present embodiment finds utility in the manufacture of an LED-based lighting device that does not require conventional LED packaging structures. For example, instead of requiring conventional LED packages that include a costly encapsulant, lamps can be implemented using lamp modules having LEDs that do not require integrated encapsulant. Instead, the LEDs are mounted onto a substrate without requiring much of the conventional packaging structures.

In addition, a separate encapsulant is not provided as part of the LED in the present approach. Instead, the lamp module is manufactured such that chamber is sufficiently filled with an optical medium to remove the need to separately encapsulate the LED with an encapsulant. This means that the optical medium within the chamber will provide the necessary material to eliminate air interfaces that exist between the LEDs and the phosphor, which reduces and/or eliminates any mismatches between the index of refraction of the material of the phosphor and the index of refraction of the LEDs.

According to some embodiments, an improved method is provided for manufacturing a white light module and/or lamp. The method is particularly appropriate for manufacture of a linear lamp module, although usable to manufacture modules for other types of lamps as well.

In one embodiment, the method receives a linear array of LEDs. The linear array of LEDs is provided without requiring the individual LEDs to be placed into conventional packaging structures. Instead, the array of LEDs may be directly provided on a substrate as bare chips. The array of LEDs on the substrate are appropriately wired and connected together. The next manufacturing step is to co-extrude the multi-layer photoluminescent conversion component onto the linear array of LEDs. This creates the linear light module that is usable within a linear lamp. A co-extrusion process can be used to perform this manufacturing step. In this approach, multiple extruders feed into a single extrusion head to create the white light module.

A first extruder processes the material for the lens portion of the white light module. A light diffusing/scattering material can be used in conjunction with the multi-layered optic component, e.g., by placing the light diffusing/scattering material into the lens. The light diffusing/scattering material is useful to reduce the quantity of phosphor material that is required to generate a selected color of emitted light. The light diffusing/scattering material can also be useful to improve the off-state white appearance of the lamp. A second extruder processes the material for the photoluminescent (phosphor) portion of the white light module. Therefore, the second extruder can be used to process a polymer material that also includes the phosphor material. A third extruder processes the material for the optical medium. The third extruder is used to process a solid material (e.g., clear polymer), that possesses an index of refraction that more closely matches the index of refraction for the phosphor and the LEDs. The material for the optical medium may be selected from any suitable material, e.g. silicone, to generally fall within or match the index of refraction for materials typically used for the phosphor and the LEDs. A fourth extruder can be used to process material for a reflector. The fourth extruder is therefore used to process a light reflective material, e.g., a light reflective polymer that is typically white in color.

The extruders are used to feed their respective materials into a single extruder head to create the multiple portions of materials in the multi-layer conversion component of the white light module. A linear array of LEDs on a substrate (Typically the substrate flexible, though it can be rigid) is also fed into the extruder head. The phosphor portion, lens portion, optical medium portion, and reflector portion are integrally created and shaped around and over the linear array of LEDs on the substrate.

The method can also be used to manufacture a white light module where the LEDs are provided on a Chip-On-Wire structure, instead of providing the LEDs on a solid substrate. In the current embodiment, the packaged LED structure on the Chip-On-Wire structure is provided without integrated encapsulant, since an optical medium portion is manufactured as part of the white light module. However, in alternative embodiments, encapsulant is provided as part of the packaged LED structure. When performing co-extrusion, the Chip-On-Wire structure is fed into the extruder head where the phosphor portion, lens portion, optical medium portion, and reflector portion are integrally created and shaped around and over the linear array of LEDs on the Chip-On-Wire structure to form the final layers and shapes of the white light module. In some embodiments, the optical medium portion is extruded to conform to the shape of the LEDs on the Chip-On-Wire structure so that an encapsulation does not necessarily need to be included on the packaged LED structure of the Chip-On-Wire structure. However, this manufacturing process is also usable even if encapsulation is integrally included on the packaged LED structure of the Chip-On-Wire structure. The flexible nature of the Chip-On-Wire structure permits the linear array of LEDs to be fed into the extruder head from a spooled storage structure for the Chip-On-Wire structure.

An alternative method for manufacturing a white light module is provided, where the LEDs do not include the LEDs in a conventional package structure and/or where the LEDs do not include an integrated encapsulant. This embodiment is used when it is not desirable or possible to co-extrude the entirety of the white light module to include the array of LEDs. Instead, the multi-layered optic component is separately manufactured from the array of LEDs, and the array of LEDs is later affixed to the multi-layered optic component. The method receives a linear array of LEDs, where the linear array of LEDs is provided without integrated encapsulant being placed onto the array of LEDs. Instead, the array of LEDs may be provided on a substrate as bare chips. The array of LEDs on the substrate are appropriately wired and connected together. The next step is to manufacture the multi-layer conversion component. The multi-layered optic components include a channel that is formed within the optical medium. The channel is sized and shaped to match the profile of the LEDs, so that the multi-layered optic component can properly receive the linear array of LEDs during later stages of the manufacturing process. The next manufacturing step is to apply a liquid optical medium to the linear array of LEDs and/or to the channel. The liquid optical medium is provided in sufficient quantities to fill any gaps between the LEDs and optical component in the final lamp module. The next step is to mount the linear array of LEDs to the multi-layer conversion component, where the LEDs themselves are received into the channel in the multi-layer conversion component. The liquid optical medium is then cured, e.g., by using any appropriate method such as application of heat or UV light.

An alternative embodiment is provided for manufacturing a white light module where the LEDs do not need to be provided in a conventional package structure or provided to include an integrated encapsulant. This embodiment is also used in the situation where it is not desirable or possible to co-extrude the entirety of the white light module to include the array of LEDs. Instead, the multi-layered optic component is separately manufactured from the array of LEDs, and the array of LEDs is later affixed to the multi-layered optic component.

The method receives a linear array of LEDs, where the linear array of LEDs is provided without integrated encapsulant being placed onto the individual LEDs on the array of LEDs. The next step is to manufacture the multi-layer conversion component. However, unlike the previously described embodiments, the multi-layered optic component does not include an optical medium portion. Instead, the multi-layered optic component is manufactured to leave an open chamber within the phosphor portion. The next manufacturing step is to fill the cavity with a liquid optical medium, which is provided in sufficient quantities to make sure that air gaps will not exist in the finished product. The linear array of LEDs is attached to the multi-layer conversion component, where the LEDs themselves are received into the chamber containing the liquid optical medium. The liquid optical medium is then cured, e.g., by using any appropriate method such as application of heat or UV light.

In accordance with an embodiment of the invention, a linear lighting arrangement is provided/manufactured which includes a linear transparent optical portion that serves to mix and distribute of lights emitted from LED(s) and phosphor. The phosphor layer is in a curved shape within an interior cavity of the linear optical portion. The LED(s) on a linear substrate (e.g. Printed Circuit Board—PCB) is located remotely from the phosphor layer. In some embodiments, the lens optical portion is preferably manufactured with a rough surface for efficient extraction of light. The linear lighting arrangement may be referred to herein by example as a “linear lamp”.

In some embodiments, a linear lamp comprises an array of LED chips mounted on a support, e.g. a PCB that fits within inside indentations/slots on the optical portion (lens), where an inner cavity/chamber is formed in the interior of the optical portion (lens). The walls of the chamber include a layer of phosphor. The surface of the circuit board may be formed or covered with a reflective material to reflect light from the LED chip away from the circuit board and towards the phosphor. The light emitted by the LED chip is converted by the phosphor into photoluminescent light, and the color quality of the final light emission output of the lamp is based (at least in part) upon the combination of the wavelength of the photoluminescent light emitted by the phosphor with the wavelength of any remaining light from the LED chip that pass through the phosphor. The color of light emitted from the lighting arrangement can be controlled by appropriate selection of the phosphor composition as well as the thickness and/or loading of phosphor within the phosphor layer which will determine the proportion of output light originating from the phosphor. To ensure a uniform output color the phosphor layer is preferably of uniform thickness.

The arrangement and shape of the optical portion (lens) may be configured to affect the actual pattern of the emitted light from the lamp. The lens in some embodiments has a semi-circular profile that permits focusing and distribution of the emitted light output from lamp in desired directions, e.g. for a range of coverage substantially corresponding to the radial angles of the lens from a center axis of the lamp. The lens can be made of any suitable material, e.g. a plastics material such as polycarbonates, acrylic, silicone or glass such as silica based glass or any material.

The arrangement and shape of the phosphor may be configured to affect the distribution of the emitted light from the lamp. Some embodiments provide for a conical profile for the phosphor that enhances the amount of light that is distributed from the sides of the lamp. An alternate design is directed to a lamp in which the phosphor has a profile that is more semi-circular in nature, rather than conical, which provides relatively greater distributions of light towards the center of the distribution area. The exact shape of the phosphor and/or the lens can be selected and combined to provide any suitable output pattern and distribution as desired. Another benefit is that the lens also serves to provide a chamber in which light is mixed within highly transparent solid with minimal loss. An example of this occurs when a lamp includes both red and blue LEDs in the chamber, and the chamber allows the light from these LEDs (e.g., the red light) to be uniformly distributed inside the lens.

In some embodiments, the chamber in the lens provides a cavity within the lamp, which has a volume that is large enough for insertion of the array of LEDs within the cavity. This permits the LED to be located, wholly or partially, within the interior of the lens and/or phosphor. The approach of implementing a cavity/chamber within the lens makes for very simple assembly and improved efficiency due to avoiding losses from an exterior mixing chamber.

Some embodiments implement the optical material of the lens with a clear or transparent property provides the benefit of creating a linear optic/linear lens. Alternatively, the lens can be configured to operate as a light pipe that provides collimation at the light source so the light travels inside the pipe for an extended distance without exiting the sides. The optical component can be configured with appropriately curved sides to provide collimation functionality. In an alternative embodiment the lens is not configured to extend along the entire length of the reflector. Instead, the lens generally forms a curved or dome-like shape that only partially fills the interior volume formed by the reflector. A co-extrusion process can be used to manufacture the structure of the phosphor layer, lens, and reflector. The concept of co-extruding the phosphor and optical portion as a single component is considered inventive in its own right.

In some embodiments, further operating efficiencies for the lamp are provided by including an optical medium within the chamber, e.g., a solid optical medium. The optical medium within the chamber comprises a material possessing an index of refraction that more closely matches the index of refraction for the phosphor, the LEDs, and/or any type of encapsulating material that may exist on top of the LEDs. The optical medium may be selected of a material, e.g. silicone, to generally fall within or match the index of refraction for materials typically used for the phosphor, the LEDs, and/or any encapsulating material that be used to surround the LEDs. In some embodiments, the lamp structure comprises a multi-layered “sandwich” structure in which a specific shape of the phosphor layer is embedded between a front lens and solid fill inside the chamber. This structure can be manufactured by, for example, co-extrusion of all three layers.

Some embodiments of a linear lamp include an elongate lens having an integrally formed chamber that runs the length of the optical portion (lens), where the chamber is shaped to provide a desired light distribution pattern. A linear array of LEDs is located on a circuit board, and a reflective material is provided which include apertures for the LEDs. The circuit board is mounted onto a heat sink. The assembly comprising the heat sink, circuit board, and reflective material is attached to the lens using a pair of endplates to be set at indented end portions of the lens. In embodiments where the linear lamp is intended to be direct replacements for standard fluorescent lamps, end caps are provided which include appropriate connectors such as a G5 or G13 bi-pin connectors to fit into standard fluorescent lamp fixtures. External reflectors may also be used in conjunction with the lamp to direct output light into desired directions.

The angle of coverage for the lens is configurable to adjust the illumination pattern of the lamp. Increasing the angle of coverage to 360 degrees would result in a lamp having a full 360 degrees of illumination. The bottom portion of the lens is configured such that the lens provides a semi-circular profile having and illumination angle, e.g., at a radial angle at greater than or less than 180 degrees relative to a central axis of the lamp. The angle of the bottom portion of the lens can also be adjusted to adjust the illumination pattern of the lamp, which is tilted in either an outwards direction or an inwards direction.

A light diffusing layer can be provided in some embodiments to improve the visual appearance of the lighting device in an OFF state to an observer—“off-state white appearance”. The light diffusing layer includes particles of a light diffractive material that can substantially reduce the passage of external excitation light that would otherwise cause the wavelength conversion component to re-emit light of a wavelength having a yellowish/orange color. The particles of a light diffractive material in the light diffusing layer are selected, for example, to have a size range that increases its probability of scattering blue light, which means that less of the external blue light passes through the light diffusing layer to excite the wavelength conversion layer. The light diffractive particle size can be selected such that the particles will scatter blue light relatively more (e.g. at least twice as much) as they will scatter light generated by the phosphor material. Preferably, to enhance the white appearance of the lighting device in an OFF state, the light diffractive material within the light diffusing layer is a “nano-particle” having an average particle size of less than about 150 nm. For light sources that emit lights having other colors, the nano-particle may correspond to other average sizes. For example, the light diffractive material within the light diffusing layer for an UV light source may have an average particle size of less than about 100 nm. Embodiments of the present invention can be used to reduce the amount of phosphor materials that is required to manufacture an LED lighting product, thereby reducing the cost of manufacturing such products given the relatively costly nature of the phosphor materials. In particular, the addition of a light diffusing layer composed of particles of a light diffractive material can substantially reduce the quantity of phosphor material required to generate a selected color of emitted light. Different approaches can be used to introduce light scattering materials into an LED lamp, which can substantially reduce the quantity of phosphor material required to generate a selected color of emitted light. In addition, the light diffusing layer can be used in combination with additional scattering (or reflective/diffractive) particles in the wavelength conversion component to further reduce the amount of phosphor material that is required to generate a selected color of emitted light. One possible approach is in which the light scattering material is included within a separate layer. Another possible approach is in which the light scattering material is included within the layer containing the phosphor. Yet another possible approach is in which the light scattering material is introduced into the lens. Any combination of the above may also be implemented. For example, the light scattering material can be introduced into both the layer of phosphor and the lens. In addition, the light scattering material can be included within both a separate layer and the layer of phosphor. Moreover, the light scattering material can be included within each of the separate layer, the layer of phosphor, and the lens.

Alternative approaches can be taken to improve the off-state white appearance of the lamp. For example, texturing can be incorporated into the exterior surface of the lamp to improve the off-state white appearance of the lamp, e.g. in the exterior surface of the lens. Yet another possible approach is to implement a thin white layer directly after the yellow phosphor layer and before the clear linear optic. This three layer structure would be white appearance in the off-state but the primary optic would still be clear (not diffused/cloudy). This approach has the benefit of preserving the light distribution pattern of the linear lens optics while still providing a white appearance.

The approach of using an interior cavity as a “mixing chamber” can be applied to non-linear lamps as well. In some embodiments, an LED lighting arrangement is provided where the lens comprises a solid semi-spherical shape, and the LED chip is mounted within the chamber of the lighting arrangement such that it is wholly contained within the interior of the profile of the phosphor. However, the lens can be fabricated to provide any suitable shape as desired. For example, an alternate LED lighting arrangement in accordance with an embodiment of the invention is where the lens comprises a solid ovoid shape.

With regard to linear lamp embodiments, any suitable manufacturing process may be employed to manufacture the lamp assembly. For example, a printing process can be employed where ink is printed using screen printing directly onto the lens surface. Other printing techniques can be used to print and/or coat the phosphor, such using roller coaters to coat the phosphor ink onto the lens. Spray coating is another technique that may be used to coat the phosphor onto the lens. Lamination can also be performed to manufacture the linear lamp. In this approach, a separate sheet of phosphor material is manufactured, e.g. with or without a clear carrier layer. The sheet of phosphor is then laminated onto the light lens/pipe structure. A co-extrusion process can be performed to manufacture the linear lamp arrangement. Two extruders can be used to feed into a single tool to create both the layer of phosphor and the materials of the lens, where the two layers are simultaneously created and manufactured together in this approach. If the chamber in the lens includes a solid optical medium, then a co-extrusion approach can be used to manufacture the three layers with three extruders.

In some embodiments, a multi-layered optic component is provided which integrally includes a phosphor portion, a lens, and a reflector portion. A triple-extrusion process can be utilized to manufacture the multi-layered optic component, where three extruders are used to feed into a single tool to create the layer of phosphor, the materials of the lens, and the material of the reflector. Three extruders are used to feed into a single tool to create the three separate layers of materials, including phosphor, the materials of the lens, and the materials of the reflector. The three layers are simultaneously created and manufactured together in this approach. This approach can be used with a wide variety of source materials, e.g. PC-Polycarbonate, PMMA-Poly(methyl methacrylate), and PET-Polyethylene Terephthalate, including most or all thermoform plastics. This triple-extrusion process can generally use pellets identical or similar to pellets used for injection molding materials. If the chamber in the lens includes a solid optical medium, then a quadruple-extrusion approach can be used to manufacture the multiple layers with four extruders.

In some embodiments, the circuit board having the array of LEDs is mounted to, and in thermal communication with, a support body. The reflector is formed having a lower flange portion that extends away from the central portion of the multi-layered optic component. The flange portion is configured to slot within a channel in support body

In some embodiments, a co-extrusion process is utilized that manufactures the multi-layered optic component having the array of LEDs, where the LEDs 22 are attached to a structure that is fed into the co-extrusion equipment, such that the multi-layered optic component is affixed to the circuit board having the LEDs as it is being formed.

The inner chamber of the lamp may be filled with an optical medium. The optical medium within the chamber comprises a material, e.g., a solid material, possessing an index of refraction that more closely matches the index of refraction for the phosphor, the LEDs, and/or any type of encapsulating material that may exist on top of the LEDs. The optical medium may be selected of any suitable material, e.g. silicone, to generally fall within or match the index of refraction for materials typically used for the phosphor, the LEDs, and/or any encapsulating material that be used to surround the LEDs. If the chamber in the lens includes a solid optical medium, then a co-extrusion approach can be used to manufacture the multi-layered optic component to also include the optical medium, e.g., by adding an extruder that for the material of the optical medium.

A light diffusing/scattering material can be used in conjunction with the multi-layered optic component. The light diffusing/scattering material is useful to reduce the quantity of phosphor material that is required to generate a selected color of emitted light. The light diffusing/scattering material is also useful to improve the off-state white appearance of the lamp. The light diffusing/scattering material may be included into any of the layers of the multi-layered optic. For example, the light diffusing/scattering material can be incorporated into the layer containing the phosphor, added to the lens, included as an entirely separate layer, or any combination of the above.

In any of the disclosed embodiments, the combination of the solid optical medium and the phosphor can be replaced by a layer of material that entirely fills the volume surrounding the LEDs, but which also includes the phosphor integrally within that layer of material. This provides a hybrid remote-phosphor/non-remote-phosphor approach whereby the phosphor is located in the layer of material that fills the interior cavity, but some of the phosphor is located in close proximity to the LEDs (in the inner portion of the material adjacent to the LEDs), but much of the phosphor is actually quite distant to the LEDs (in the outer portion of the material away from the LEDs). This approach therefore provides much of the advantages of remote-phosphor designs, while also maximizing light conversion efficiencies (due to elimination of mismatches in indices of refraction from eliminating air interfaces). Manufacturing may also be cheaper and easier, since the extrusion processes and apparatuses only need to extrude the single layer of materials, rather than an extruder for the phosphor material and a separate extruder for the optical medium material.

Some embodiments comprise a reflector having high side walls. The side walls are useful to focus the light emitted form lamp into a desired direction.

According to some embodiments, one or more linear lighting arrangements are placed inside of an envelope to form a replacement for a standard incandescent light bulb. The lamp may include standard electrical connectors (e.g., standard Edison-type connectors) that allow lamp to be used in conventional lighting devices. The linear lighting arrangements are vertically oriented, extending axially within the lamp. Internally, the LEDs within the linear lighting arrangements are oriented radially from the central axis of lamp. This configuration provides a good overall emission pattern from lamp over a wide range of emission angles, with the exact dimensions (e.g., length, width) of the linear lighting arrangements selected to provide a desired emission profile. The envelope may be configured in any suitable shape. In some embodiments, envelope comprises a standard light-bulb shape. This permits the lamp to be used in any application/location that could otherwise be implemented with a standard incandescent light bulb. The envelope may include or be used in conjunction with a diffuser. In some embodiments, scattering particles are provided at the envelope, either as an additional layer of material or directly incorporated within the material of envelope.

Inline testing may be employed using any of the above approaches to control and minimize variations in the final manufactured product. With a co-extrusion system, one possible approach to perform in-line testing is to mount a colorimeter or spectrometer that actively measures the product color while it was being extruded. This measurement tool would generally be mounted inline after the cooling bath and dryer but prior to cutting. The color measurement provides real-time feedback to the extrusion system which adjusts layer thickness by varying the relative pressures of the two extrusion screws. The phosphor layer is manufactured to be either thicker or thinner to tune the color of the product in real-time while the extrusion is taking place. This allows one to have single bin accuracy while being able to perform quality checks in real-time during the extrusion process. Similar inline testing could be used with printing and coating methods.

In some embodiments, the length L₁ for the exterior surface of the lens exceeds the length L₂ of the surface of the phosphor portion. The length L₂ in some approaches is at least two times L₁.

An optical component may comprise a cylindrical body of axial length 1 and radius r having a hemispherical end and a planar end which is mountable to an LED package, where the phosphor is provided on the cylindrical and hemispherical surfaces of the component. In some embodiments, the aspect ratio is 3:1 (although other ratios may be employed in certain embodiments).

According to some embodiments of the invention, SQE loss is significantly eliminated or reduced by implementing some or all of the following factors into a lamp design: (i) remote phosphor; (ii) a coupling optic; and (iii) phosphor wavelength conversion layer with an aspect ratio greater than 1:1.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

FIG. 1 is a schematic representation of a known white LED as already described;

FIGS. 2 to 7 are schematic representations of LED lighting arrangements;

FIG. 8 is an end view of an LED linear lamp lighting arrangement in accordance with an embodiment of the invention;

FIGS. 9-12 are schematic representations of an LED linear lamp lighting arrangement in accordance with an embodiment of the invention;

FIG. 13 is an end view of an LED linear lamp lighting arrangement in accordance with an alternate embodiment of the invention;

FIGS. 14A and 14B are an end views of additional embodiments of LED linear lamp lighting arrangements;

FIGS. 15-17 are schematic representations of LED linear lamp lighting arrangement with scattering particles;

FIG. 18 is a schematic sectional representation of a LED lighting arrangement with an interior chamber;

FIG. 19 is a schematic sectional representation of a LED lighting arrangement with an interior chamber and an ovoid lens shape;

FIGS. 20-22 are schematic representations of alternate LED linear lamp lighting arrangements with scattering particles;

FIG. 23 is a schematic end view of a LED linear lamp component;

FIG. 24 is a diagram of emission patterns for an example lamp utilizing the component of FIG. 23;

FIG. 25 is a schematic end view of a LED linear lamp component;

FIG. 26 is a diagram of emission patterns for an example lamp utilizing the component of FIG. 25;

FIG. 27A is a schematic representation of a LED linear lamp lighting arrangement in which the lens provides collimation functionality;

FIG. 27B is a schematic representation of an alternative LED linear lamp lighting arrangement;

FIG. 28 is an end view LED linear lamp component in which a specific aspect ratio is provided;

FIG. 29 illustrates the end view of a lamp having a multi-layered optic component according to some embodiments of the invention;

FIG. 30 illustrates the end view of a lamp having a multi-layered optic component, where an optical medium is placed within the chamber;

FIG. 31 illustrates the end view of a lamp having a multi-layered optic component, which further includes scattering particles;

FIG. 32 illustrates the end view of a lamp having a multi-layered optic component, where an optical medium placed within the chamber comprises photoluminescent material;

FIG. 33 illustrates the end view of a lamp having a multi-layered optic component, where the reflector comprises high walls; and

FIGS. 34 and 35 are perspective views LED lamps having vertically oriented linear light arrangements.

FIGS. 36A and 36B illustrate a conventional packaged LED 200.

FIGS. 37A, 37B, and 37C illustrate the problems of packaged LEDs in the context of an array of packaged LEDs.

FIGS. 38A and 38B illustrate a schematic plan and cross-sectional views of a chip-on-board (COB) LED structure.

FIG. 39 illustrates the end view of a lamp module according to some embodiments of the invention.

FIG. 40 illustrates a flowchart of an improved method for manufacturing a white light module and/or lamp according to some embodiments.

FIGS. 41A-D illustrate one example approach for manufacturing the linear array of LEDs.

FIG. 42 illustrates a process for co-extruding the multi-layer conversion component onto the linear array of LEDs to forms the white light module.

FIG. 43 illustrate an example Chip-On-Wire structure, which includes an array of LEDs that are aligned and mounted along a set of wires.

FIGS. 44A and 44B illustrate an example of a packaged LED that is usable in the Chip-On-Wire structure.

FIG. 45 illustrates a process of co-extruding the multi-layer conversion component onto a linear packaged LED structure to form the white light module.

FIG. 46 illustrates an embodiment of a white light module.

FIG. 47 illustrates a flowchart of an alternative method for manufacturing a white light module, where the LEDs do not include the LEDs in a conventional package structure and/or where the LEDs do not include an integrated encapsulant.

FIG. 48 illustrates a process to manufacture a multi-layer conversion component.

FIG. 49 illustrates a process for co-extruding the multi-layer conversion component.

FIGS. 50A-C illustrate assembly steps according to one embodiment of the invention.

FIG. 51 illustrates an embodiment of a white light module manufactured according to some embodiments of the invention.

FIGS. 52A-C illustrate an alternative approach to implement final assembly steps, where the liquid optical medium is applied to the multi-layer conversion component.

FIG. 53 illustrates a flowchart of a method for manufacturing a white light module where an optical medium is not co-extruded in the multi-layer conversion component.

FIG. 54 illustrates a process to manufacture a multi-layer conversion component.

FIG. 55 illustrates a process for co-extruding the multi-layer conversion component.

FIGS. 56A-C illustrate an alternative approach to implement final assembly steps, when an optical medium is not co-extruded in the multi-layer conversion component.

FIG. 57 illustrates an embodiment of a white light module manufactured according to some embodiments of the invention.

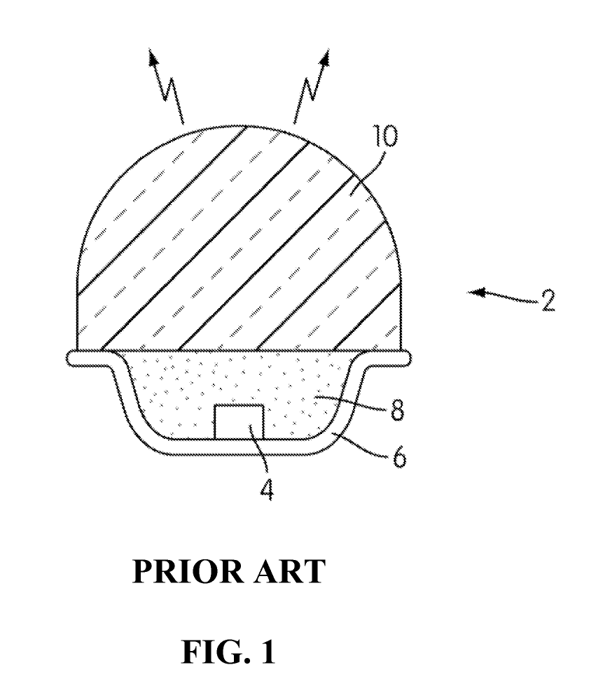

### DETAILED DESCRIPTION OF EMBODIMENTS OF THE INVENTION

In order that the present invention is better understood, embodiments of the invention will now be described by way of example only with reference to the accompanying drawings.

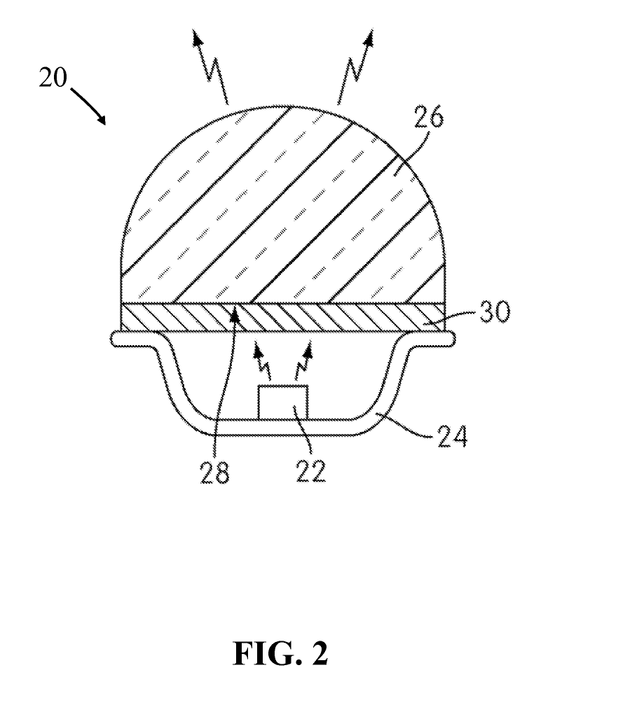

Referring to FIG. 2 there is shown a LED lighting arrangement 20 for generating light of a selected color for example white light. The lighting arrangement 20 comprises a LED chip 22, preferably a Gallium Nitride chip, which is operable to produce light, radiation, preferably of wavelength in a range 300 to 500 nm. The LED chip 22 is mounted inside a stainless steel enclosure or reflection cup 24 which has metallic silver deposited on its inner surface to reflect light towards the output of the lighting arrangement. A convex lens 26 is provided to focus light output from the arrangement. In the illustrated example, the lens 26 is substantially hemispherical in form. The lens 26 can be made of a plastics material such as polycarbonates, acrylic, silicone or glass such as silica based glass or any material substantially transparent to the wavelengths of light generated by the LED chip 22.

In FIG. 2 the lens 26 has a planar, substantially flat, surface 28 onto which there is provided a layer of phosphor 30 before the lens is mounted to the enclosure 22. The phosphor 30 can comprise any photoluminescent material such as a nitride and/or sulfate phosphor materials, oxy-nitrides and oxy-sulfate phosphors, garnet materials (YAG) or a quantum dot material. The phosphor which is typically in the form of a powder is mixed with an adhesive material such as epoxy or a silicone resin, or a transparent polymer material and the mixture is then applied to the surface of the lens to provide the phosphor layer 30. The mixture can be applied by painting, dropping or spraying or other deposition techniques which will be readily apparent to those skilled in the art. Moreover the phosphor mixture preferably further includes a light diffusing material such as titanium oxide, silica or alumina to ensure a more uniform light output.

The color of light emitted from the lighting arrangement can be controlled by appropriate selection of the phosphor composition as well as the thickness of the phosphor layer and/or weight loading of phosphor which will determine the proportion of output light originating from the phosphor. To ensure a uniform output color the phosphor layer is preferably of uniform thickness and has a typical thickness in a range 20 to 500 μm.

An advantage of such lighting arrangements is that no phosphor need be incorporated within the encapsulation materials in the LED package. Moreover the color of the light output by the arrangement can be readily changed by providing a different lens having an appropriate phosphor layer. This enables large scale production of a common laser package. Moreover such a lens provides direct color conversion in an LED lighting arrangement.

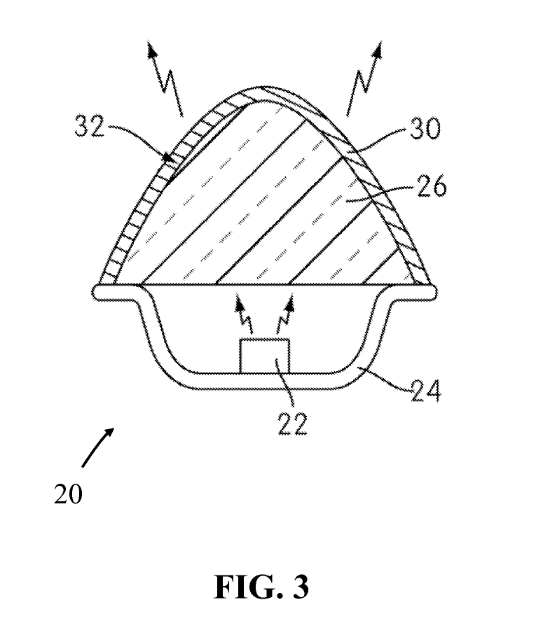

Referring to FIG. 3 there is shown a further LED lighting arrangement 20 in which the phosphor 30 is provided as a layer on the outer convex surface 32 of the lens 26. In this embodiment the lens 26 is dome shaped in form.

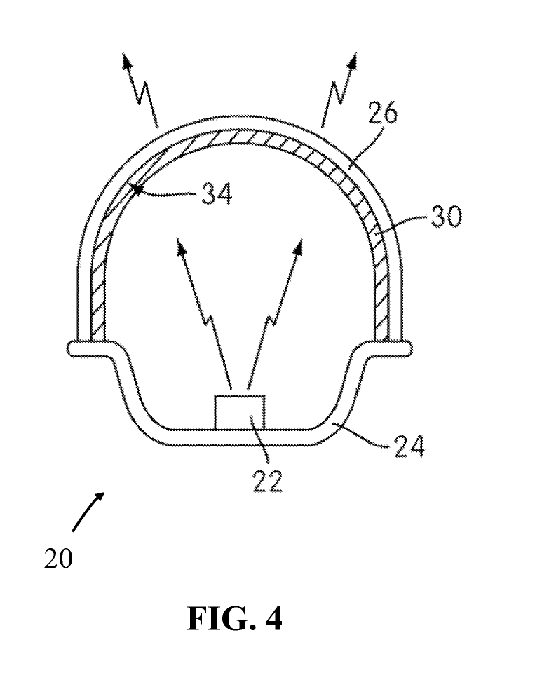

FIG. 4 shows an LED lighting arrangement 20 in which the lens 26 comprises a substantially hemispherical shell and the phosphor 30 is provided on the inner surface 34 of the lens 26. An advantage of providing the phosphor on the inner surface is that the lens 26 then provides environmental protection for the LED and phosphor. Alternatively the phosphor can be applied as a layer of the outer surface of the lens 26 (not shown).

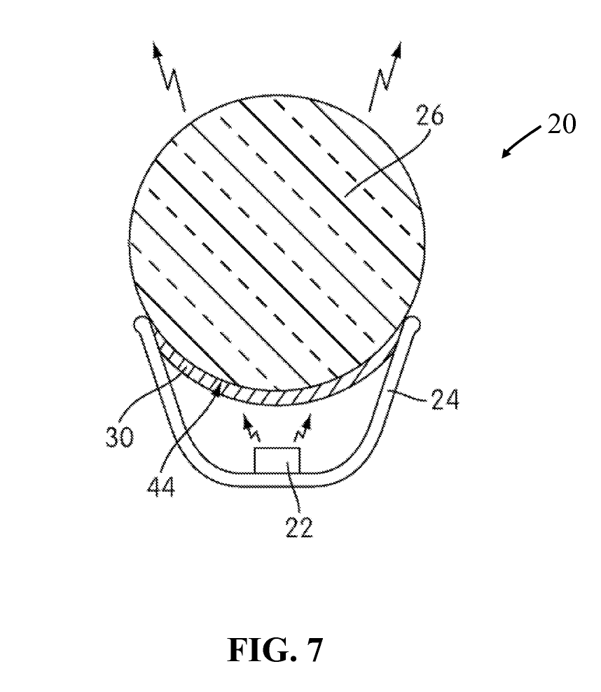

FIG. 7 shows an LED lighting arrangement 20 in which the optical component comprise a solid substantially spherical lens 26 and the phosphor is provided on at least a part of the spherical surface 44. In a preferred arrangement, as illustrated, the phosphor is applied to only a portion of the surface, which surface is then mounted within the volume defined by the enclosure. By mounting the lens 26 in this way this provides environmental protection of the phosphor 30.

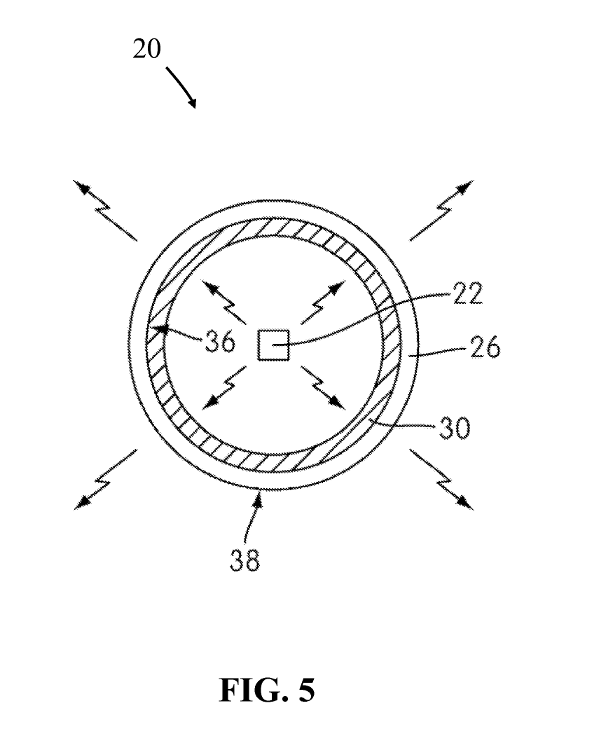

FIG. 5 illustrates an LED lighting arrangement 20 in which the lens 26, optical component, comprises a substantially spherical shell and the phosphor 30 is deposited as a layer on at least a part of the inner 36 or outer spherical 38 surfaces and the LED chip 22 is mounted within the spherical shell. To ensure uniform emission of radiation a plurality of LED chips are advantageously incorporated in which the chip are oriented such that they each emit light in differing directions. Such a form is preferred as a light source for replacing existing incandescent light sources (light bulbs).

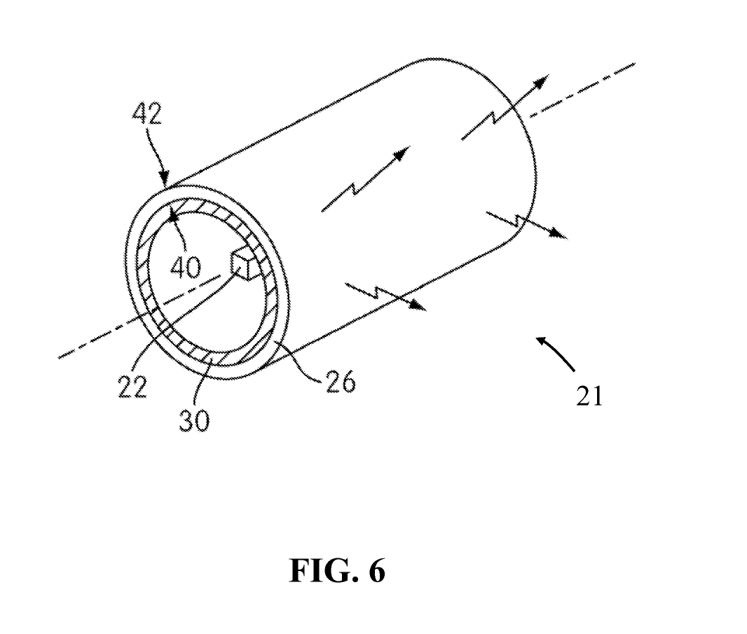

Referring to FIG. 6 there is shown a further LED lighting arrangement 20 in which the optical component 26 comprises a hollow cylindrical form and the phosphor is applied to the inner 40 or outer 42 curved surfaces. In such an arrangement the laser chip preferably comprises a linear array of laser chips that are arranged along the axis of the cylinder. Alternatively the lens 26 can comprise a solid cylinder (not shown).

The embodiment of FIG. 6 generally depicts an example of a linear lighting arrangement/linear lamp 21, which is a lighting apparatus typically having a long tubular profile. These lamps are common in many office or workspace environments, and many commercial and institutional buildings will routinely incorporate lighting fixtures and ceiling recesses/troughs in ceilings to fit standard size linear lamps (such as standard tubular T5, T8, and T12 lamps).

Linear lamps are normally implemented with fluorescent tube technology, encompassing gas discharge lamps that use electricity to excite mercury vapors. However, there are many disadvantages with conventional fluorescent-based lamps. For example, the mercury within the fluorescent lamp is considered poisonous, and breakage of the fluorescent lamp, particularly in ducts or air passages, may require expensive cleanup efforts to remove the mercury (as recommended by the Environmental Protection Agency). Moreover, fluorescent lamps can be quite costly to manufacture, due in part to the requirement of using a ballast to regulate the current in such lamps. In addition, fluorescent lamps have fairly high defects rates and relatively low operating lives.

In contrast, LED-based linear lamps overcome these problems associated with fluorescent lamps. Unlike fluorescent lamps, LED-based linear lamps do not require any mercury. LED-based lamps are able to generate higher lumens per wattage as compared to fluorescent lamps, while having lower defects rates and higher operating life expectancies.

The approach shown in FIG. 6 provides an arrangement in which light generated by the linear lamp is emitted in all directions. The layer of phosphor 30 and the lens/optical component 26 entirely surround the linear array of LEDs 22. The light produced by the lamp is therefore emitted over an entire 360 degrees of direction from the center axis of the lamp.

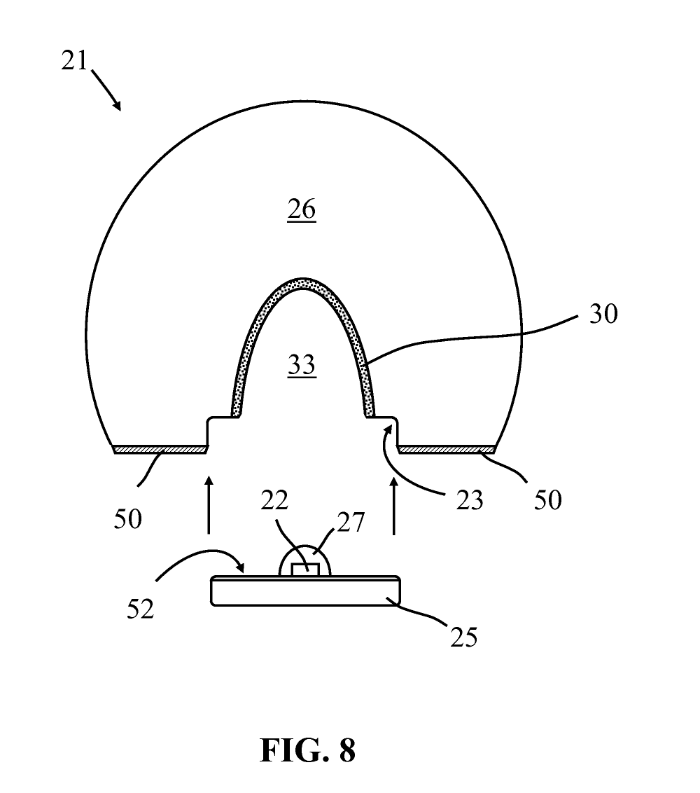

FIG. 8 illustrates a LED-based linear lamp 21 in accordance with an embodiment of the invention, in which light is emitted in selected directions from the linear lamp. The array of LED chips 22 are mounted on a support, e.g. a printed circuit board 25, that fits within inside indentations 23 on lens 26. An inner cavity/chamber 33 is formed in the interior of the lens 26. The walls of the chamber 33 include a layer of phosphor 30. The LED chip 22 in some embodiments comprises a Gallium Nitride chip which is operable to produce light, radiation, preferably of wavelength in a range 300 to 500 nm. The surface of the circuit board 25 may be formed or covered with a reflective material 52 to reflect light from the LED chip 22 away from the circuit board 25 and towards the phosphor 30.

Each of the LEDs in the array of LED chips 22 may be covered or otherwise encapsulated with a light extracting cover 27. The light extracting cover 27 reduces excessive mismatches between the index of refraction of the LEDs 22 and the index of refraction of the air within the interior chamber 33. Any mismatch in the indices of refraction can cause a significant portion of the LED light to be lost from the total LED light output. By including light extracting cover 27, this helps to reduce excessive mismatches in the indices of refraction, facilitating an increase the overall light conversion efficiency of lamp 21.

The light emitted by the LED chip 22 is converted by the phosphor 30 into photoluminescent light. The color quality of the final light emission output of the lamp is based (at least in part) upon the combination of the wavelength of the photoluminescent light emitted by the phosphor 30 with the wavelength of any remaining light from the LED chip 22 that pass through the phosphor 30. The color of light emitted from the lighting arrangement can be controlled by appropriate selection of the phosphor composition as well as the thickness and/or loading density of phosphor within the phosphor layer which will determine the proportion of output light originating from the phosphor. To ensure a uniform output color the phosphor layer is preferably of uniform thickness and has a typical thickness in a range 20 to 500 μm.

The actual pattern of the emitted light from the lamp 21 is affected by the arrangement of the lens 26. The lens 26 in the current embodiment has a semi-circular profile that permits focusing and distribution of the emitted light output from lamp 21 in desired directions, e.g. for a range of coverage substantially corresponding to the radial angles of the lens 26 from a center axis of the lamp. The lens 26 can be made of any suitable material, e.g. a plastics material such as polycarbonates or glass such as silica based glass or any material.

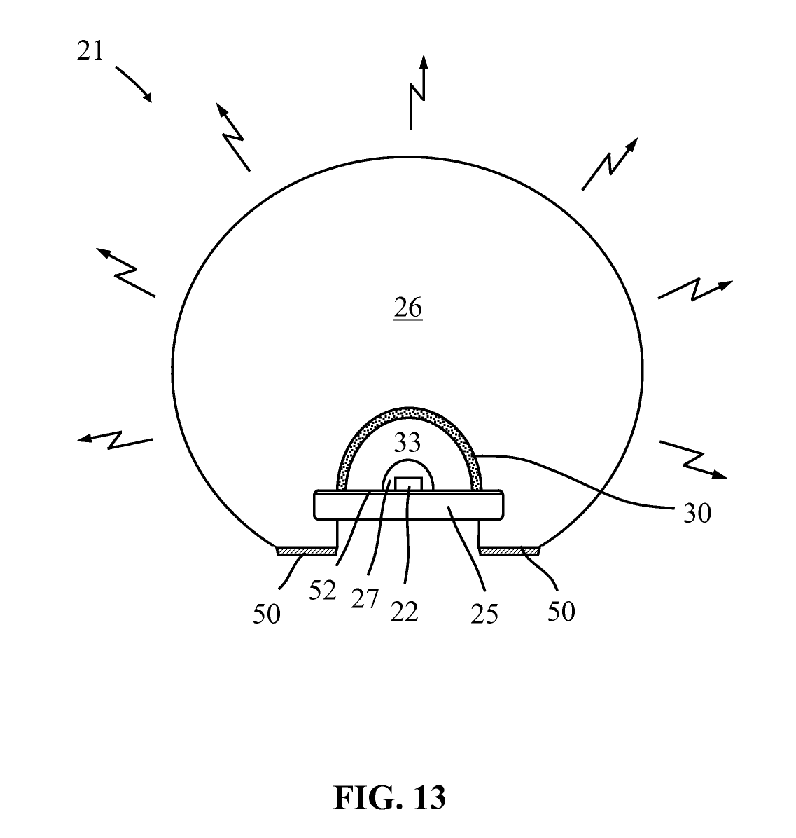

The distribution of light from the lamp 21 is also affected by the shape of the phosphor 30 in chamber 33. The lamp 21 shown in FIG. 8 has a conical profile for the phosphor 30 that enhances the amount of light that is distributed from the sides of the lamp 21. FIG. 13 illustrates an alternate design in which the phosphor 30 has a profile that is more semi-circular in nature, rather than conical. This approach provides relatively greater distributions of light towards the center of the distribution area. The exact shape of the phosphor 30 and/or the lens 26 can be selected and combined to provide any suitable output pattern and distribution as desired.

The chamber 33 provides a cavity (also referred to herein as a “mixing chamber”) within the lamp 21, which has a volume that is large enough for insertion of the LED 22 within the cavity. This permits the LED 22 to be located, wholly or partially, within the interior of the lens 26 and/or phosphor 30.

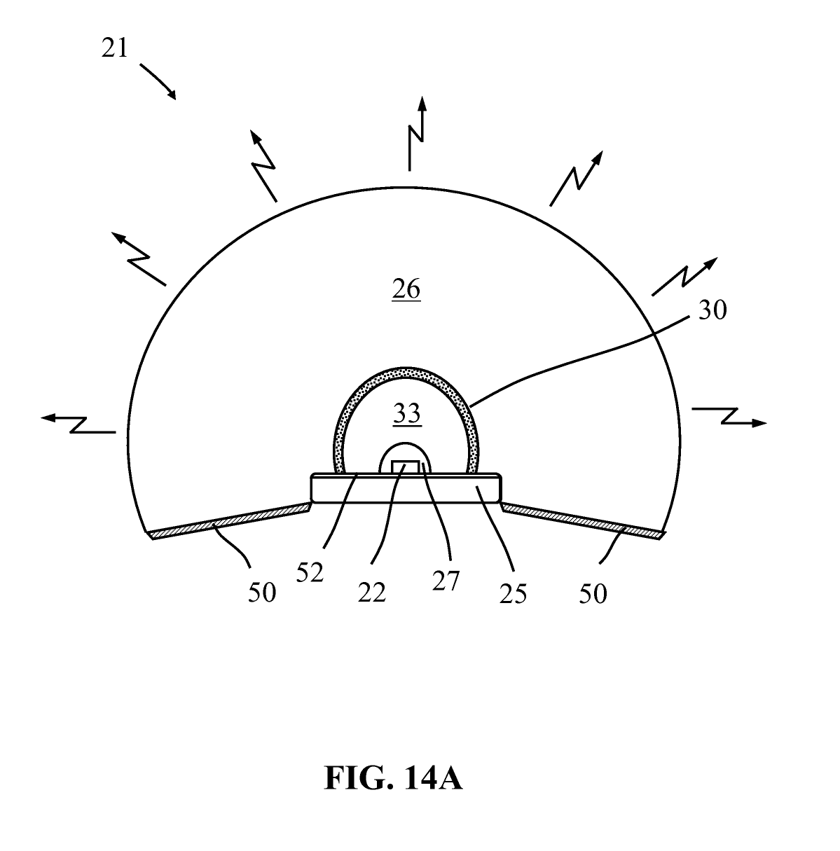

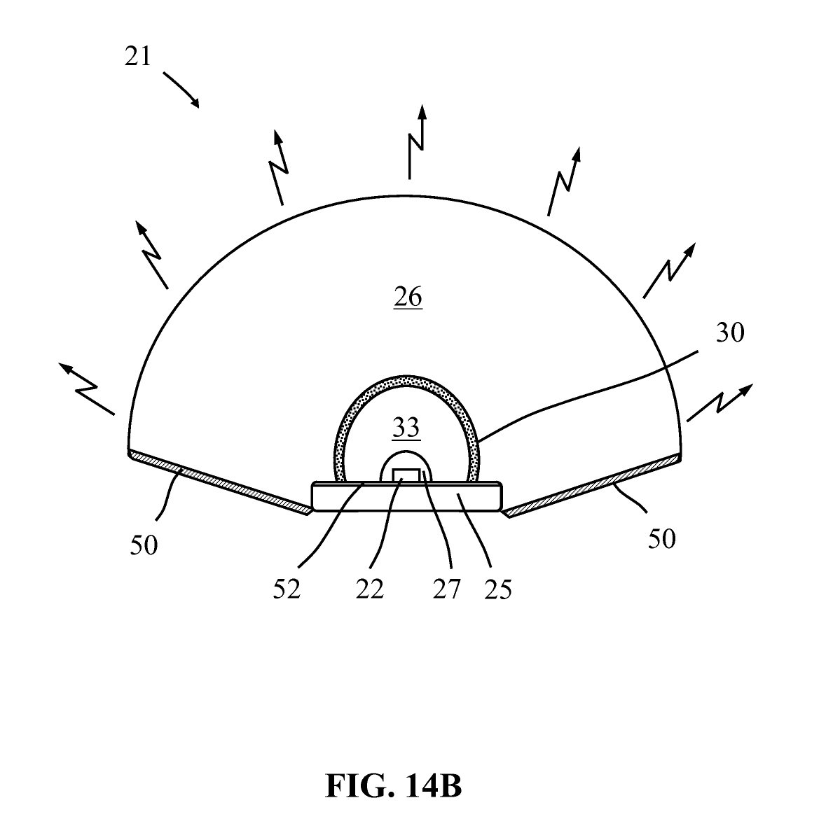

In the approach of FIG. 8, the indentation/slot 23 is incorporated into the outer profile of the lens 26 to accommodate direct placement of the PCB 25 or Chip-On-Board (COB) array. In the approach of FIG. 14, a slot formed within the lens 26 to permit the PCB 25 to slide and support into the slot. The PCB or COB surface has a reflective layer or coating 52 placed on it to reflect LED-emitted light towards the phosphor 30. The bottom surface of the lens 26 may also be covered with a reflective material 50. The approach of implementing a cavity/chamber 33 within the lens 26 makes for very simple assembly and improved efficiency due to avoiding losses from an exterior mixing chamber.

A benefit provided by this arrangement is that the chamber provides for mixing of light within highly transparent solid with minimal loss. An example of this occurs when a lamp includes both red and blue LEDs in the chamber, and the chamber allows the light from these LEDs (e.g., the red light) to be uniformly distributed inside the lens. There are various reasons for the advantages provided by the internal mixing chamber. For example, one reason is because the arrangement of the internal mixing chamber provides for cross-wall emissions of light. Even though reflectors are still provided on the “floor” of the lamp, much of the light that moves through the mixing chamber will cross from one wall of the phosphor to another wall without needing to reflect from the reflectors, improving the efficiency of the lamp for its light production. Another benefit provided by the arrangement is that it removes the point source impact of having individual LEDSs in the lamp. Each LED is a point source of light (e.g., blue or red light), but because the LEDs are within the chamber that has its walls covered with phosphor, the light emitted by the phosphor will visibly obscure the point source effects of the LEDs. Yet another advantage is the directionality provided by the current arrangement. Since most fluorescent replacement lamps will be inserted into ceiling or wall fixtures, it is likely that the emitted light will be provided in a desired direction, e.g., away from the ceiling or wall. The present embodiment of using the lens and internal chamber configuration enhances the directionality of the emitted light in the desired directions. Another benefit provided by embodiments of the invention is that the amount of phosphor needed to manufacture the lamp can be minimized for a given size of the lamp. Even though the external dimensions of the lamp may be quite large due to the size of the lens, the smaller surface area of the internal chamber means that a much smaller amount of phosphor is actually required for the lamp. A further benefit of the small internal chamber is that it reduces the apparent size of the phosphor component when viewing the lamp in an off-state.

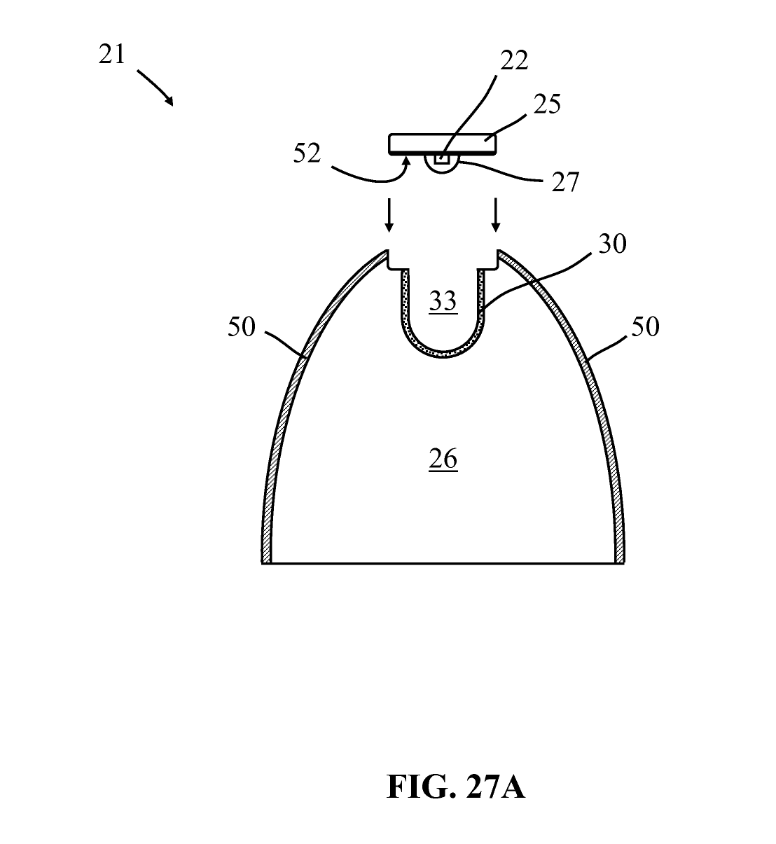

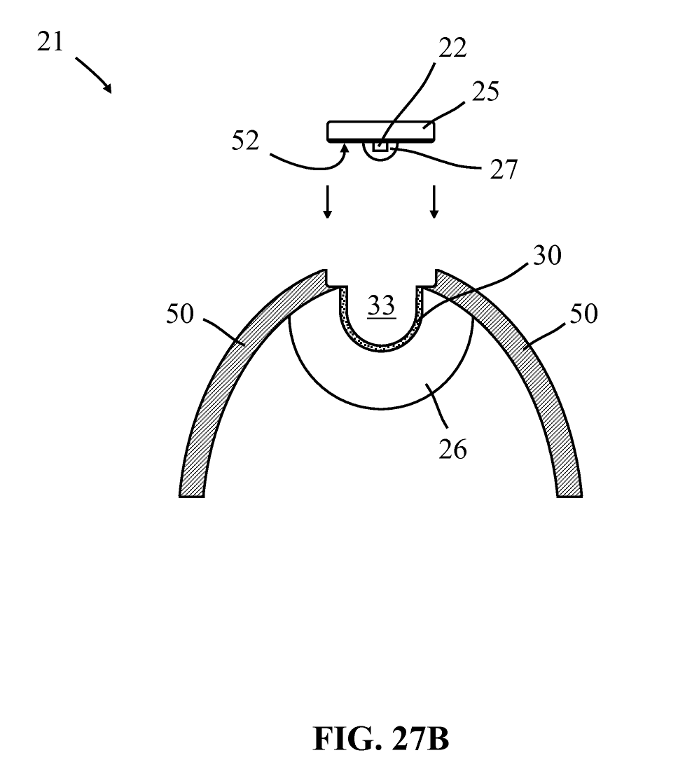

Leaving the optical material of the lens 26 with a clear or transparent property also provides the benefit of creating a linear optic/linear lens. Alternatively, the lens can be configured to operate as a light pipe that provides collimation at the light source so the light travels inside the pipe for an extended distance without exiting the sides. For example, FIG. 27A shows a lamp where the optical component 26 is configured with appropriately curved sides to provide collimation functionality. In this arrangement, the light emitted from the phosphor 30 that impact the walls of the lens 26 at certain angles will reflect away from those walls in a downwards direction, e.g., based at least in part upon the light pipe effects of the lens 26. This result is achievable without the need to include reflective material 50 on the walls of the lens 26, although inclusion of reflective material 50 will improve the efficiency at which light is emitted in the downwards direction.

FIG. 27B shows an alternative embodiment of a lamp 21 where the lens 26 is not configured to extend along the entire length of the reflector 50. Instead, the lens 26 generally forms a curved or dome-like shape that only partially fills the interior volume formed by the reflector 50. Appropriate configuration of the lens 26 and reflector 50 permit this approach to form a direct lamp replacement having any desired light emission characteristics. In both the approaches of FIGS. 27A and 27B, a co-extrusion process can be used to manufacture the structure of the phosphor layer, lens, and reflector.

In the embodiment of FIG. 8, the light is generally unstructured without a collimator. However the current embodiment does create a linear lens optic with the clear material that is coupled to a smaller linear light source (the phosphor layer). The combined system allows one to accurately control the light distribution pattern with minimal losses because there is no air interface between the remote phosphor layer and optics. The cross section in the figures shows a light source and single optic coupled together into a single unit. It is possible to configure specific linear beam patterns by designing the shape of the linear lens relative to the light source. In effect, the lens 26 can be used to shape the emitted properties of the light that is generated by the lamp, e.g., by focusing the emitted light from the lamp.

In some embodiments, further operating efficiencies for the lamp are provided by including an optical medium within the chamber 33. The optical medium within the chamber 33 comprises a material, e.g., a solid material, possessing an index of refraction that more closely matches the index of refraction for the phosphor 30, the LEDs 22, and/or any type of encapsulating material that may exist on top of the LEDs 22. One reason or using the optical medium is to eliminate air interfaces that exist between the LEDs 22 and the phosphor 30. The problem addressed by this embodiment is that there is a mismatch between the index of refraction of the material of the phosphor 30 and the index of refraction of the air within the interior volume 33 of the lamp 21. This mismatch in the indices of refraction for the interfaces between air and the lamp components may cause a significant portion of the light to be lost in the form of heat generation. As a result, lesser amounts of light and excessive amounts of heat are generated for a given quantity of input power. By filling the chamber 33 with an optical medium 56, this approach permits light to be emitted to, within, and/or through the interior volume of the lamp without having to incur losses caused by excessive mismatches in the indices of refraction for an air interface. The optical medium 56 may be selected of a material, e.g. silicone, to generally fall within or match the index of refraction for materials typically used for the phosphor 30, the LEDs 22, and/or any encapsulating material that be used to surround the LEDs 22. Further details regarding an exemplary approach to implement the optical medium are described in U.S. Provisional Application Ser. No. 61/657,702, filed on Jun. 8, 2012, entitled “Solid-State Lamps With Improved Emission Efficiency And Photoluminescence Wavelength Conversion Components Therefor”, which is hereby incorporated by reference in its entirety.

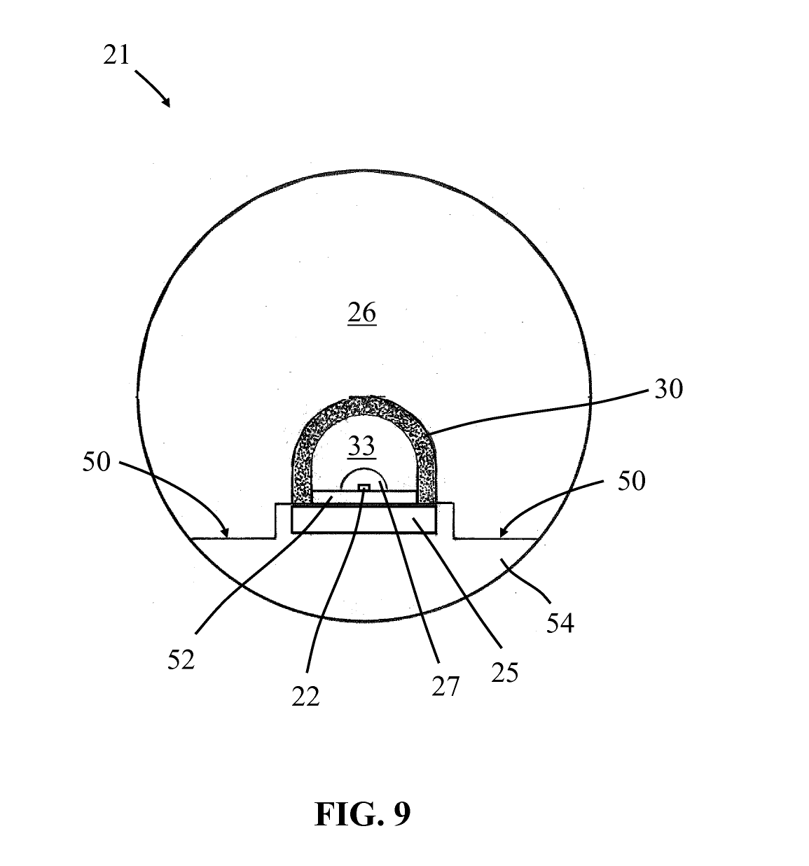

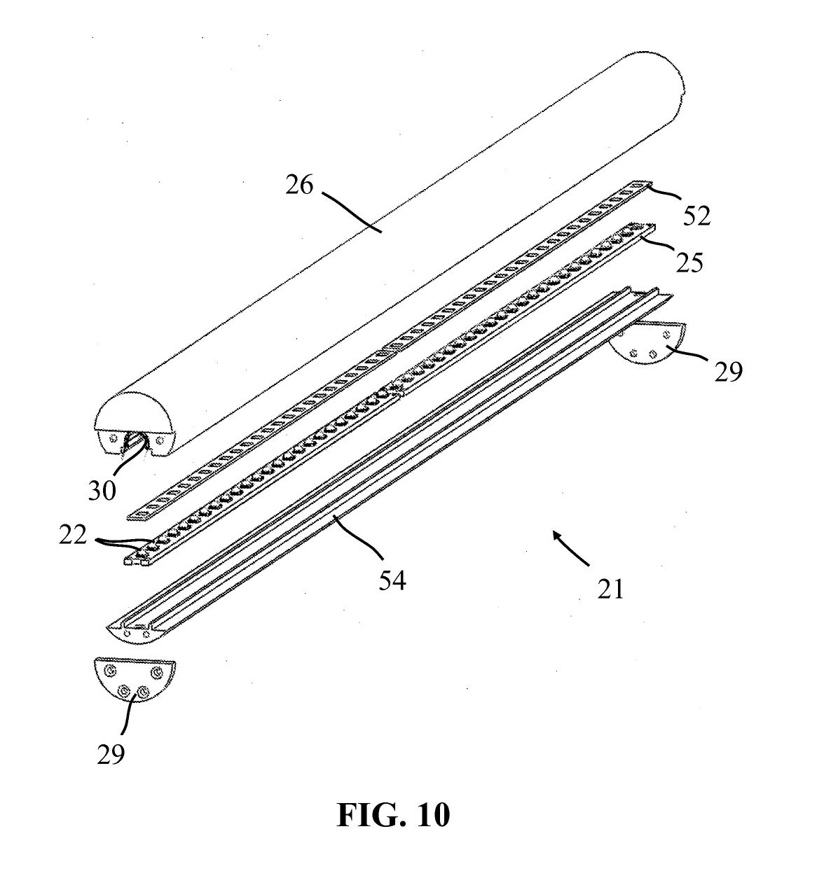

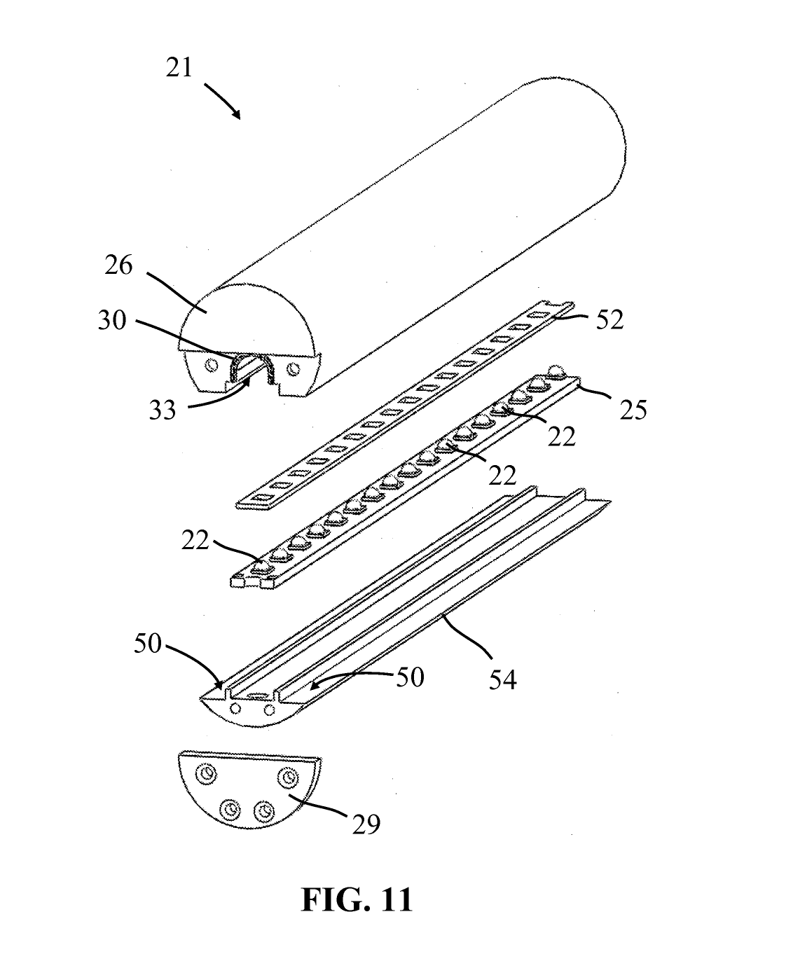

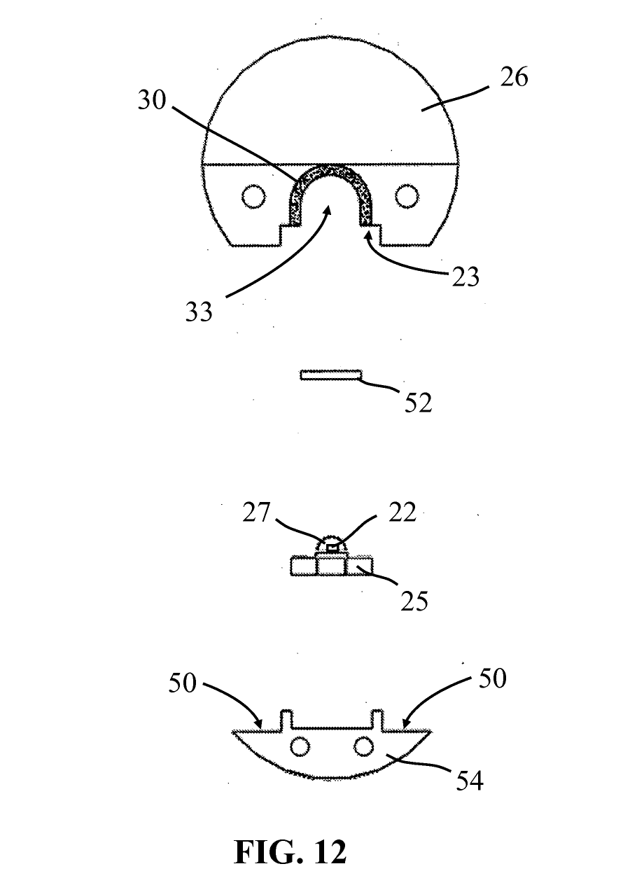

FIGS. 9, 10, 11, and 12 provide illustrations of the components of a linear lamp 21 according to particular embodiments of the invention. FIG. 9 is an end view and FIG. 12 is an exploded end view of the linear lamp 21. FIG. 10 is an exploded perspective view of the lamp 21, which is further magnified in FIG. 11. The linear lamp 21 includes an elongate lens 26 having an integrally formed chamber 33 that runs the length of the lens 26. The chamber 33 is shaped to provide a desired light distribution pattern. In this current example of the linear lamp 21, the cavity 33 is shown with a dome-shaped profile. A layer of phosphor 30 is placed within the chamber 33.

A linear array of LEDs 22 is located on a circuit board 25. Any suitable approach can be taken to implement the array of LEDs 22. For example, the LED array may be implemented using a chip-on-board (COB) configuration. A reflective material 52 (e.g., reflective tape or paper) is provided which include apertures for the LEDs 22. The circuit board 25 is mounted onto a heat sink 54. The assembly comprising the heat sink 54, circuit board 25, and reflective material 52 is attached to the lens 26 using a pair of endplates 29 to be set at the indented end portion of the lens 26. The endplate 29 includes a set of four screw holes (not shown in FIG. 9). The top two screw holes are for insertion of screws to openings in the lens 26. The bottom two screws are for insertion of screws to openings in the heat sink 54.

In embodiments where the linear lamp 21 is intended to be direct replacements for standard fluorescent lamps such as t5, T8 or T12 fluorescent tubes, end caps (not shown) are provided which include appropriate connectors such as a G5 or G13 bi-pin connectors to fit into standard fluorescent lamp fixtures. External reflectors (not shown) may also be used in conjunction with lamp 21 to direct output light from the lamp 21 into desired directions. The direction of orientation for lamp 21 would be adjusted as appropriate. For example, the lamp would normally be directed in a downwards direction (e.g. with the lens 26 facing downwards below a reflector) when installed into a ceiling fixture.

The bottom portion of the lens 26 is configurable to adjust the illumination pattern of the lamp 21, e.g., by adjusting the radial angle of coverage for the lens 26 as measured from a central axis of the lamp. If the profile of the lens extends over a full 360 degrees from a central axis, this would result in a lamp having 360 degrees of illumination, e.g., as shown in the lamp of FIG. 6. The angle of the bottom portion of the lens can also be adjusted to adjust the illumination pattern of the lamp. FIG. 14A illustrates the end view of an embodiment of the invention in which the bottom portion of the lens 26 is configured such that the lens 26 provides a semi-circular profile having a radial angle at slightly greater than 180 degrees relative to a central axis of the lamp 21, e.g., where the portions 50 are tilted in an outward direction to improve the spread of light emitted by the lamp. An alternate embodiment can be configured such that the bottom portion of the lens 26 is tilted in an inwards direction. FIG. 14B illustrates the end view of an embodiment of the invention in which the bottom portion of the lens 26 is configured such that the lens 26 provides a semi-circular profile having a radial angle at slightly less than 180 degrees relative to a central axis of the lamp 21, e.g., where the portions 50 are tilted in an inward direction to improve the concentration of light emitted by the lamp in a selected direction.

One problem associated with LED lighting device that is addressed by embodiments of the invention is the non-white color appearance of the device in an OFF state. During an ON state, the LED chip or die generates blue light and some portion of the blue light is thereafter absorbed by the phosphor(s) to re-emit yellow light (or a combination of green and red light, green and yellow light, green and orange or yellow and red light). The portion of the blue light generated by the LED that is not absorbed by the phosphor combined with the light emitted by the phosphor provides light which appears to the human eye as being nearly white in color. However, in an OFF state, the LED chip or die does not generate any blue light. Instead, light that is produced by the remote phosphor lighting apparatus is based at least in part upon external light (e.g. sunlight or room lights) that excites the phosphor material in the wavelength conversion component, and which therefore generates a yellowish, yellow-orange or orange color in the photoluminescence light. Since the LED chip or die is not generating any blue light, this means that there will not be any residual blue light to combine with the yellow/orange light from the photoluminescence light of the wavelength conversion component (e.g. phosphor 30) to generate white appearing light. As a result, the lighting device will appear to be yellowish, yellow-orange or orange in color. This may be undesirable to the potential purchaser or customer that is seeking a white-appearing light.

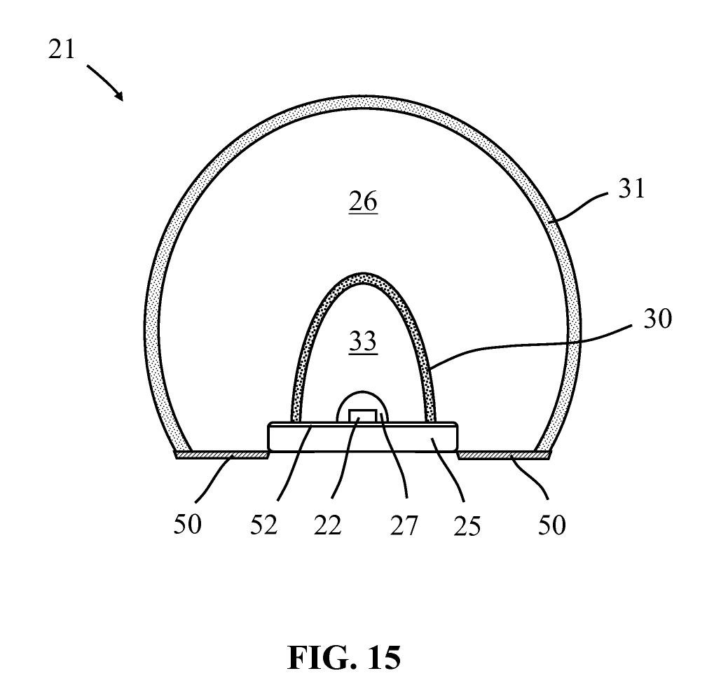

According to the embodiment of FIG. 15, a light diffusing layer 31 provides the benefit of addressing this problem by improving the visual appearance of the device in an OFF state to an observer. In part, this is because the light diffusing layer 31 includes particles of a light diffractive material that can substantially reduce the passage of external excitation light that would otherwise cause the wavelength conversion component to re-emit light of a wavelength having a yellowish/orange color. The particles of a light diffractive material in the light diffusing layer 31 are selected, for example, to have a size range that increases its probability of scattering blue light, which means that less of the external blue light passes through the light diffusing layer to excite the wavelength conversion layer. Therefore, the remote phosphor lighting apparatus will have more of a white appearance in an OFF state since the wavelength conversion component is emitting less yellow/red light.

The light diffractive particle size can be selected such that the particles will scatter blue light relatively more (e.g. at least twice as much) as they will scatter light generated by the phosphor material. Such a light diffusing layer ensures that during an OFF state, a higher proportion of the external blue light received by the device will be scattered and directed by the light diffractive material away from the wavelength conversion layer, decreasing the probability of externally originated photons interacting with a phosphor material particle and minimizing the generation of the yellowish/orange photoluminescent light. However, during an ON state, phosphor generated light caused by excitation light from the LED light source can nevertheless pass through the diffusing layer with a lower probability of being scattered. Preferably, to enhance the white appearance of the lighting device in an OFF state, the light diffractive material within the light diffusing layer is a “nano-particle” having an average particle size of less than about 150 nm. For light sources that emit lights having other colors, the nano-particle may correspond to other average sizes. For example, the light diffractive material within the light diffusing layer for an UV light source may have an average particle size of less than about 100 nm.

Therefore, by appropriate selection of the average particle size of the light scattering material, it is possible to configure the light diffusing layer such that it scatters excitation light (e.g. blue light) more readily than other colors, namely green and red as emitted by the photoluminescence materials. For example, TiO₂ particles with an average particle size of 100 nm to 150 nm are more than twice as likely to scatter blue light (450 nm to 480 nm) than they will scatter green light (510 nm to 550 nm) or red light (630 nm to 740 nm). As another example, TiO₂ particles with an average particle size of 100 nm will scatter blue light nearly three times (2.9=0.97/0.33) more than it will scatter green or red light. For TiO₂ particles with an average particle size of 200 nm these will scatter blue light over twice (2.3=1.6/0.7) as much as they will scatter green or red light. In accordance with some embodiments of the invention, the light diffractive particle size is preferably selected such that the particles will scatter blue light relatively at least twice as much as light generated by the phosphor material(s).

Another problem with remote phosphor devices that can be addressed by embodiments of the invention is the variation in color of emitted light with emission angle. This problem is commonly called COA (Color Over Angle). Remote phosphor layers allow a certain amount of blue light to escape as the blue component of white light. This is directional light coming from the LEDs. The RGY (Red Green Yellow) light coming from the phosphor is lambertian. Therefore the directionality of the blue light may be different than that of the RGY light causing a “halo” effect at the edges with color looking “cooler” in the direction of the blue LED light and “warmer” at the edges where the light is all RGY. The addition of nano-diffuser selectively diffuses blue light—causing it to have the same lambertian pattern as the RGY light and creating a very uniform color over angle. Traditional LEDs also have this problem which can be improved by remote phosphor using this technology. Remote phosphor devices are often subject to perceptible non-uniformity in color when viewed from different angles. Embodiments of the invention correct for this problem, since the addition of a light diffusing layer in direct contact with the wavelength conversion layer significantly increases the uniformity of color of emitted light with emission angle θ.

Embodiments of the present invention can be used to reduce the amount of phosphor materials that is required to manufacture an LED lighting product, thereby reducing the cost of manufacturing such products given the relatively costly nature of the phosphor materials. In particular, the addition of a light diffusing layer composed of particles of a light diffractive material can substantially reduce the quantity of phosphor material required to generate a selected color of emitted light. This means that relatively less phosphor is required to manufacture a wavelength conversion component as compared to comparable prior art approaches. As a result, it will be much less costly to manufacture lighting apparatuses that employ such wavelength conversion components, particularly for remote phosphor lighting devices. In operation, the diffusing layer increases the probability that a photon will result in the generation of photoluminescence light by reflecting light back into the wavelength conversion layer. Therefore, inclusion of a diffusing layer with the wavelength conversion layer can reduce the quantity of phosphor material required to generate a given color emission product, e.g. by up to 40%.

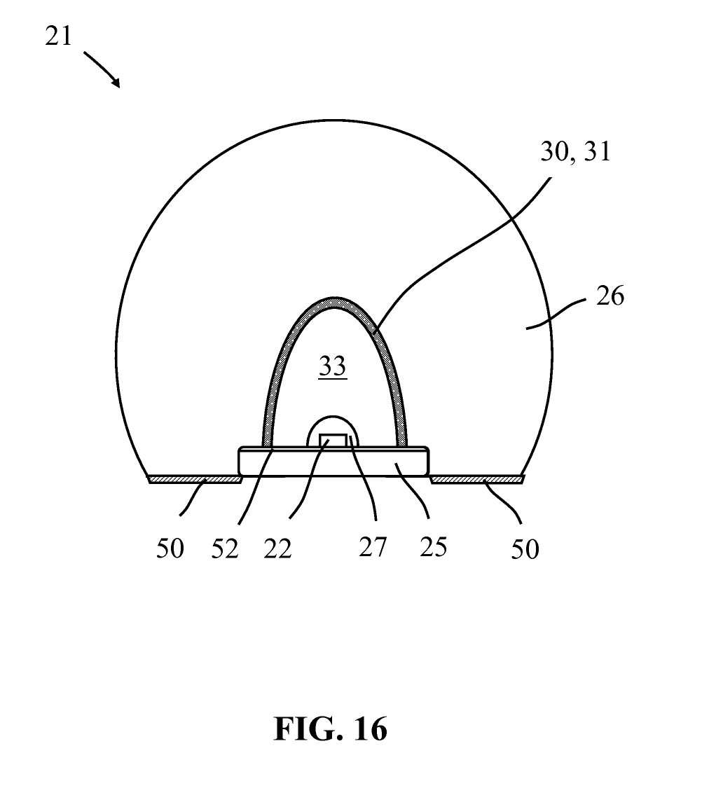

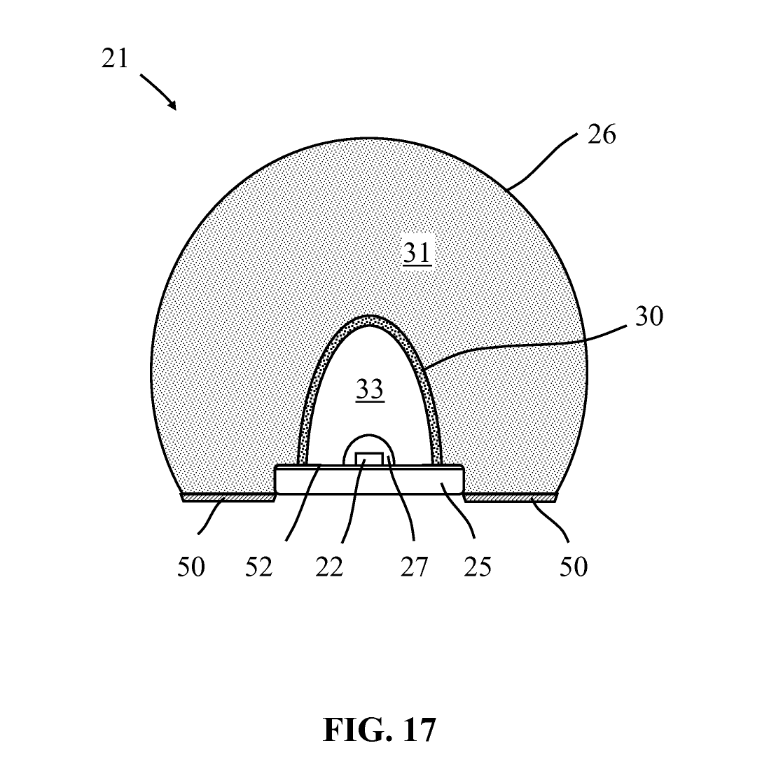

FIGS. 15, 16, and 17 illustrate different approaches to introduce light scattering materials into an LED lamp, which can substantially reduce the quantity of phosphor material required to generate a selected color of emitted light. In addition, the light diffusing layer can be used in combination with additional scattering (or reflective/diffractive) particles in the wavelength conversion component to further reduce the amount of phosphor material that is required to generate a selected color of emitted light. FIG. 15 illustrates an approach in which the light scattering material 31 is included within a separate layer. FIG. 16 illustrates an approach in which the light scattering material 31 is included within the layer containing the phosphor 30. FIG. 17 illustrates an alternative approach in which the light scattering material 31 is introduced into the lens 26. Any combination of the above may also be implemented. For example, the light scattering material 31 can be introduced into both the layer of phosphor 30 and the lens 26. In addition, the light scattering material can be included within both a separate layer 31 and the layer of phosphor 30. Moreover, the light scattering material 31 can be included within each of the separate layer, the layer of phosphor 30, and the lens 26.

Alternative approaches can be taken to improve the off-state white appearance of the lamp. For example, texturing can be incorporated into the exterior surface of the lamp to improve the off-state white appearance of the lamp, e.g. in the exterior surface of the lens 26.

Yet another possible approach is to implement a thin white layer directly after the yellow phosphor layer and before the clear linear optic. This three layer structure would be white appearance in the off-state but the primary optic would still be clear (not diffused/cloudy). This approach has the benefit of preserving the light distribution pattern of the linear lens optics while still providing white appearance.

Further details regarding an exemplary approach to implement scattering particles are described in U.S. patent application Ser. No. 11/185,550, filed on Oct. 13, 2011, entitled “Wavelength Conversion Component With Scattering Particles”, which is hereby incorporated by reference in its entirety.

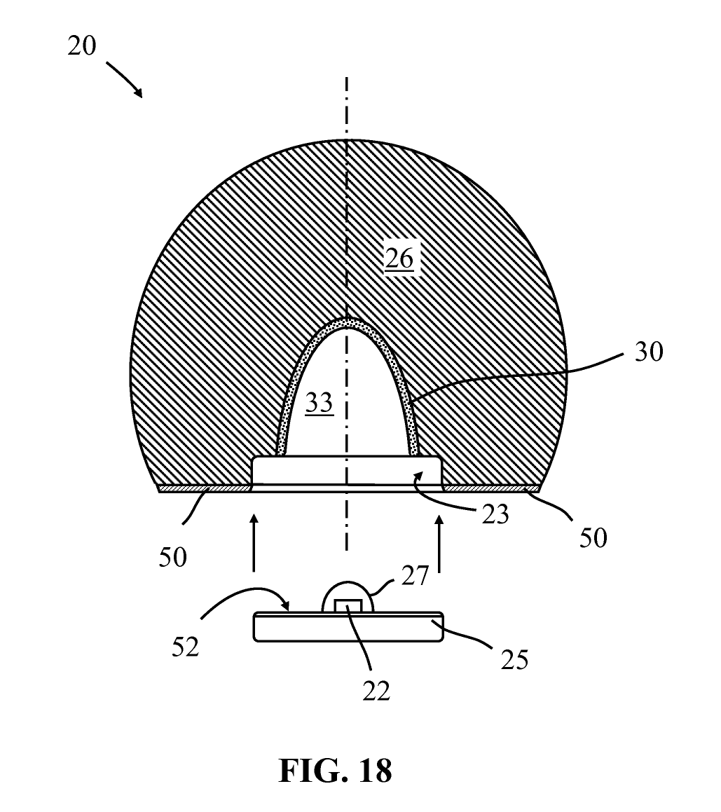

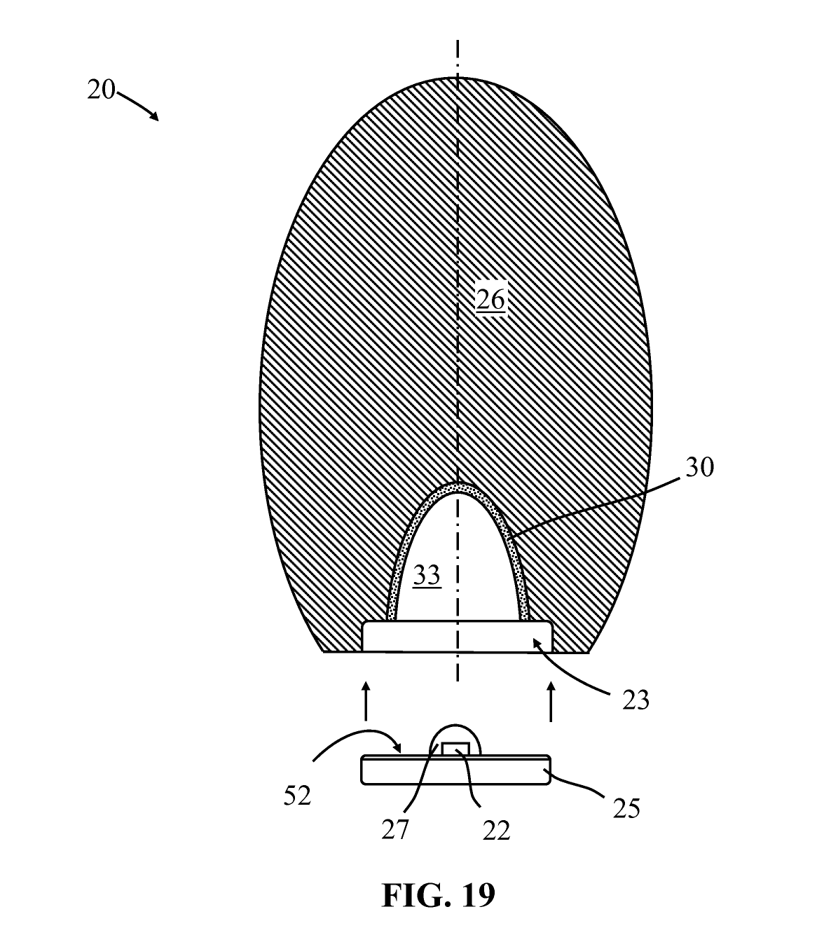

The approach of using an interior cavity as a “mixing chamber” can be applied to non-linear lamps as well. FIG. 18 shows a LED lighting arrangement 20 in accordance with an embodiment of the invention where the lens 26 comprises a solid semi-spherical shape. The LED chip 22 is mounted within the chamber 33 of the lighting arrangement 20, such that it is wholly contained within the interior of the profile of the phosphor 30. An indentation 23 is formed within the lens 26 to receive the PCB 25.

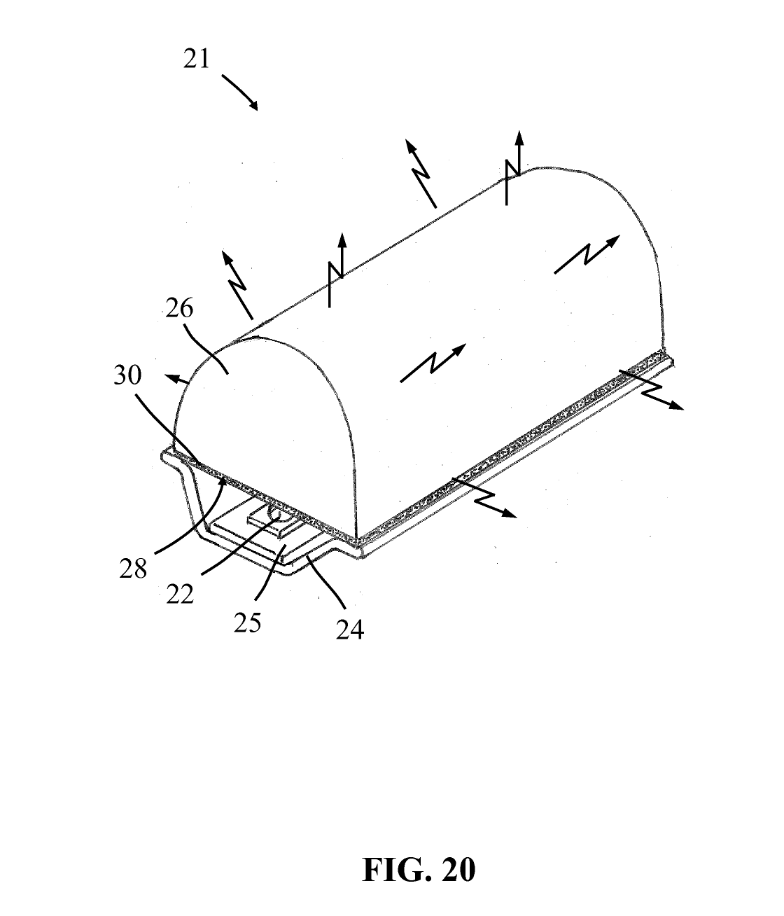

The lens 26 can be fabricated to provide any suitable shape as desired. For example, FIG. 20 shows an alternate LED lighting arrangement in accordance with an embodiment of the invention where the lens 26 comprises a solid ovoid shape. As before, the LED chip 22 is mounted within the chamber 33 of the lighting arrangement, such that it is wholly contained within the interior of the profile of the phosphor 30. An indentation 23 is formed within the lens 26 to receive the PCB 25.

Any of the embodiments described earlier can be configured as a linear lamp. For example, the embodiment of FIG. 2 shows a lamp having a convex lens 26 that is provided to focus light output from the arrangement, where the lens 26 is substantially hemispherical in form. The lens 26 has a planar, substantially flat, surface 28 onto which there is provided a layer of phosphor 30 before the lens is mounted to the enclosure 24. FIG. 20 illustrates a linear lamp with a cross-sectional profile having a similar structure. The linear lamp comprises an elongate lens 26 that is semi-circular in its cross-sectional shape, where the base of the lens 26 has a planar surface 28 onto which there is provided an elongate layer of phosphor 30. The LED 22 is mounted to a support surface where it is exterior to the lens 26.

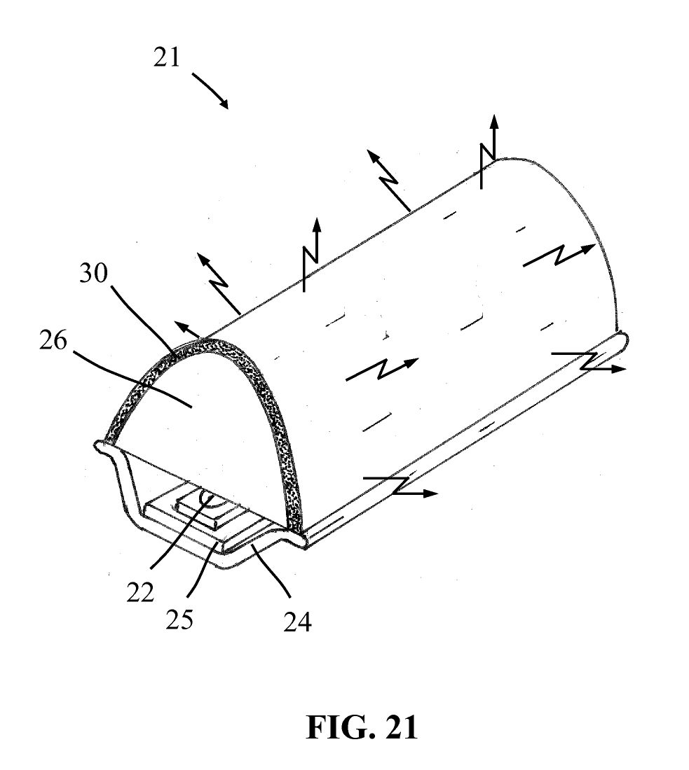

Similarly, the previously described embodiment of FIG. 3 is directed to an LED lighting arrangement in which the phosphor 30 is provided as a layer on the outer convex surface 32 of the lens 26. In this embodiment the lens 26 is dome shaped in form. FIG. 21 illustrates a linear lamp with a cross-sectional profile having a similar structure. The linear lamp comprises an elongate lens 26 that is semi-circular in its profile, where the phosphor 30 is provided as a layer on the outer surface of the lens 26.

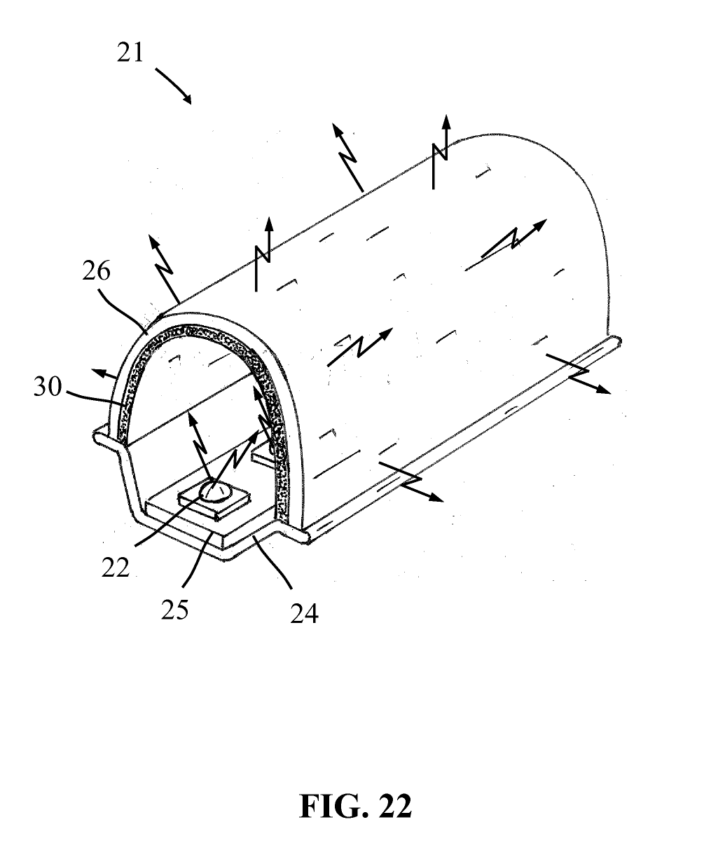

The previously described embodiment of FIG. 4 is directed to an LED lighting arrangement in which the lens 26 comprises a substantially hemispherical shell and the phosphor 30 is provided on either the inner or outer surface of the lens 26. FIG. 22 illustrates a linear lamp with a cross-sectional profile having a similar structure, in which the linear lamp comprises an elongate lens 26 having semi-circular shell profile, where the phosphor 30 is provided as a layer on the inner or outer surface of the lens 26.

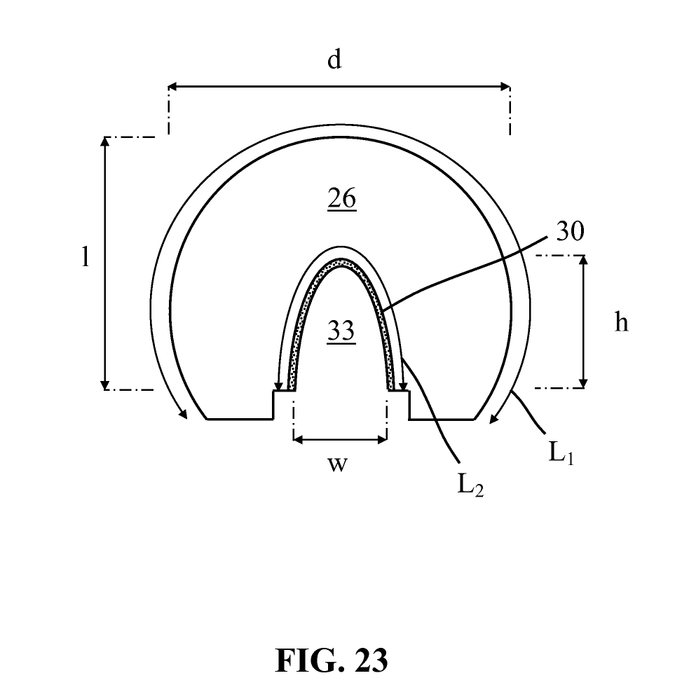

FIG. 23 illustrates an example configuration for the profile of a lamp according to some embodiments of the invention. The arrangement of this figure shows a phosphor portion 30 with a conical (or candle) sectional shape within the chamber 33. When implemented as a T8 replacement lamp, the overall diameter d=25.54 mm (1 inch), 1=20.70 mm, h=9.62 mm, and w=8 mm. The length L₁ for the exterior surface of the lens 26 exceeds the length L₂ of the surface of the phosphor portion 30. In some embodiments L₂ is at least two times L₁. The surface area of the phosphor material is 10.5 in²/ft.

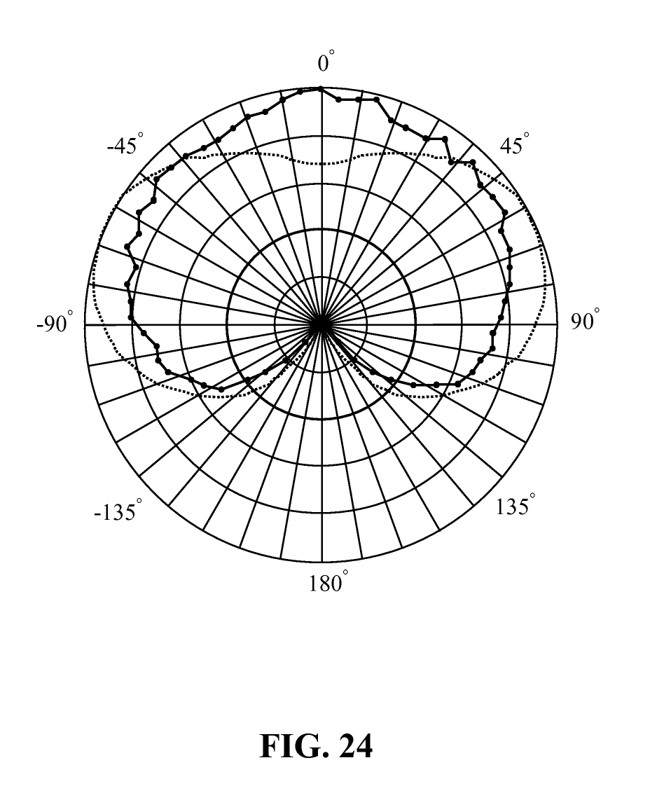

FIG. 24 is a diagram showing the emission patterns for light distributed by one example implementation of the lamp of FIG. 23. The dotted line shows the emission pattern for an example lamp that does not include a lens 26. The solid line shows the emission pattern for an example lamp that does include a lens 26. It can be seen that the lens serves to shape the emitted light such that a greater concentration generally occur towards 0 degrees on the chart (towards the tip of the conical shape of the phosphor portion 30).

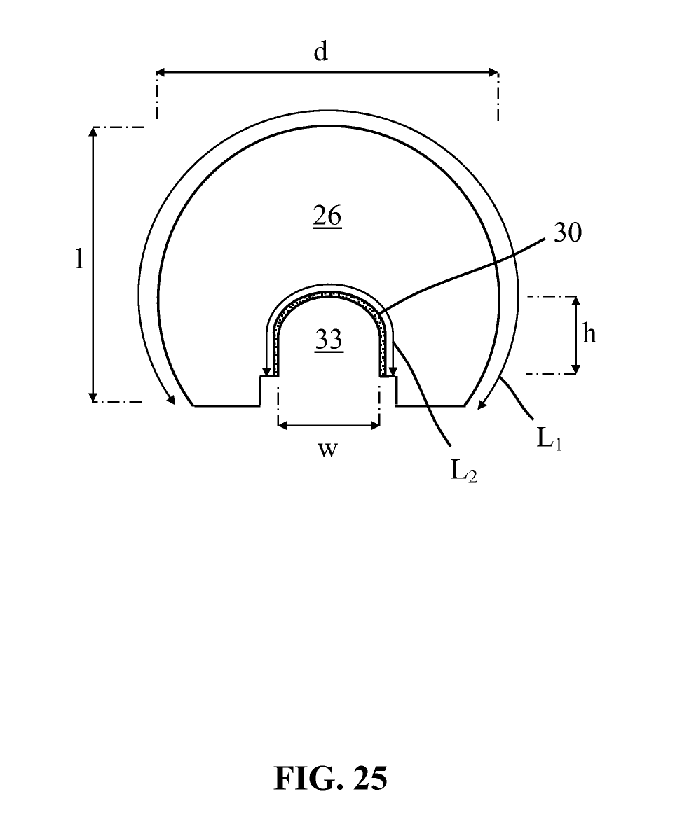

FIG. 25 illustrates another example configuration for the profile of a lamp according to some embodiments of the invention. The arrangement of this figure shows a phosphor portion 33 with a generally dome sectional shape within the chamber 33. When implemented as a T8 replacement lamp, the diameter d has a 1 inch (25.4 m) length and where 1=20.70 mm, and w=8 mm, same as the embodiment of FIG. 23. However, the value of h in this embodiment is 6 mm. As before, the length L₁ for the exterior surface of the lens 26 significantly exceeds the length L₂ of the surface of the phosphor portion 30, e.g., where L₂ is at least two times L₁. The surface area of the phosphor material is 7.8 in²/ft.

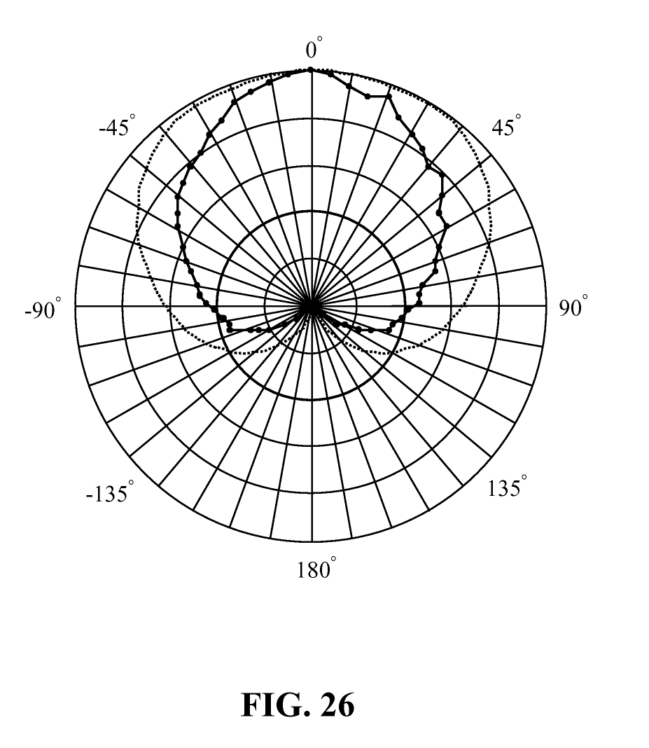

FIG. 26 is a diagram showing the emission patterns for light distributed by one example implementation of the lamp of FIG. 25. The dotted line shows the emission pattern for an example lamp that does not include a lens 26. The solid line shows the emission pattern for an example lamp that does include a lens 26. As before, it can be seen that the lens serves to shape the emitted light such that a greater concentration generally occur towards 0 degrees on the chart (towards the tip of the dome shape of the phosphor portion 30).

These diagrams show a clear difference between the emission pattern of the lamp of FIG. 23 and the emission pattern for the lamp of FIG. 25. The approach of using the dome-shaped cross-sectional profile provides a more uniform pattern in the near field (at or near the tube surface) light distribution and better far field beam control. The conical sectional shape of FIG. 23 provides a greater distribution of light along the sides of the lamp. In contrast, the dome-shaped sectional profile of FIG. 25 provides a greater distribution of light towards the top of the lamp. This highlights the ability to shape the light produced by the lamp by configuring the shape of the sectional profile of the phosphor/chamber in the lens. The approach of using the dome-shaped cross-sectional profile generally corresponds to less phosphor surface area than the cone-shaped sectional profile, which potentially translates to a less costly lamp design.

The arrangement of the lamp can also be configured to improve its light producing efficiency (also referred to herein as “System Quantum Efficiency” or SQE) and to reduce SQE light loss, where system quantum efficiency can be defined as the ratio of the total number of photons produced by the system to the number of photons generated by the LED. Many white LEDs and LED arrays are typically constructed of blue LEDs encapsulated with a layer of silicone containing particles of a powdered phosphor material or covered using an optical component (optic) including the phosphor material. The system quantum efficiency (SQE) of the known white LED and LED arrays is negatively affected by the loss of the total light output of the lamp during conversion of the blue LED light to white light, where the majority of light loss is not due to the photoluminescence conversion process but rather due to absorption losses for light (both photoluminescence and LED light) that is emitted back into the LED(s). Due to the photoluminescence conversion process being isotropic, photoluminescence light will be emitted in all directions and hence up to about 50% will be generated in a direction back towards the LED(s) giving rise to re-absorption and loss of photoluminescence light by the LED(s).

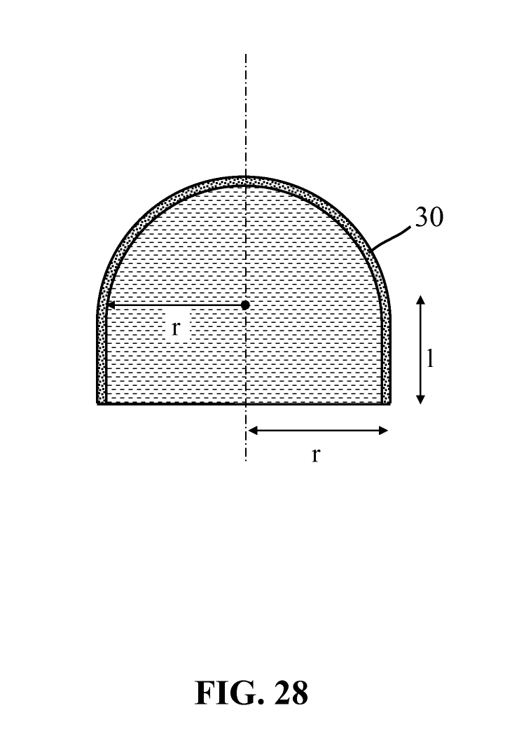

By appropriately configuring the aspect ratio of the phosphor portion 30, it is possible to eliminate or significantly reduce the SQE losses of the lamp. The aspect ratio of the phosphor portion 30 is the ratio of the area of the phosphor layer to the area of the LED package. FIG. 28 is an example of such a component that comprises a cylindrical body of axial length 1 and radius r having a hemispherical end and a planar end which is mountable to an LED package. The phosphor is provided on the cylindrical and hemispherical surfaces of the component. In this exemplary embodiment the area of LED package (i.e. the planar base of the component) is πr² whilst the surface area of the wavelength conversion component (phosphor) is 2πr²+27αrl. As a result the aspect ratio is 2(r+l)/r:l. For a component in which the length l=0.5r, that is a component whose length in an axial direction is one and a half times its diameter, the aspect ratio is preferably 3:1 (although other ratios may be employed in certain embodiments). For such a component the solid optic within chamber 33 transmits the majority of light to the opposite side of the phosphor optic and very little light returns to the LED and package base. Travelling through the solid optic has no refractive index changes so there is virtually 100% efficiency. Therefore the goal of this design is to maximize light emission by minimizing the amount of light returning to the LED package.

According to some embodiments of the invention, SQE loss is significantly eliminated or reduced by implementing the following combination of factors:
i) remote phosphor—the phosphor portion is separated from the LEDs;
ii) a coupling optic—An optical material having a high refractive index material is coupled directly to LEDs and the phosphor conversion component. This material should have a refractive index of 1.4 or greater (>1.5 preferred). Good optical coupling between the blue LEDs and the clear optic is used to ensure that it effectively acts as a light transport layer. By eliminating air interfaces and refractive index mismatches, virtually all light generated by the LEDs will travel with virtually no or minimal loss to the wavelength conversion component (phosphor layer).
iii) phosphor wavelength conversion layer with an aspect ratio greater than 1:1—the phosphor layer is separated from the blue LEDs by the clear coupling optic. Ideally the outer phosphor optic is the same refractive index as the clear layer and has no gap or other optical loss in the interface to the clear optic. The phosphor outer layer optic has an aspect ratio of 1:1 or greater such that the total surface area of the outer phosphor layer in contact with the clear coupling optic is at least three times the area of the LED package surface coupled to the clear coupling optic.

In operation blue light travels through the clear coupling optic with effectively no loss. When the blue light excites the phosphor layer and the photoluminescence light can now travel equally in any direction due to the elimination of the optical medium/air interface. Due to the high aspect ratio of the photoluminescence wavelength conversion component a majority of light (both phosphor generated light and scattered LED light) will not travel back to the LED package. Instead most light will travel through the clear optic to the other side and exit out of the phosphor layer on the opposing side. Once converted, YGR (Yellow, Green, Red) light easily passes through the phosphor layer. In summary, the majority of light is no longer re-cycled directly between the phosphor and the package/LEDs as it is in standard LED configurations.

With regard to linear lamp embodiments, any suitable manufacturing process may be employed to manufacture the lamp assembly. For example, a printing process can be employed where ink is printed using screen printing directly onto the lens surface. Other printing techniques can be used to print and/or coat the phosphor, such using roller coaters to coat the phosphor ink onto the lens. Spray coating is another technique that may be used to coat the phosphor onto the lens.

Lamination can also be performed to manufacture the linear lamp. In this approach, a separate sheet of phosphor material is manufactured, e.g. with or without a clear carrier layer. The sheet of phosphor is then laminated onto the light lens/pipe structure.

A co-extrusion process can be performed to manufacture a multi-layered linear lighting arrangement. Two extruders are used to feed into a single tool to create both the layer of phosphor and the materials of the lens. The two layers are simultaneously created and manufactured together in this approach. This approach can be used with a wide variety of source materials, e.g. PC-Polycarbonate, PMMA-Poly(methyl methacrylate), and PET-Polyethylene Terephthalate, including most or all thermoform plastics. This co-extrusion process can generally use pellets identical or similar to pellets used for injection molding materials. If the chamber in the lens includes a solid optical medium, then a co-extrusion approach can be used to manufacture the three layers with three extruders.

As noted above, a slot can be incorporated in the profile of the extrusion to accommodate the PCB or COB array. The use of an interior cavity approach makes for simple assembly and improved efficiency due to avoiding losses from an exterior mixing chamber. In some embodiments, the LEDs are mounted inside a linear mixing chamber and the extrusion is attached to the linear mixing chamber.

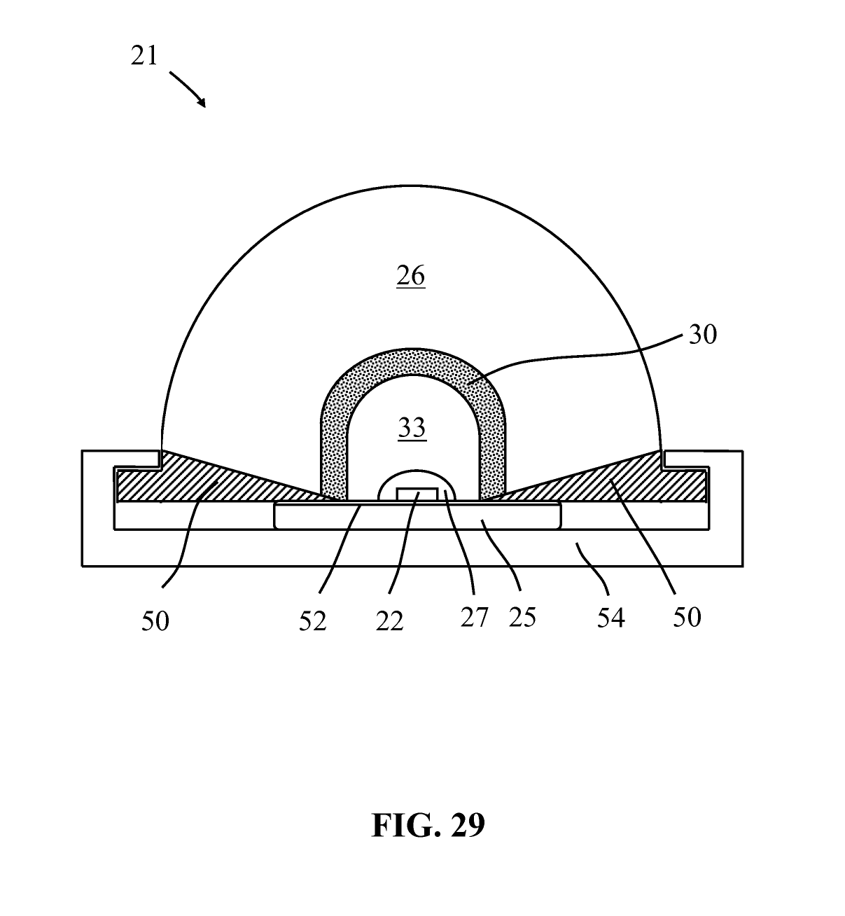

FIG. 29 illustrates the end view of another lamp according to some embodiments of the invention. The arrangement of this figure shows a multi-layered optic component, where the multi-layered optic component integrally includes a phosphor portion 30, a lens 26, and a reflector portion 50. As before, the phosphor portion 30 comprises a generally dome sectional shape that surrounds chamber 33. The lens 26 also comprises an exterior sectional profile having a dome shape. The reflector 50 is formed of any material that is capable of substantially reflecting light, and is intended to function by reflecting some or all of the phosphor-generated light from phosphor portion 30 away from the base of the lamp 21. In some embodiments, the reflector 50 comprises a white polycarbonate material.

A triple-extrusion process can be utilized to manufacture the multi-layered optic component, where three extruders are used to feed into a single tool to create the layer of phosphor, the materials of the lens, and the material of the reflector. Three extruders are used to feed into a single tool to create the three separate layers of materials, including phosphor, the materials of the lens, and the materials of the reflector. The three layers are simultaneously created and manufactured together in this approach. This approach can be used with a wide variety of source materials, e.g. PC-Polycarbonate, PMMA-Poly(methyl methacrylate), and PET-Polyethylene Terephthalate, including most or all thermoform plastics. This triple-extrusion process can generally use pellets identical or similar to pellets used for injection molding materials. If the chamber in the lens includes a solid optical medium, then a quadruple-extrusion approach can be used to manufacture the multiple layers with four extruders.

In some embodiments, the circuit board 25 having the array of LEDs 22 is mounted to, and in thermal communication with, a support body 54. The reflector 50 is formed having a lower flange portion that extends away from the central portion of the multi-layered optic component. The flange portion is configured to slot within a channel in support body 54. This allows the lamp 21 to be easily implemented by mounting support body 54 anywhere that a linear lamp is needed, and then attaching the multi-layered optic component to the support body by sliding the flange portion into the appropriate channels in the support body 54.

In alternate embodiments, the lamp is not manufactured by first mounting the LEDs 22 to the circuit board 25 that is attached to the support body 54. Instead, a co-extrusion process is utilized that manufactures the multi-layered optic component having the array of LEDs 22. In this embodiment, the LEDs 22 are attached to a flexible circuit board 25 that fed into the co-extrusion equipment, such that the multi-layered optic component is affixed to the circuit board having the LEDs as it is being formed.

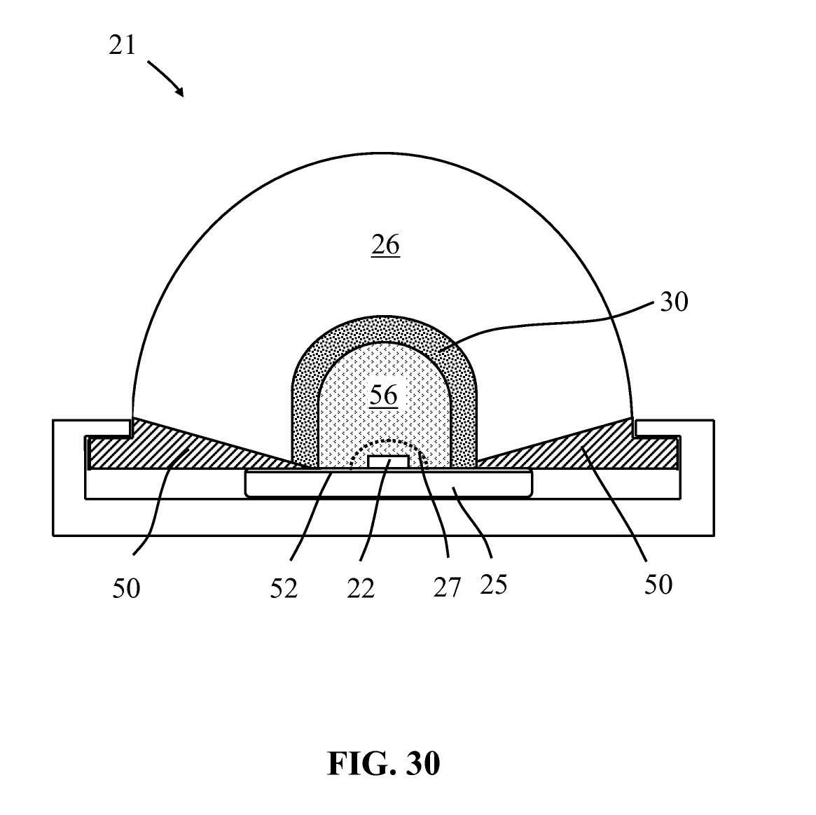

FIG. 30 illustrates an embodiment where the chamber is filled with an optical medium 56. The optical medium within the chamber 33 comprises a material, e.g., a solid material, possessing an index of refraction that more closely matches the index of refraction for the phosphor 30, the LEDs 22, and/or any type of encapsulating material 27 that may exist on top of the LEDs 22. As previously noted, one reason for using the optical medium 56 is to eliminate air interfaces that exist between the LEDs 22 and the phosphor 30. This reduces and/or eliminates any mismatches between the index of refraction of the material of the phosphor 30 and the index of refraction of the air within the interior volume 33 of the lamp 21. By reducing/preventing these mismatches in the indices of refraction, this removes the interfaces between air and the lamp components that may cause a significant portion of the light to be lost in the form of heat generation. By filling the chamber 33 with an optical medium 56, light is permitted to be emitted to, within, and/or through the interior volume of the lamp without having to incur losses caused by excessive mismatches in the indices of refraction for an air interface. The optical medium may be selected of any suitable material, e.g. silicone, to generally fall within or match the index of refraction for materials typically used for the phosphor 30, the LEDs 22, and/or any encapsulating material that be used to surround the LEDs 22.

If the chamber 33 in the lens includes a solid optical medium 56, then a co-extrusion approach can be used to manufacture the multi-layered optic component to also include the optical medium 56, e.g., by adding an extruder that for the material of the optical medium 56. If the optical medium 56 comprises a liquid material, then the liquid material can be injected or inserted into chamber 33 after the multi-layered optic component has been mounted onto the support body 54. If desired, a curing process (e.g., using UV light) can further be used to solidify the liquid material of the optical medium 56.

A light diffusing/scattering material can be used in conjunction with the multi-layered optic component. The light diffusing/scattering material is useful to reduce the quantity of phosphor material that is required to generate a selected color of emitted light. The light diffusing/scattering material is also useful to improve the off-state white appearance of the lamp 21.

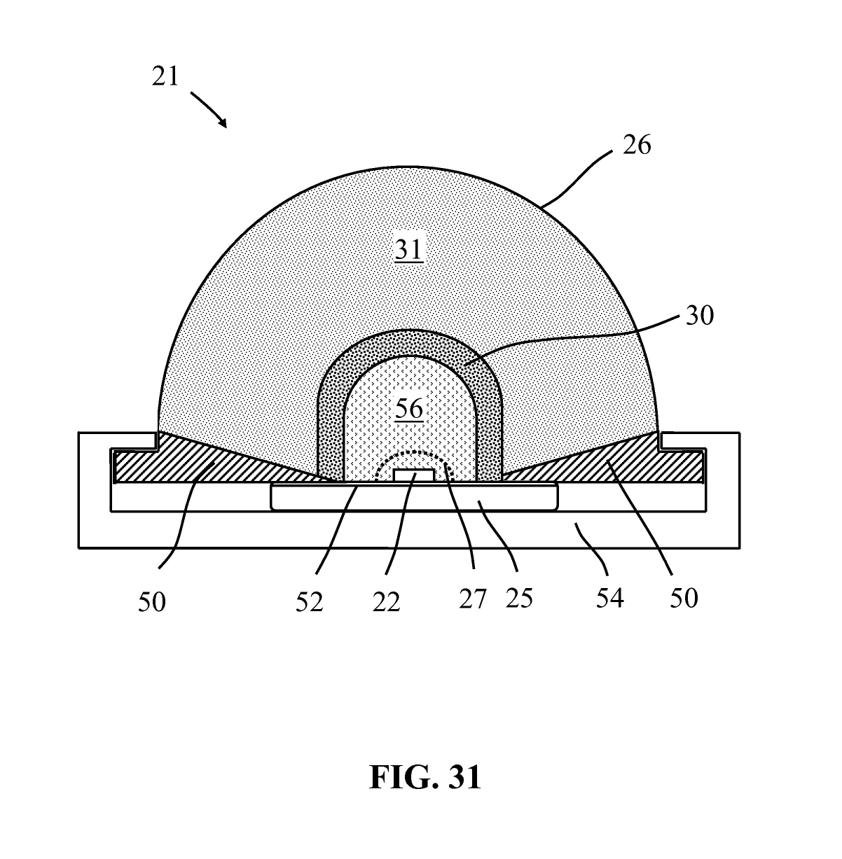

The light diffusing/scattering material may be included into any of the layers of the multi-layered optic. For example, the light diffusing/scattering material can be incorporated into the layer containing the phosphor 30, added to the lens 26, included as an entirely separate layer, or any combination. FIG. 31 shows an embodiment in which the light diffusing/scattering material 31 has been incorporated into the material of the lens 26 in the multi-layered optic component.

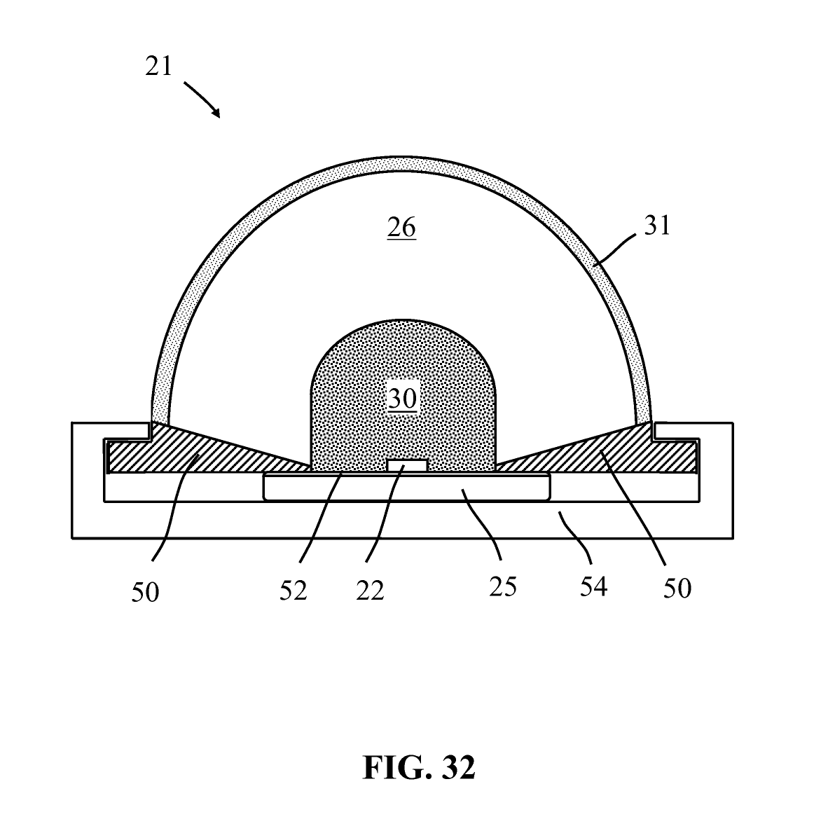

In any of the disclosed embodiments, the combination of the solid optical medium 56 and the phosphor 30 can be replaced by a layer of material that entirely fills the volume surrounding the LED 22, but which also includes the phosphor integrally within that layer of material. This approach is illustrated in FIG. 32. Here, the lamp 21 does not have a thin separate layer of phosphor. Instead, the entirety of the interior volume that surrounds the LED 22 is filled with material that also includes the phosphor 30. This provides a hybrid remote-phosphor/non-remote-phosphor approach whereby the phosphor is located in the layer of material that fills the interior cavity, but some of the phosphor is located in close proximity to the LEDs 22 (in the inner portion of the material adjacent to the LED), but much of the phosphor is actually quite distant to the LEDs 22 (in the outer portion of the material away from the LED).

This approach therefore provides much of the advantages of remote-phosphor designs, while also maximizing light conversion efficiencies (due to elimination of mismatches in indices of refraction from eliminating air interfaces). Manufacturing may also be cheaper and easier, since the extrusion processes and apparatuses only need to extrude the single layer of materials, rather than an extruder for the phosphor material and a separate extruder for the optical medium material.

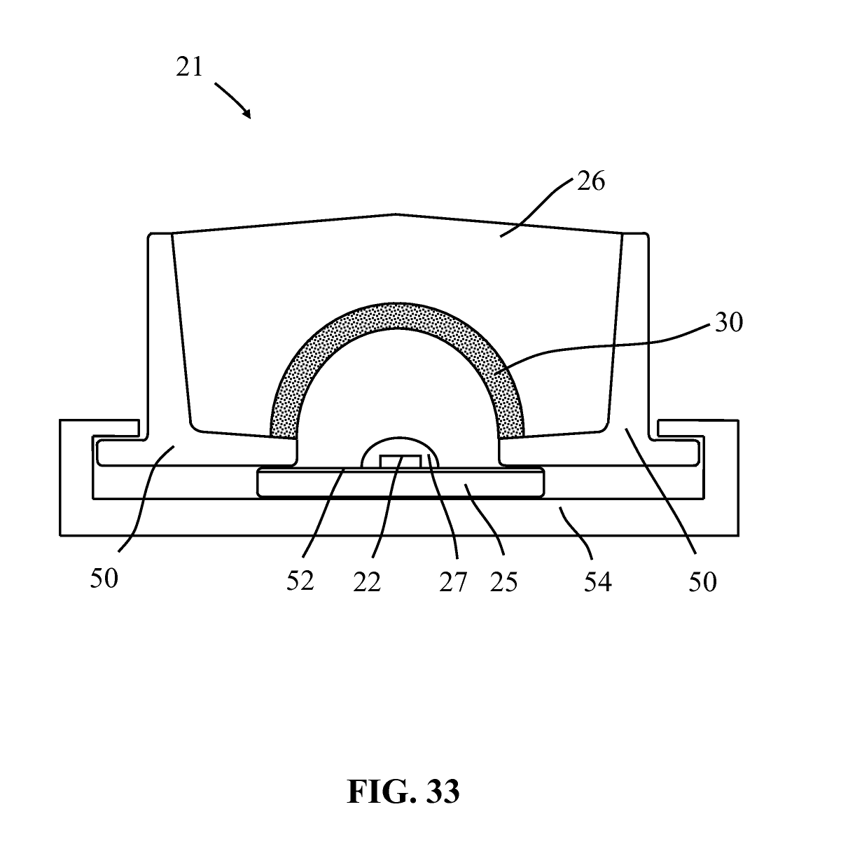

FIG. 33 shows another embodiment in which the reflector 50 comprises high side walls. The side walls are useful to focus the light emitted form lamp 21 into a desired direction. The side walls of the reflector 50 can be configured, however, in any manner needed to generate a desired light emission pattern from the lamp 21.

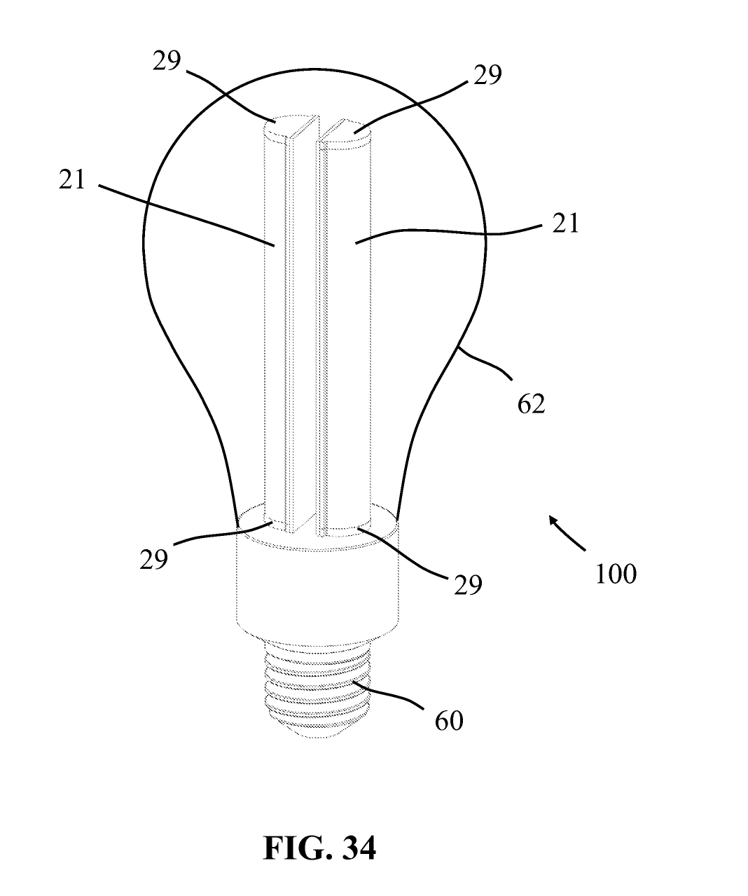

FIG. 34 illustrates an embodiment of a lamp 100 in which one or more linear lighting arrangements 21 are placed inside of an envelope 62 to form a replacement for a standard incandescent light bulb. As such, lamp 100 may include standard electrical connectors 60 (e.g., standard Edison-type connectors) that allow lamp 100 to be used in conventional lighting devices.

The linear lighting arrangements 21 function as the lighting elements in the lamp 100. The linear lighting arrangements 21 are vertically oriented, extending axially within the lamp 100, with end caps 29 placed at the end (e.g., distal end) of the linear lighting arrangements 21. Internally, the LEDs within the linear lighting arrangements 21 are oriented radially from the central axis of lamp 100. This configuration provides a good overall emission pattern from lamp 100 over a wide range of emission angles, with the exact dimensions (e.g., length, width) of the linear lighting arrangements 21 selected to provide a desired emission profile.

The envelope 62 may be configured in any suitable shape. In some embodiments, envelope 62 comprises a standard light-bulb shape. This permits the lamp 100 to be used in any application/location that could otherwise be implemented with a standard incandescent light bulb. The envelope 62 may include or be used in conjunction with a diffuser. In some embodiments, scattering particles are provided at the envelope 62, either as an additional layer of material or directly incorporated within the material of envelope 62.

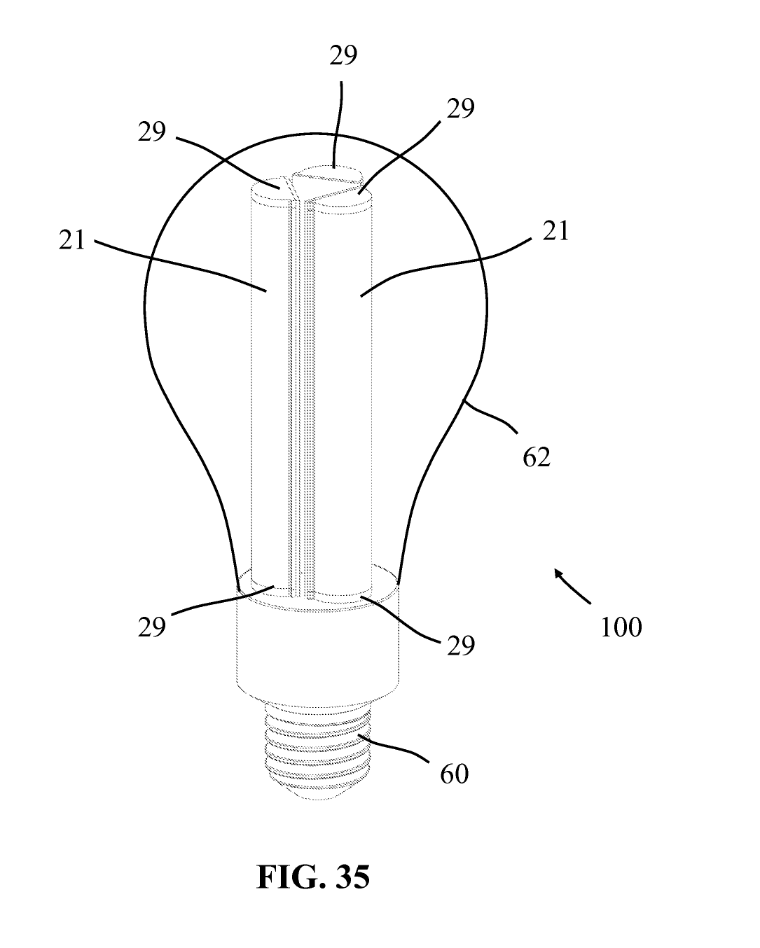

Any number of linear lighting arrangements 21 may be included in the lamp 100. Two linear lighting arrangements 21 are shown in the embodiment of FIG. 34. FIG. 35 illustrates an embodiment where three linear lighting arrangements 21 are arranged within the lamp 100. The exact number of linear lighting arrangements 21 to be placed into lamp 100 is selected to provide achieve desired performance characteristics. Examples of further LED bulbs implemented using linear lighting arrangements are disclosed in co-pending U.S. patent application Ser. No. 29/443,392, filed Jan. 16, 2013, entitled “LED Light bulbs”, which is hereby incorporated by reference in its entirety.

Some embodiments of the invention are directed to improved lamps that provide significant advances in their manufacturing process and structure, where the lamp does not need to utilize conventional LED packaging structures.

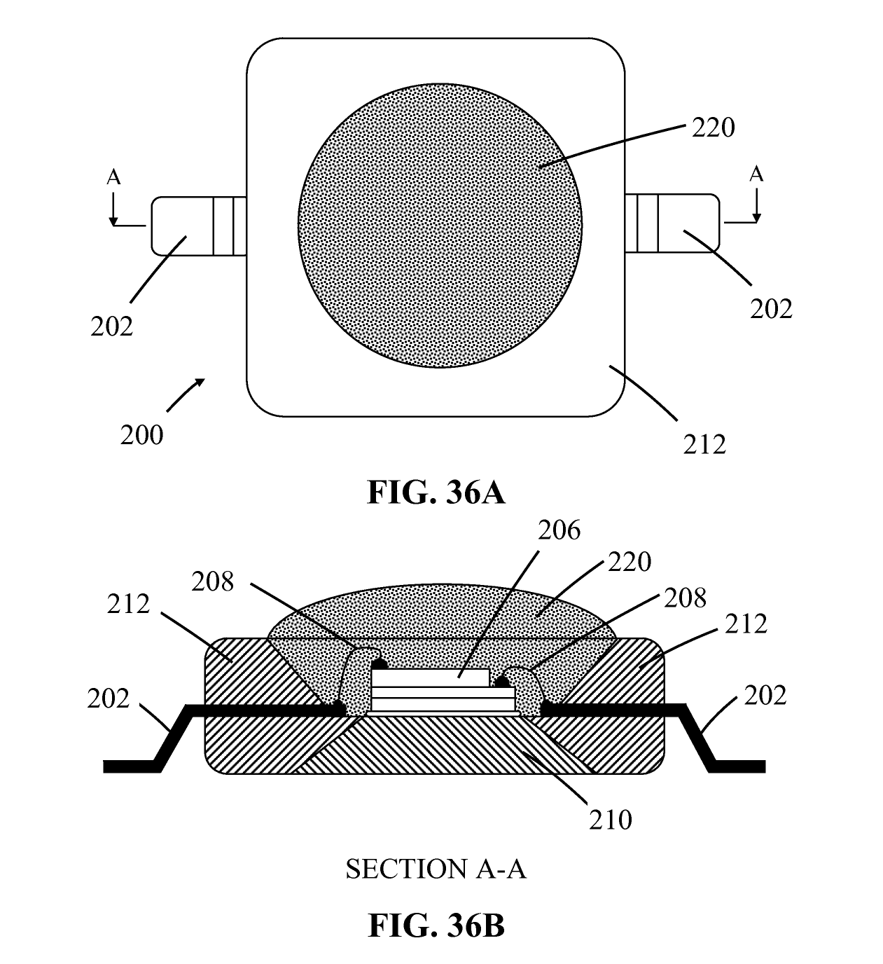

To explain, consider the conventional packaged LED 200 shown in FIGS. 36A and 36B. This conventional packaged LED 200 includes an LED chip/die 206 that resides within the bottom of a dish-shaped cavity within a package 212. Leads 202 are used to conduct electricity to the packaged white LED, where bond wires 208 provide the connection paths from the leads 202 to the LED chip/die 206. An encapsulant 220 is typically provided on the LED chip/die 206 to reduce light losses due to an air interface at the surface of the LED chip/die 206. The encapsulant 220 completely surrounds the LED chip/die 206 and fills the entirety of the cavity within the package 212. One main reason for providing the encapsulant 220 is to minimize any losses associated with differences between the index of refraction of the LED 206 and any surrounding air around the LED 206. If the packaged LED 200 is designed to produce white light, then the packaged LED 200 will also include a phosphor material within the encapsulant. Rather than being remote from the LED chip/die 206, the phosphor encapsulation will instead actually be formed as part of the packaged white LED 200.

Requiring a conventional LED package to include these supporting structures can end up adding a very significant amount to the final cost to manufacture and use LEDs in a lighting device. However, conventional LED-based lighting devices all require LED packages having these or similar packaging structures. This can significantly drive up the cost of the LED lighting devices to manufacturers and consumers. This inhibits and prevents broad adoption of LED lights, which are often much more efficient and energy efficient when compared to conventional incandescent lights.

For example, it is notable that an encapsulant 220 is conventionally provided as part of the packaging on the known LED packaging structures. The problem is that the requirement to provide encapsulant 220 necessarily introduces additional manufacturing steps, manufacturing time requirements, manufacturing costs, and materials costs to a conventional packaged LED structure. In some cases, the total costs of manufacturing and/or purchasing a packaged LED may be increased by at least 30% or more as a result of requiring encapsulant 220 to be provided onto the package structure. However, it is not realistic to save these costs by simply choosing not to include encapsulant 220 onto the package structure, since failure to include the encapsulant 220 could result in very significant performance and efficiency problems due to the excessive index of refraction issues.

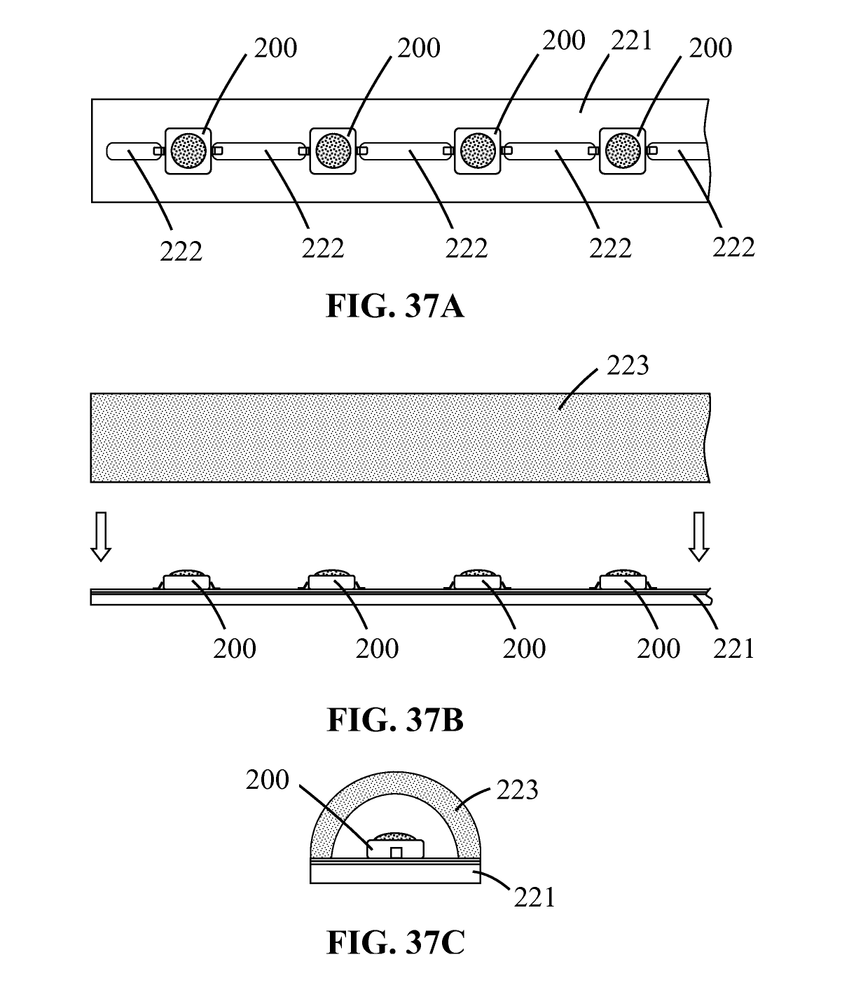

These problems associated with the conventional LED packages are not limited to single LED package structures. FIGS. 37A, 37B, and 37C illustrate this problem in the context of an array 238 of packaged LEDs 200, which may be used for example in a linear lamp. The array 238 of packaged LEDs 200, are mounted onto a circuit board 221. Each of the packaged LEDs is connected to another LED package with circuit tracks 222. When used in a linear light arrangement, a diffuser cover 223 may be placed over and around the array 238 of packaged LEDs 200.

Here, the array 238 of packaged LEDs 200 include LEDs having a conventional LED packaging structure, including for example, an encapsulant 220 over the LED chip/die 206. The problems described above with regards to the costs of requiring the structures for a conventional LED package are therefore multiplied with respect to the number of LEDs that are required in the array 238.

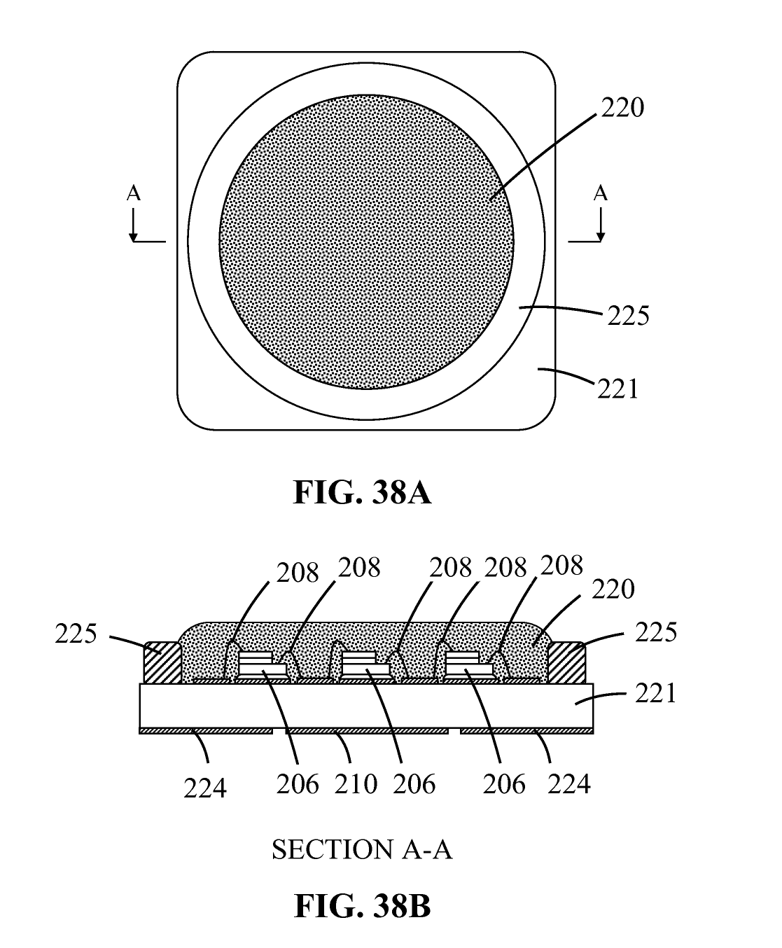

This problem may exist for any type of an array that is used for LEDs. For example, consider FIGS. 38A and 38B which illustrate a schematic plan and cross-sectional views of a chip-on-board (COB) LED structure 226. Here, an entire array of packaged LED chips 206 are placed within a packaging structure (such as the packaging structure described above). The array of LEDs 206 is placed on the circuit board 221 between annular walls 225. An encapsulant 220 is placed over and around the entire array of packaged LED chips. Contact pads 224 provide electrical conductivity from the COB LED structure 226 to control electronics.

The problems described above with regards to the costs of requiring the structures for a conventional LED package (e.g., encapsulant 220) therefore also apply to the COB structure 226. These requirements for conventional package structures necessarily introduce additional manufacturing steps, manufacturing time requirements, manufacturing costs, and materials costs to the COB structure.

Embodiments of the present invention provide an improved approach to implement lamps that do not suffer these disadvantages. The present embodiment is usable to manufacture an LED-based lighting device that does not require conventional LED packaging structures. For example, instead of requiring conventional LED packages that include a costly encapsulant, lamps can be implements that use lamp modules having LEDs that do not require integrated encapsulant.

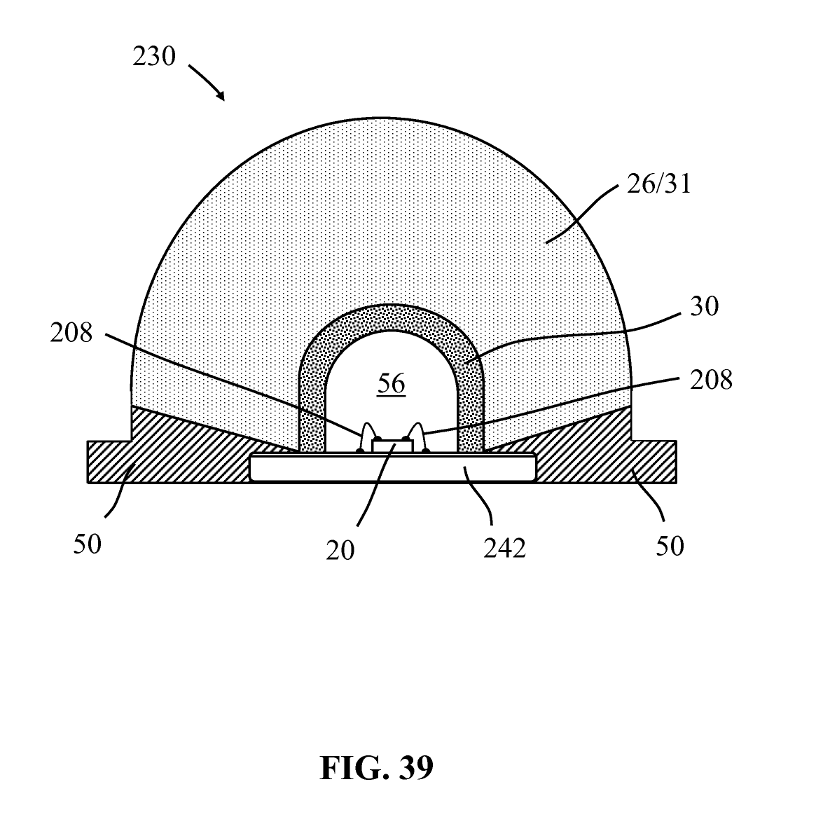

FIG. 39 illustrates the end view of a lamp module 230 according to some embodiments of the invention. The arrangement of this figure shows a lamp module 230 having a multi-layered optic component 21 and LEDs 22. The multi-layered optic component 21 integrally includes a phosphor portion 30, a lens 26, and a reflector portion 50. The phosphor portion 30 comprises a generally dome sectional shape. The lens 26 also comprises an exterior sectional profile having a dome shape. The reflector 50 is formed of any material that is capable of substantially reflecting light, and is intended to function by reflecting some or all of the phosphor-generated light from phosphor portion 30 away from the base of the lamp.

Notably, a conventional LED package structure is not required for the LEDs 22 in this lamp module 230. Instead, the LEDs 22 are mounted onto a substrate 242 without requiring much of the packaging structures that were previously described for conventional LED packages. In fact, it can be visually seen that there is the complete absence of a “package” that surrounds LED 22 in the lamp module 230.

It is also noted that a separate encapsulant (shown as encapsulant 220 in the previous figures) is not provided as part of the LED 22 in the present approach. Instead, the lamp module 230 is manufactured such that an optical medium 56 is provided, which removes the need to separately encapsulate the LED 22 with an encapsulant. This means that the optical medium 56 within the chamber 33 will provide the necessary material to eliminate air interfaces that exist between the LEDs 22 and the phosphor 30, which reduces and/or eliminates any mismatches between the index of refraction of the material of the phosphor 30 and the index of refraction of the LEDs 22.

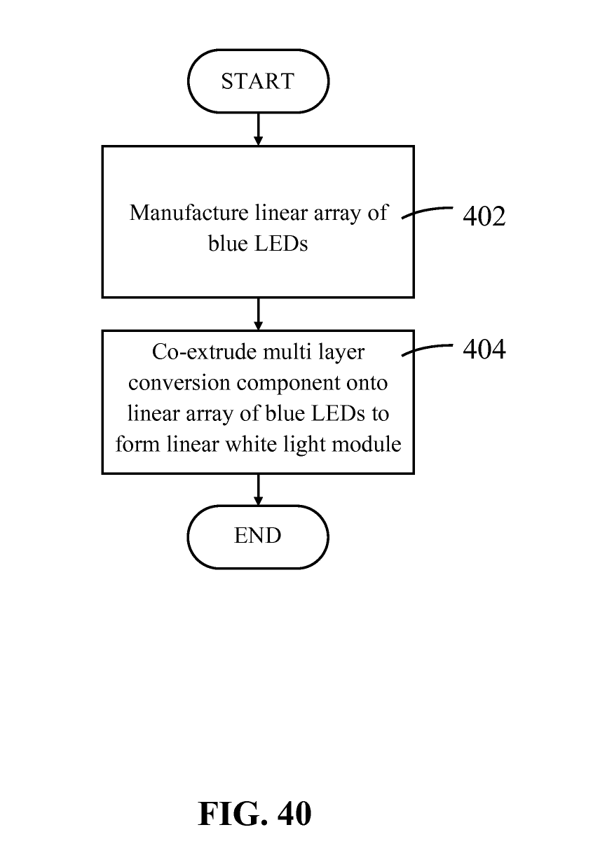

FIG. 40 illustrates a flowchart of an improved method for manufacturing a white light module 230 and/or lamp according to some embodiments. The method is particularly appropriate for manufacture of a linear lamp module, although usable to manufacture modules for other types of lamps as well. Therefore, the following description is being provided in the context of linear lamps, although not limited to such lamps unless explicitly claimed as such.

At 402, the method receives a linear array of LEDs. The linear array of LEDs is provided without requiring the individual LEDs to be placed into conventional packaging structures. Instead, the array of LEDs may be directly provided on a substrate as bare chips. The array of LEDs on the substrate are appropriately wired and connected together.

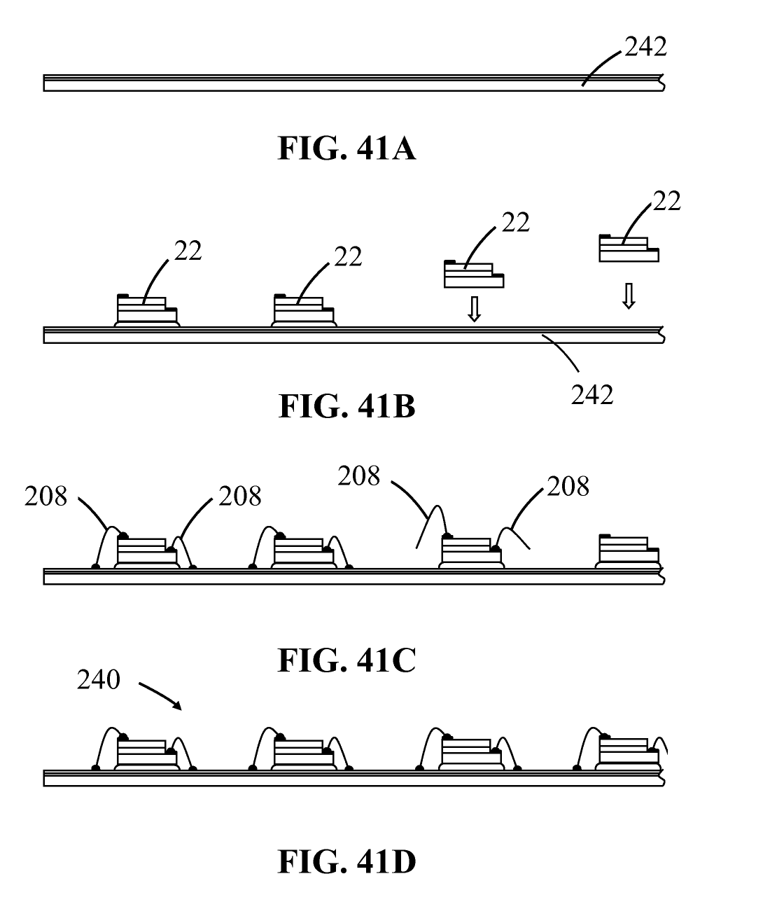

FIGS. 41A-D illustrate one example approach for manufacturing the linear array 240 of LEDs 22. The approach shown in these figures pertain to a wire-bonding approach, although flip-chip technology is usable as well. FIG. 41A shows the substrate 242 prior to the mounting of any LED chips 22. Any suitable substrate 242 may be employed as the platform for the LED chips 22. The substrate 242 may be, for example, a flexible circuit board. FIG. 41B illustrates the LED chips 22 being placed onto the substrate. A die attach adhesive is applied to mount the bare dies for the LED chips onto the substrate. The LED chips 22 are affixed with spacing appropriate for the expected lighting needs of the lighting module. FIG. 41C illustrate the process of affixing the bond wires 244 to each LED chip 22 and to leads on the substrate 242. FIG. 41D illustrates final configuration for the linear array 240 of the LEDs. It is noted that this array 240 of LEDs does not include an encapsulant on each of the individual LEDs 22 themselves.

Returning back to FIG. 40, the next manufacturing step at 404 is to co-extrude the multi-layer conversion component 21 onto the linear array 240 of LEDs. This creates the linear light module 230 that is usable within a linear lamp.

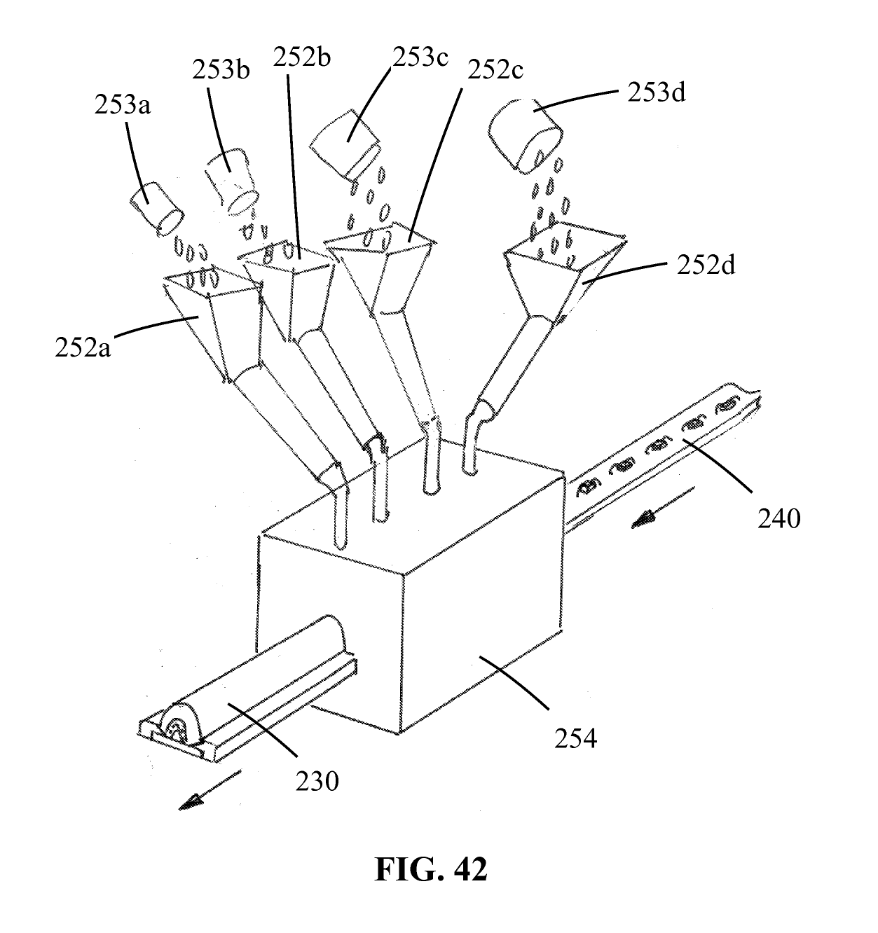

FIG. 42 illustrates this process for co-extruding the multi-layer conversion component 21 onto the linear array 240 of LEDs to forms the white light module 230. In this approach, multiple extruders 252a-d feed into a single extrusion head 254 to create the white light module 230. This approach can be used with a wide variety of source materials, e.g. PC-Polycarbonate, PMMA-Poly(methyl methacrylate), and PET-Polyethylene Terephthalate, including most or all thermoform plastics. This co-extrusion process can generally use pellets identical or similar to pellets used for injection molding materials.

A first extruder 252a processes the material 253a for the lens portion 26 of the white light module 230. As previously noted, a light diffusing/scattering material can be used in conjunction with the multi-layered optic component, e.g., by placing the light diffusing/scattering material into the lens 26. The light diffusing/scattering material is useful to reduce the quantity of phosphor material that is required to generate a selected color of emitted light. The light diffusing/scattering material is also useful to improve the off-state white appearance of the lamp. Therefore, the first extruder 252a can be used to process a polymer material 253a for the lens portion 26 that also includes the light diffusing/scattering material. In some embodiments, the light reflective material comprises titanium dioxide (TiO₂) though it can comprise other materials such as barium sulfate (BaSO₄), magnesium oxide (MgO), silicon dioxide (SiO₂) or aluminum oxide (Al₂O₃).

A second extruder 252b processes the material 253b for the phosphor portion 30 of the white light module 230. Therefore, the second extruder 252d can be used to process a polymer material that also includes the phosphor material.

A third extruder 252c processes the material 263c for the optical medium 56. The third extruder 252c is used to process a solid material (e.g., clear polymer), that possesses an index of refraction that more closely matches the index of refraction for the phosphor 30 and the LEDs 22. The material for the optical medium 56 may be selected from any suitable material, e.g. silicone, to generally fall within or match the index of refraction for materials typically used for the phosphor 30 and the LEDs 22.

The fourth extruder 252d processes the material 253d for the reflector 50. The fourth extruder 252d is therefore used to process a light reflective material, e.g., a light reflective polymer that is typically white in color.

The extruders 252a-d are used to feed their respective materials 253a-d into a single extruder head 254 to create the multiple portions of materials in the multi-layer conversion component 21 of the white light module 230. The linear array 240 of LEDs 22 on the flexible substrate 242 is also fed into the extruder head 254. The phosphor portion 30, lens portion 26, optical medium portion 56, and reflector portion 50 are integrally created and shaped around and over the linear array 240 of LEDs 22 on the flexible substrate 242.

The final product is the white light module 230, where the various phosphor portion 30, lens portion 26, optical medium portion 56, and reflector portion 50 are shaped as illustrated in FIG. 39. This manufacturing approach therefore results in a white light module 230 where the optical medium 56 within the chamber 33 provides the necessary material to eliminate air interfaces that exist between the LEDs 22 and the phosphor 30. Despite the fact that a separate encapsulant 220 is not individually provided as part of the package for the LEDs 22, the final product nonetheless is a white light module 230 where the advantageous configuration of the optical medium 56 reduces and/or eliminates any mismatches between the index of refraction of the material of the phosphor 30 and the index of refraction of the LEDs 22. This means that a much less costly approach can be taken to manufacture the light module 230 (and any resultant lamps), since the approach does not require the LEDs to be provided in a conventional package structure, and especially a package structure that requires integral encapsulant surrounding the LEDs.

The method described in shown in FIG. 40 can also be used to manufacture a white light module 230 where the LEDs are provided on a Chip-On-Wire structure, instead of providing the LEDs on a solid substrate 242.

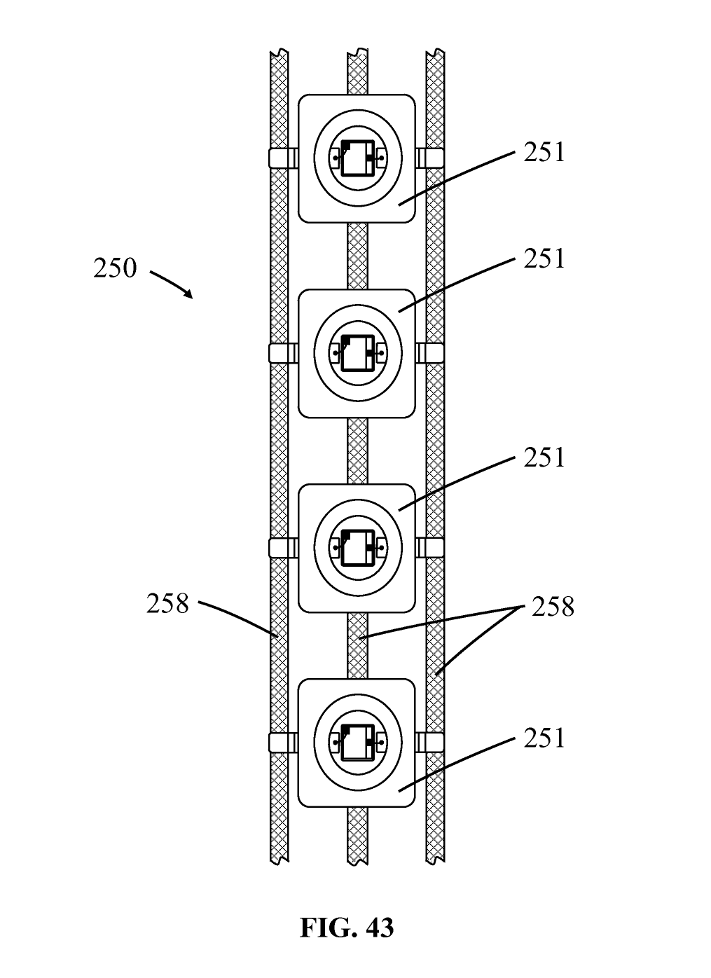

FIG. 43 illustrate an example Chip-On-Wire structure 250, which includes an array of LEDs that are aligned and mounted along a set of wires 258. The wires 258 not only conduct power, but may also serve as a support and alignment structure. In some embodiments, the wires also function as a heat sink for the array of LEDs 251. The wires 258 can be formed of any suitable wiring structure, e.g., braded wires or solid wires. Any number of wires 258 can be used in the Chip-On-Wire structure 250. For example, a set of three wires 258 can used, where the two exterior wires couple power/ground to the LEDs and the third wire provides a central support for the LEDs.

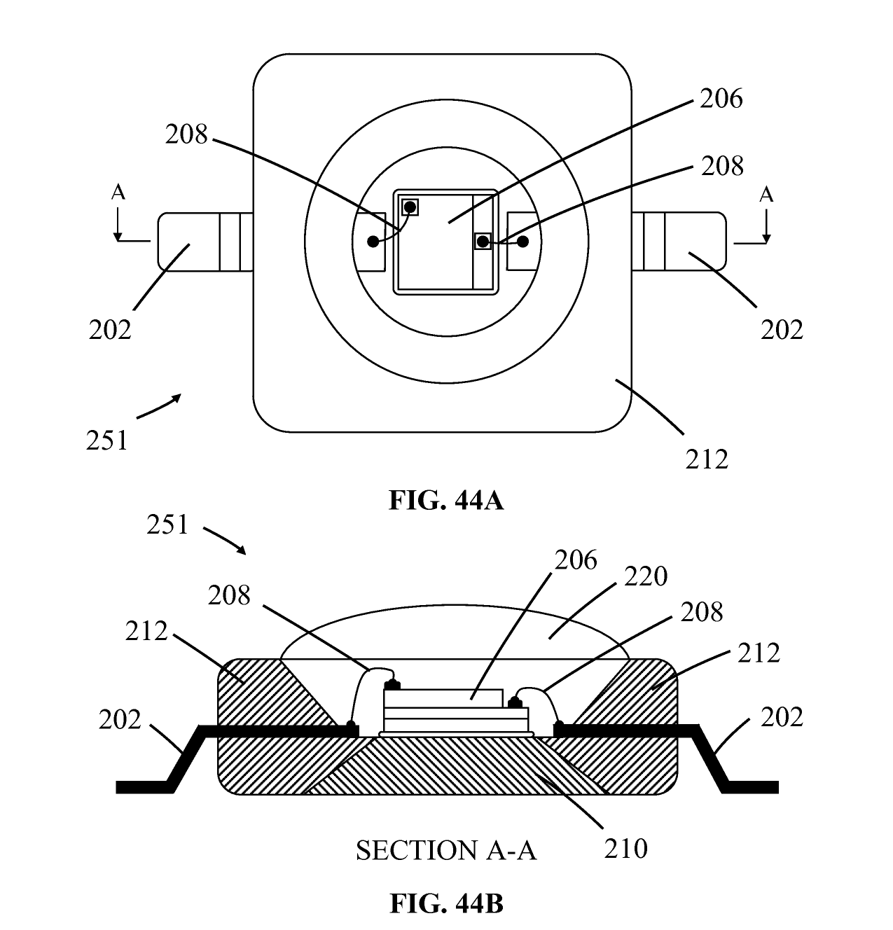

Any appropriate LED configuration can be used in the Chip-On-Wire structure 250. FIGS. 44A and 44B illustrate an example of a packaged LED structure 251 (e.g., for a blue LED) that is usable in the Chip-On-Wire structure 250. The packaged LED structure 251 includes an LED chip/die 206 mounted within a package 212 (such as a ceramic or plastic package). The LED chip/die 206 is bonded to a heatsink slug/pad 210. Bond wires 208 are affixed to contacts on the LED chip/die 206. The other end of the bond wires 208 are attached to leads 202. The leads 202 couple to the wires 258 that provide power/ground connections to the array of LEDs. In the current embodiment, the packaged LED structure 251 is provided without integrated encapsulant 220, since an optical medium portion 56 is manufactured as part of the white light module 230. However, in alternative embodiments, encapsulant 220 is provided as part of the packaged LED structure 251.

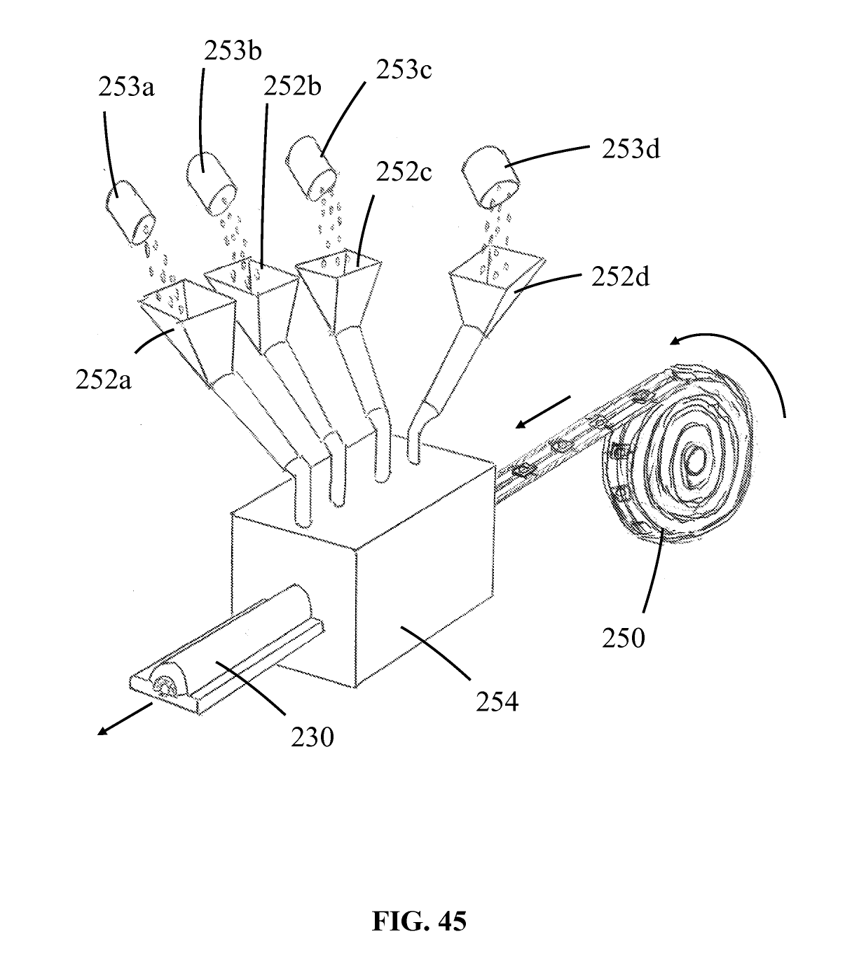

FIG. 45 illustrates the process of co-extruding the multi-layer conversion component 21 onto a linear packaged LED structure 250 to form the white light module 230. As before, multiple extruders 252a-d feed into a single extrusion head 254 to create the component 21. A first extruder 252a processes the material 253a for the lens portion 26 of the white light module 230. A second extruder 252b processes the material 253b for the phosphor portion 30 of the white light module 230. A third extruder 252c processes the material 253c for the optical medium. The fourth extruder 252d processes the material 253d for the reflector 50. The extruders 252a-d are used to feed their respective materials 253a-d into a single extruder head 254 to create the multiple portions of materials in the multi-layer conversion component 21 of the white light module 230.

Unlike the approach that was previously described with respect to LEDs on a solid substrate, the present approach shown in FIG. 45 receives a linear array of LEDs 251 on the Chip-On-Wire structure 250. The Chip-On-Wire structure 250 is fed into the extruder head 254 where the phosphor portion 30, lens portion 26, optical medium portion 56, and reflector portion 50 are integrally created and shaped around and over the linear array of LEDs 251 on the Chip-On-Wire structure 250 to form the final layers and shapes of the white light module 230. In some embodiments, the optical medium portion 56 is extruded to conform to the shape of the LEDs on the Chip-On-Wire structure 250 so that an encapsulation 27 does not necessarily need to be included on the packaged LED structure 251 of the Chip-On-Wire structure 250. However, this manufacturing process is also usable even if encapsulation 220 is integrally included on the packaged LED structure 251 of the Chip-On-Wire structure 250.

It is noted that the flexible nature of the Chip-On-Wire structure 250 permits the linear array of LEDs to be fed into the extruder head 254 from a spooled storage structure for the Chip-On-Wire structure 250. This highlights one of the advantages derived from using the Chip-On-Wire structure 250, which allows for improved space efficiency during the manufacturing process, both during the transit/shipping of the materials as well as at the manufacturing facility.

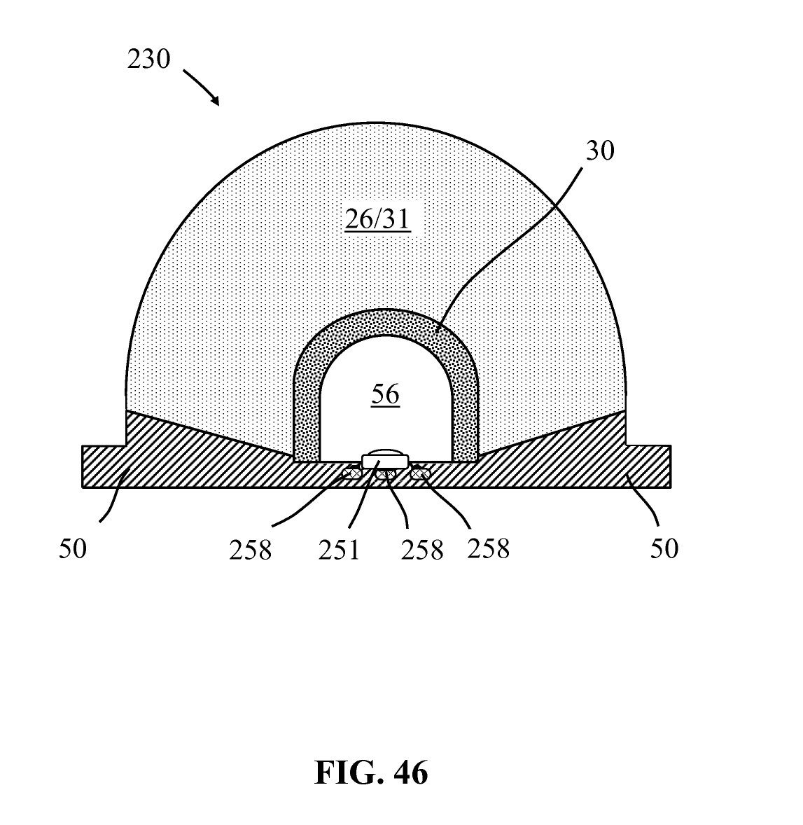

The final product is the white light module 230, where the various phosphor portion 30, lens portion 26, optical medium portion 56, and reflector portion 50 are shaped as illustrated in FIG. 46. In the current embodiment, the reflector portion 50 is extruded and shaped such that the wires 258 for the Chip-On-Wire structure 250 are embedded within the reflector portion 50.

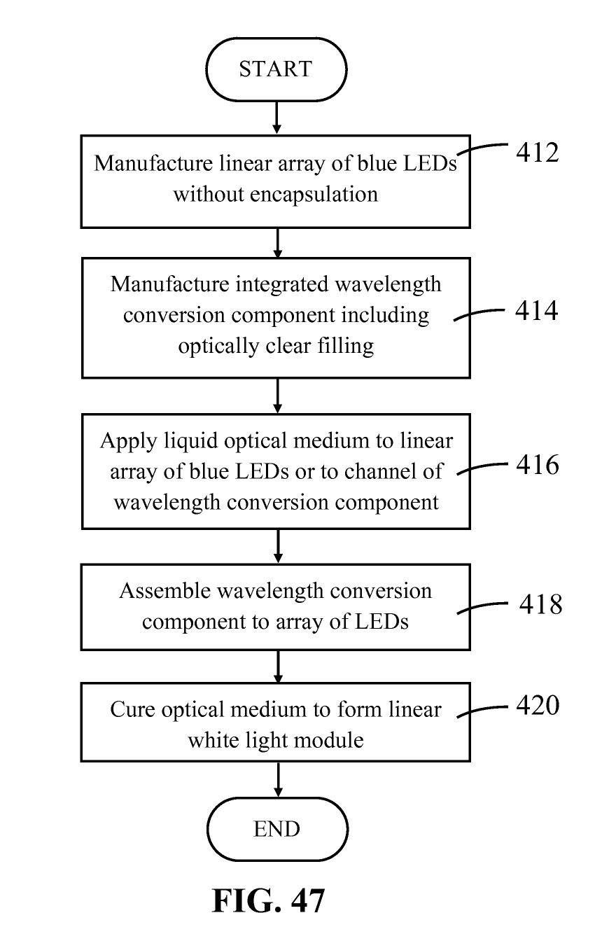

FIG. 47 illustrates a flowchart of an alternative method for manufacturing a white light module 230, where the LEDs do not include the LEDs in a conventional package structure and/or where the LEDs do not include an integrated encapsulant 27. This embodiment is used when it is not desirable or possible to co-extrude the entirety of the white light module 230 to include the array of LEDs. Instead, the multi-layered optic component 21 is separately manufactured from the array of LEDs, and the array of LEDs is later affixed to the multi-layered optic component 21.

At 412, the method receives a linear array of LEDs, such as the array 240 shown in FIG. 41D. The linear array of LEDs is provided without integrated encapsulant being placed onto the array of LEDs. Instead, the array of LEDs may be provided on a substrate as bare chips. The array of LEDs on the substrate are appropriately wired and connected together.

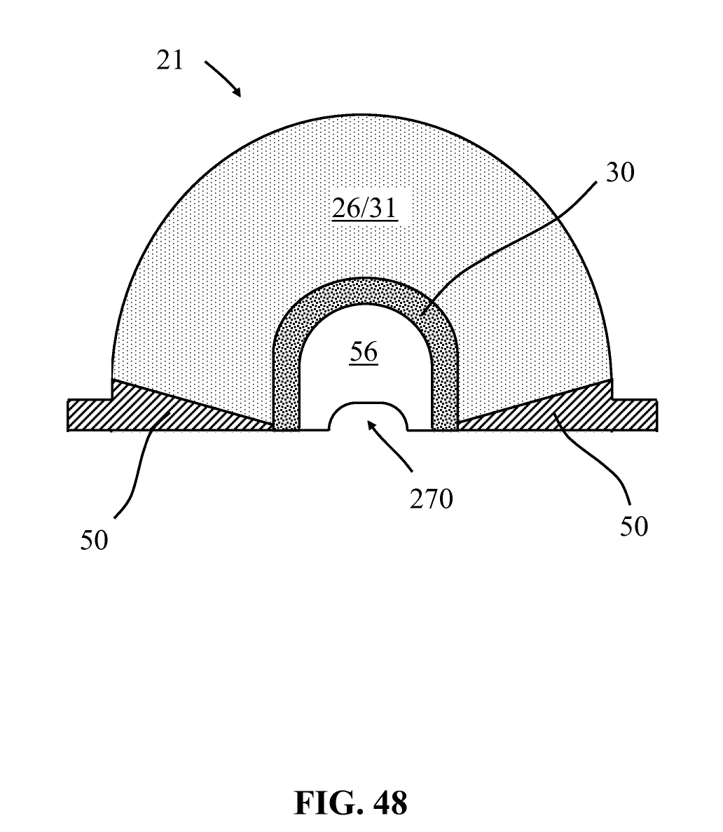

The next step at 414 is to manufacture the multi-layer conversion component 21, e.g., as illustrated in FIG. 48. Like the embodiments described above, the multi-layered optic component 21 of FIG. 48 integrally includes a phosphor portion 30, a lens 26 (which may include diffuser particles 31), a reflector portion 50, and an optical medium 56. The phosphor portion 30 comprises a generally dome sectional shape that surrounds chamber 33. The lens 26 also comprises an exterior sectional profile having a dome shape. The reflector 50 is formed of any material that is capable of substantially reflecting light, and is intended to function by reflecting some or all of the phosphor-generated light from phosphor portion 30 away from the base of the component 21. In some embodiments, the reflector 50 comprises a white polycarbonate material. The optical medium 56 comprises a material possessing an index of refraction that more closely matches the index of refraction for the phosphor 30 and any LEDs 22 to be used in conjunction with component 21.

However, unlike the previously described multi-layered optic components, the current embodiment includes a channel 270 that is formed within the optical medium 56. This channel 270 is sized and shaped to match the profile of the LEDs, so that the multi-layered optic component 21 can properly receive the linear array of LEDs during later stages of the manufacturing process.

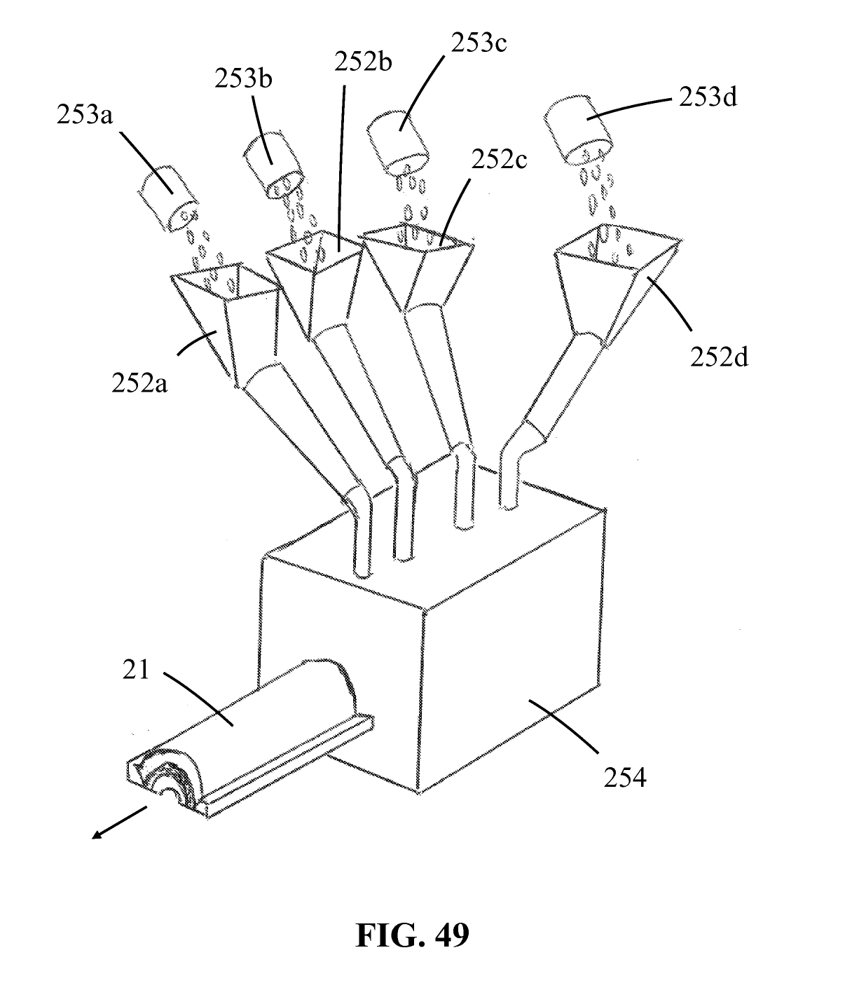

FIG. 49 illustrates a process for co-extruding the multi-layer conversion component 21. As before, the multiple extruders 252a-d feed into a single extrusion head 254 to create the component 21. The first extruder 252a processes the material 253a for the lens portion 26 of the white light module 230. A second extruder 252b processes the material 253b for the phosphor portion 30 of the white light module 230. A third extruder 252c processes the material 253c for the optical medium. The fourth extruder 252d processes the material 253d for the reflector 50.

The extruders 252a-d are used to feed their respective materials 253a-d into a single extruder head 254 to create the multiple portions of materials in the multi-layer conversion component 21. Here, it is noted that the extruder head 254 will shape the optical medium portion 56 to include the appropriately sized and shaped channel 270. The final product is the multi-layer conversion component 21 which includes channel 270 in the optical medium portion 56.

Returning back to FIG. 47, the next manufacturing step at 416 is to apply a liquid optical medium to the linear array of LEDs and/or to the channel 270. It is likely and/or possible that the channel 270 will not provide an exact fit for the LEDs on the substrate. If this is the case, than any air gaps between the channel 270 and the LEDs could potentially create air interfaces that reduce the efficiency of the final lamp product. Therefore, the liquid optical medium is provided in sufficient quantities to fill in any gaps that may exist.

At 418, the next step is mount the linear array of LEDs to the multi-layer conversion component 21, where the LEDs themselves are received into the channel 270 in the multi-layer conversion component 21. At 420, the liquid optical medium is cured, e.g., by using any appropriate method such as application of heat or UV light.

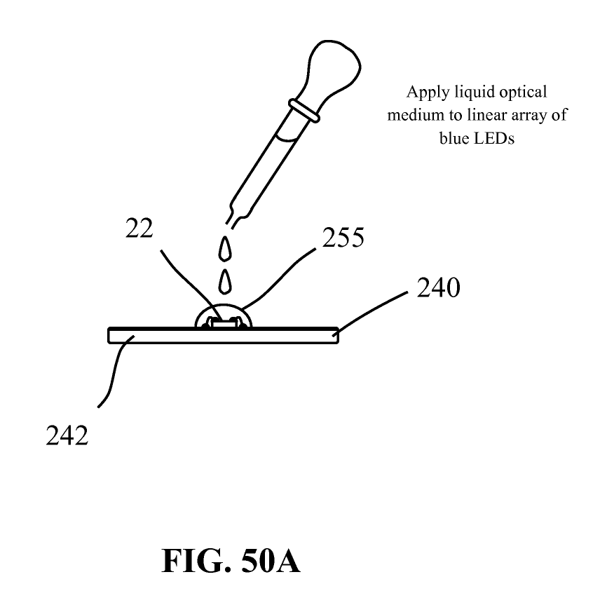

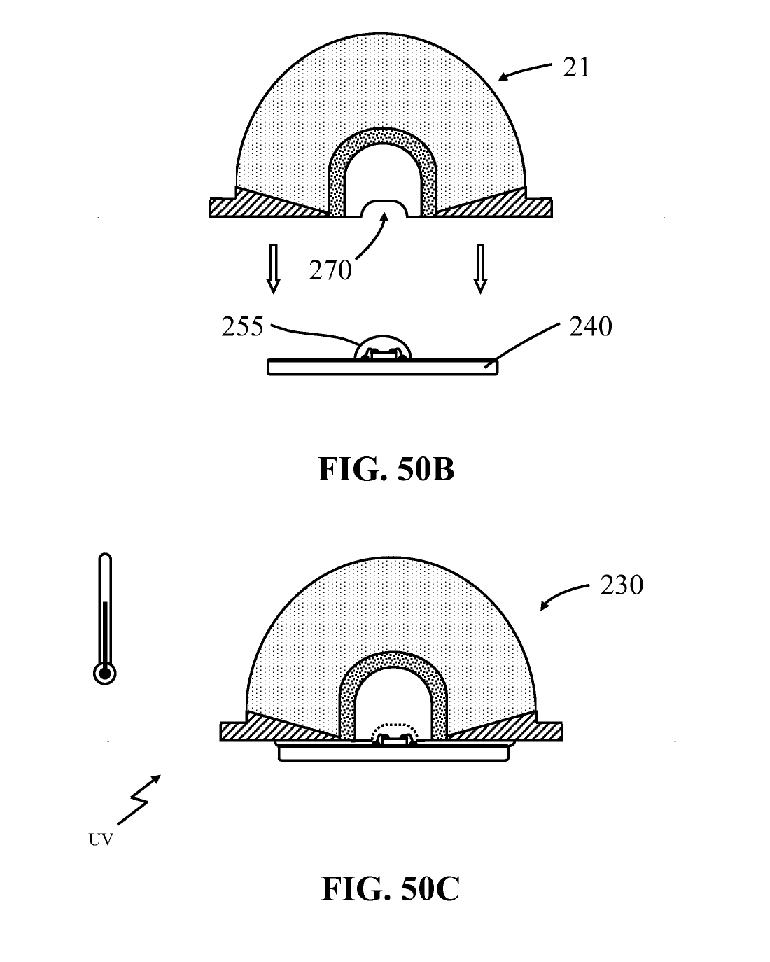

FIGS. 50A-C illustrate these assembly steps according to one embodiment. As shown in FIG. 50A, the liquid optical medium 255 is applied to the LEDs 22 on the substrate 242. Next, as shown in FIG. 50B, the multi-layer conversion component 21 is attached to the array of LEDs 240, where the LEDs 22 are received into channel 270 in the multi-layer conversion component 21. The final action illustrated in FIG. 50C is to cure the liquid optical medium 255.

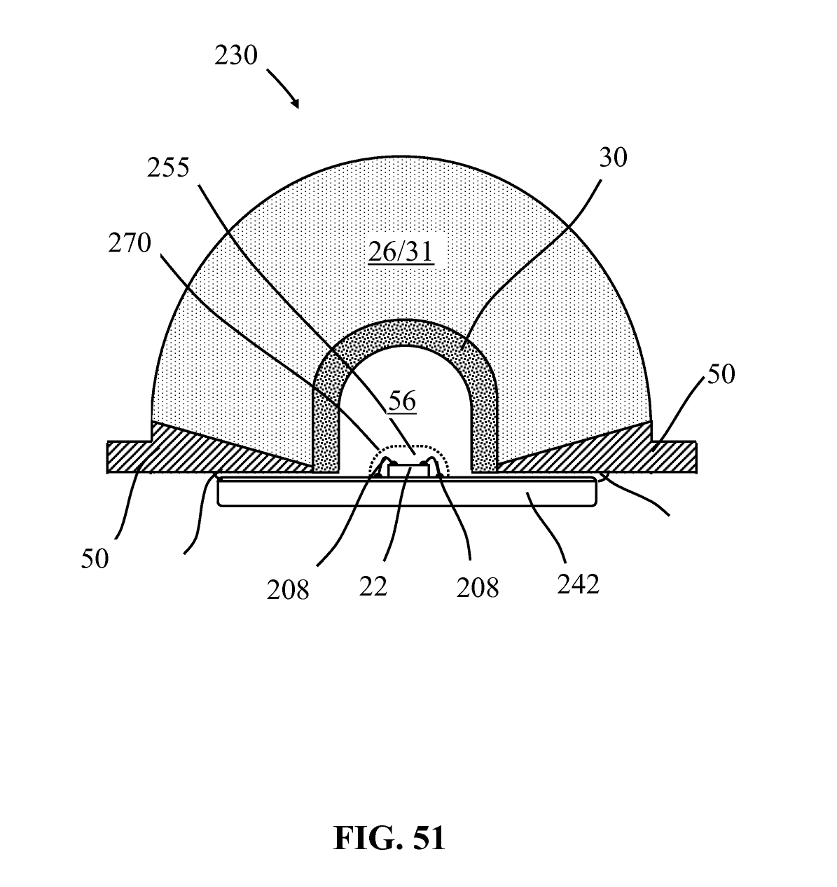

This manufacturing approach results in the white light module 230 shown in FIG. 51 where the final product does not require the LEDs to be provided in a conventional LED package structure. In addition, even though the LEDs were not provided on a package structure having integrated encapsulate over the LEDs, the optical medium 56 in the present approach (combining both the portion extruded for the multi-layer conversion component 21 as well as the portion from application of the liquid optical medium) provides the necessary material to eliminate air interfaces that exist between the LEDs 22 and the phosphor 30. Despite the fact that a separate encapsulant 220 is not provided as part of the package for the LED 22, the final product nonetheless is a white light module 230 where the advantageous configuration of the optical medium 56 (and the added optical medium 255) reduces and/or eliminates any mismatches between the index of refraction of the material of the phosphor 30 and the index of refraction of the air within the interior volume 33. This means that a much less costly approach can be taken to manufacture the light module 230 (and any resultant lamps), since the approach does not require the LEDs to be provided in a conventional package structure or to require integral encapsulant to individually surround the LEDs.

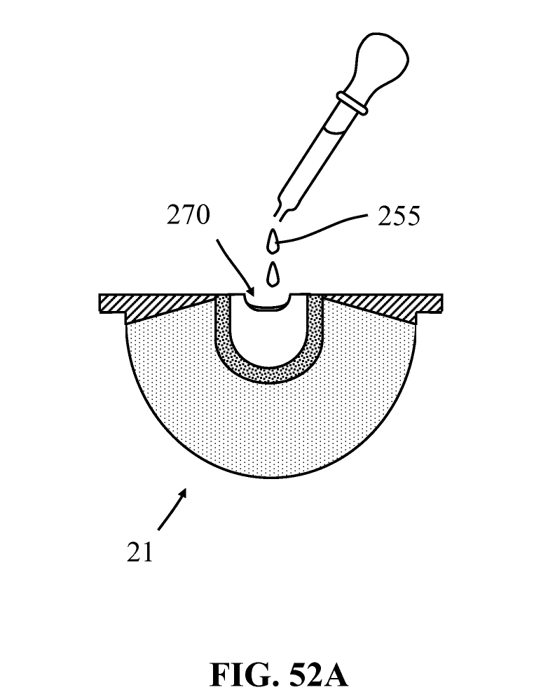

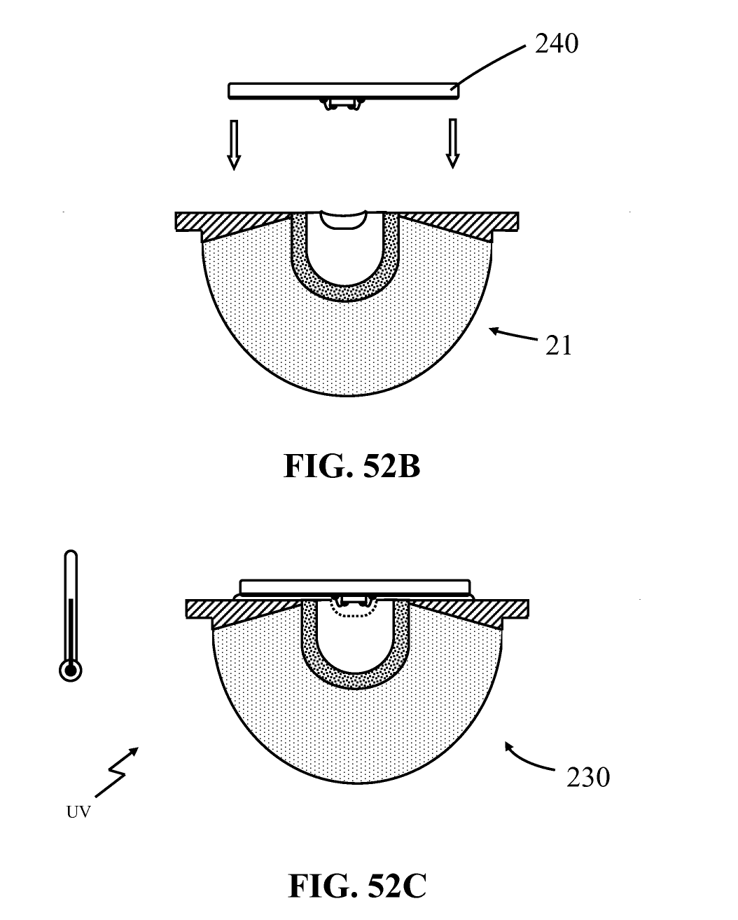

FIGS. 52A-C illustrate an alternative approach to implement the final assembly steps, where the liquid optical medium 255 is applied to the multi-layer conversion component 21 (instead of the LEDs as descried for the previous embodiment). As shown in FIG. 52A, the liquid optical medium 255 is applied to the channel 270 on the multi-layer conversion component 21. Next, as shown in FIG. 52B, the multi-layer conversion component 21 is attached to the array of LEDs 240, where the LEDs 22 are received into channel 270 in the multi-layer conversion component 21. The final action illustrated in FIG. 52C is to cure the liquid optical medium 255. As before, this manufacturing approach results in a white light module 230 where the optical medium 56 (combining both the extruded portion as well as the liquid optical medium portion 255) provides the necessary material to eliminate air interfaces that exist between the LEDs 22 and the phosphor 30.

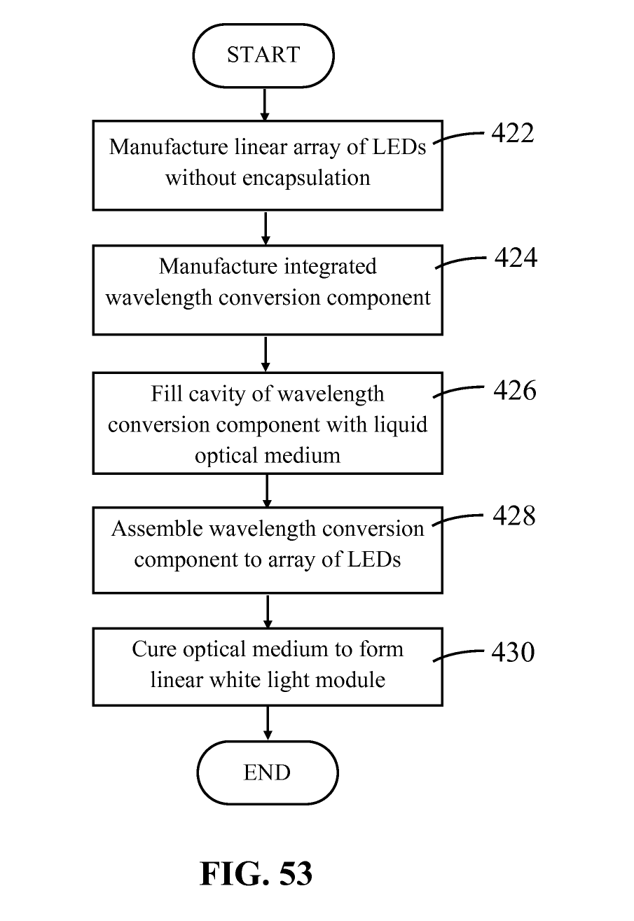

FIG. 53 illustrates a flowchart of yet another method for manufacturing a white light module 230 where the LEDs do not need to be provided in a conventional package structure or provided to include an integrated encapsulant 220. This embodiment is also used in the situation where it is not desirable or possible to co-extrude the entirety of the white light module 230 to include the array of LEDs. Instead, the multi-layered optic component 21 is separately manufactured from the array of LEDs, and the array of LEDs is later affixed to the multi-layered optic component 21.

At 422, the method receives a linear array of LEDs, such as for example the array 240 shown in FIG. 41d. The linear array of LEDs is provided without integrated encapsulant being placed onto the individual LEDs on the array of LEDs. Instead, the array of LEDs may be provided on a substrate as bare chips. The array of LEDs on the substrate are appropriately wired and connected together.

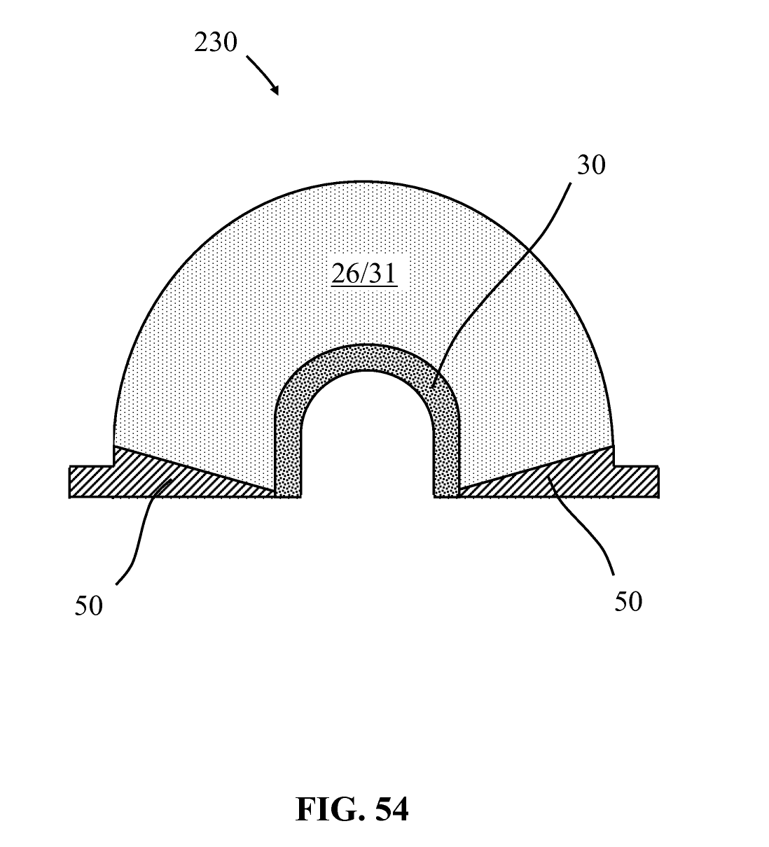

The next step at 424 is to manufacture the multi-layer conversion component 21, e.g., as illustrated in FIG. 54. Like the embodiments described above, the multi-layered optic component 21 of FIG. 54 integrally includes a phosphor portion 30, a lens 26, and a reflector portion 50. The phosphor portion 30 comprises a generally dome sectional shape that surrounds chamber 33. The lens 26 also comprises an exterior sectional profile having a dome shape. The reflector 50 is formed of any material that is capable of substantially reflecting light, and is intended to function by reflecting some or all of the phosphor-generated light from phosphor portion 30 away from the base of the component 21. In some embodiments, the reflector 50 comprises a white polycarbonate material.

However, unlike the previously described embodiments, the multi-layered optic component 21 does not include an optical medium portion 56. Instead, the multi-layered optic component 21 is manufactured to leave an open chamber 33 within the phosphor portion 30.

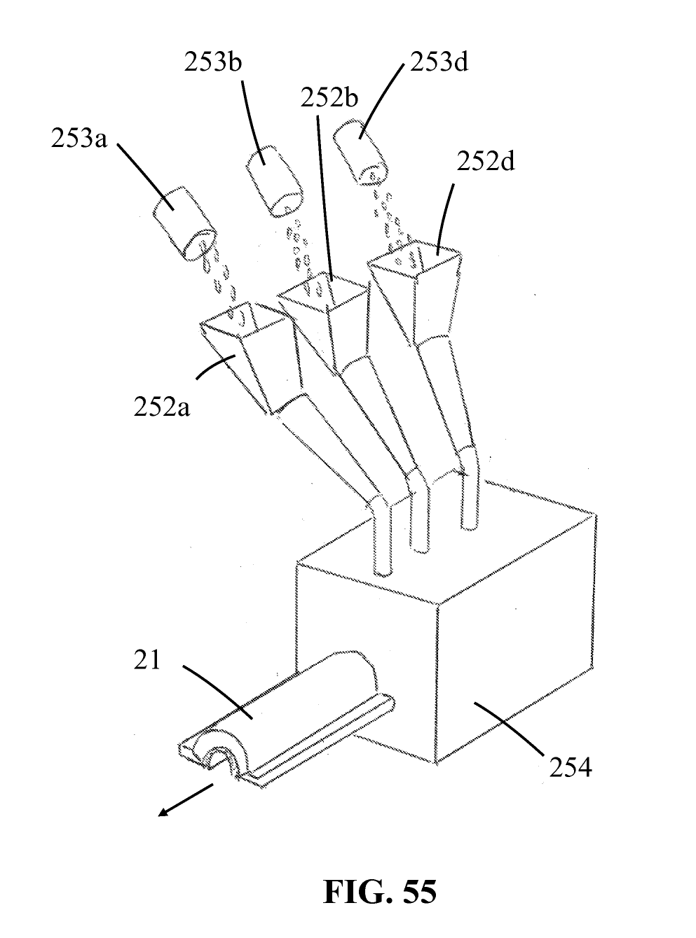

FIG. 55 illustrates a process for co-extruding the multi-layer conversion component 21. Multiple extruders feed into a single extrusion head 254 to create the component 21. The first extruder 252a processes the material 253a for the lens portion 26 of the white light module 230. A second extruder 252b processes the material 253b for the phosphor portion 30 of the white light module 230. Extruder 252d processes the material 253d for the reflector 50. Unlike the previously-described embodiments, extruder 252c is not provided in this embodiment to process material for the optical medium.

Returning back to FIG. 53, the next manufacturing step at 426 is to fill the cavity 33 with a liquid optical medium 255. The liquid optical medium 255 is provided in sufficient quantities to make sure that air gaps will not exist in the finished product.

At 428, the linear array of LEDs is attached to the multi-layer conversion component 21, where the LEDs themselves are received into the chamber 33 containing the liquid optical medium 255. At 430, the liquid optical medium 255 is cured, e.g., by using any appropriate method such as application of heat or UV light.

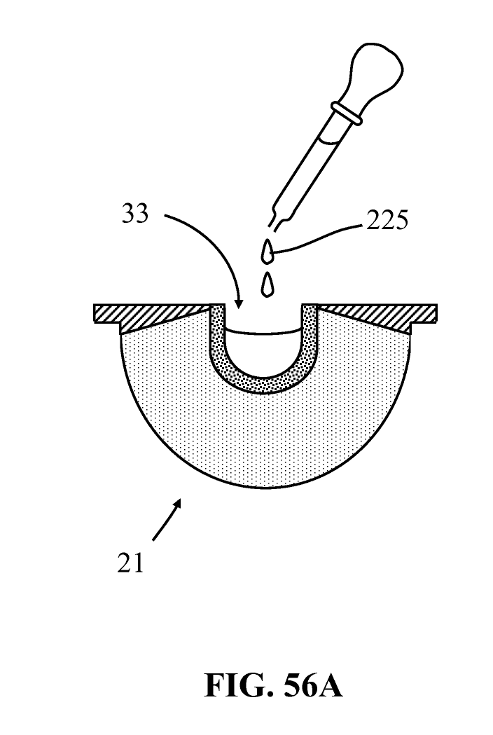

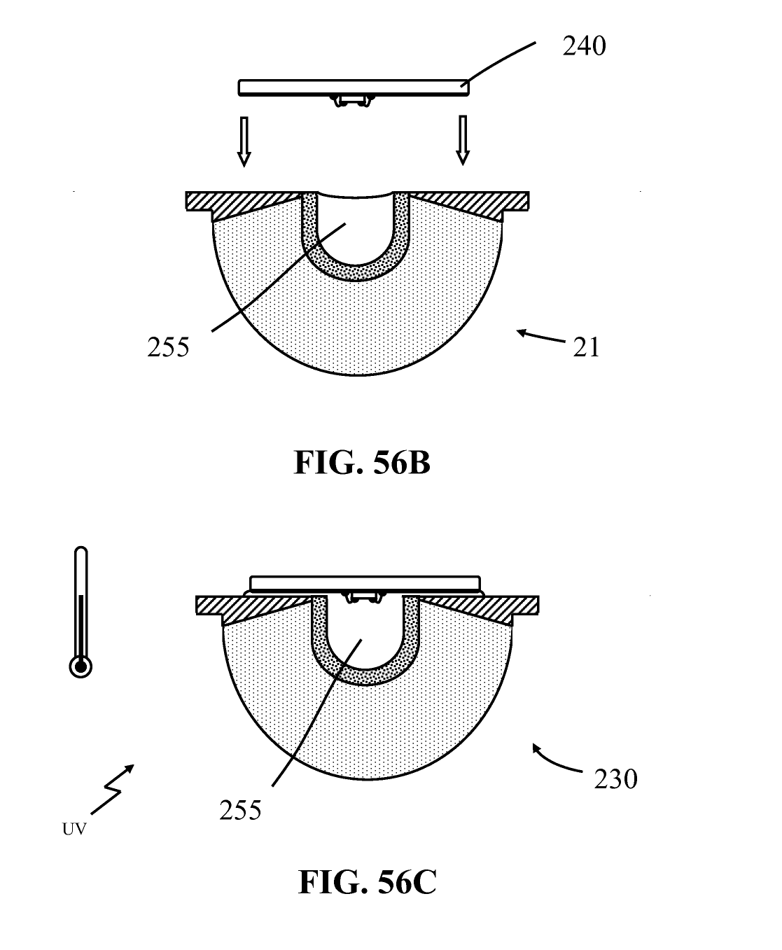

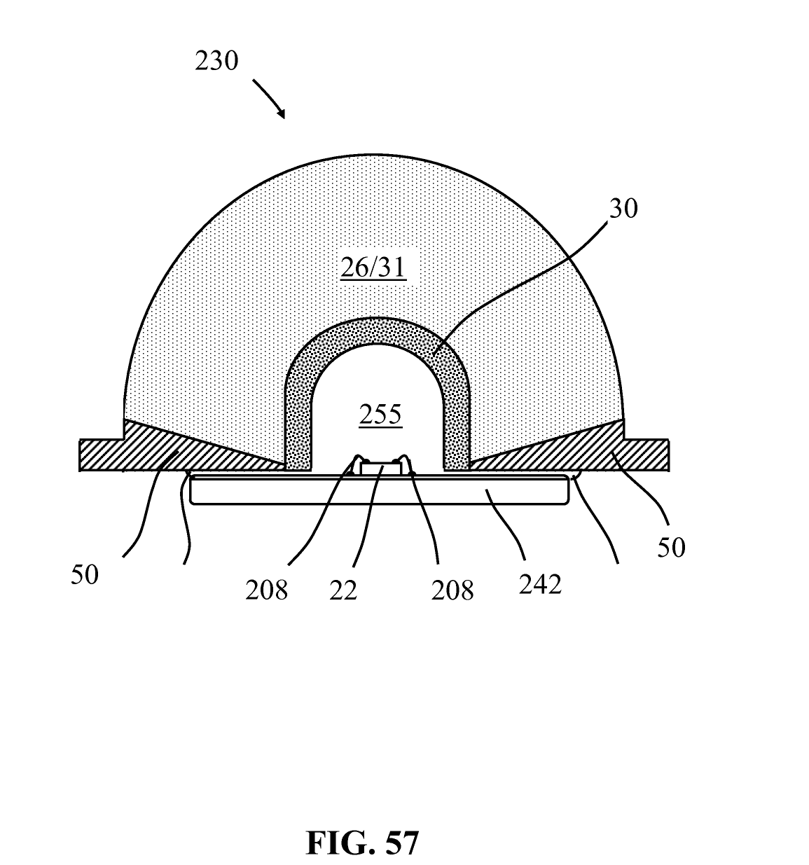

FIGS. 56A-C illustrate these assembly steps according to one embodiment. As shown in FIG. 56A, the liquid optical medium 255 is applied to the chamber 33 within the multi-layer conversion component 21. Next, as shown in FIG. 56B, the multi-layer conversion component 21 is attached to the array 240 of LEDs, where the LEDs 22 are received into the chamber 33 in the multi-layer conversion component 21. The final action illustrated in FIG. 56C is to cure the liquid optical medium 255. As before, this manufacturing approach results in a white light module 230 (e.g., as shown in FIG. 57) where the optical medium 56 provides the necessary material to eliminate air interfaces that exist between the LEDs 22 and the phosphor 30.

Inline testing may be employed using any of the above approaches to control and minimize variations in the final manufactured product. The approach of U.S. application Ser. No. 13/273,201, filed Oct. 13, 2011 describes an approach for implementing in-line process controls to minimize perceptible variation in the amount of photo-luminescent material that is deposited in the wavelength conversion components. The approach described in this co-pending application can be used in conjunction with embodiments of the present invention, and is hereby incorporated by reference in its entirety.

With a co-extrusion system, one possible approach to perform in-line testing is to mount a colorimeter or spectrometer that actively measures the product color while it was being extruded. This measurement tool would generally be mounted inline after the cooling bath and dryer but prior to cutting. The color measurement provides real-time feedback to the extrusion system which adjusts layer thickness by varying the relative pressures of the two extrusion screws. The phosphor layer is manufactured to be either thicker or thinner to tune the color of the product in real-time while the extrusion is taking place. This allows one to have single bin accuracy while being able to perform quality checks in real-time during the extrusion process. Similar inline testing could be used with printing and coating methods.

It will be appreciated that the present invention is not restricted to the specific embodiments described and that modifications can be made which are within the scope of the invention. For example although in the foregoing description reference is made to a lens the phosphor can be deposited onto other optical components such as for example a window through which light passes though is not necessarily focused or directed or a waveguide which guides, directs, light. Moreover the optical component can have many forms which will be readily apparent to those skilled in the art.

What is claimed is:

1. A method of fabricating a lamp module, comprising extruding an elongated wavelength conversion component onto an array of LEDs, wherein the elongated wavelength conversion component comprises a photoluminescent wavelength conversion material.

2. The method of claim 1, wherein the photoluminescent wavelength conversion material comprises a wavelength conversion layer of the elongated wavelength conversion component.

3. The method of claim 2, and further comprising co-extruding an optical component layer and an optical medium, the optical medium surrounding the individual LEDs on the array of LEDs.

4. The method of claim 1, wherein individual LEDs in the array of LEDs do not contain a package structure and/or wherein individual LEDs in the array of LEDs do not include integrated encapsulant over the individual LEDs.

5. The method of claim 1, wherein the array of LEDs comprises at least one of an array of LED dies on a flexible substrate or a chip-on-wire structure.

6. The method of claim 3, and comprising using multiple separate extruders to co-extrude materials of the wavelength conversion layer, the optical component layer, and the optical medium.

7. The method of claim 7, in which the materials operated upon by the extruders include at least one of PC-Polycarbonate, PMMA-Poly(methyl methacrylate), PET-Polyethylene Terephthalate, and thermoform plastics.

8. The method of claim 3, and further comprising co-extruding a light diffusive portion.

9. A lamp module fabricated according to the method of claim 1.

10. A method of fabricating a lamp module, comprising:
co-extruding an elongated optical component comprising a wavelength conversion layer, an optical component layer, and an optical medium, the optical medium comprising a channel for receiving LEDs;
applying a liquid optical medium;
assembling the elongated optical component to an array of LEDs; and
at least partially curing the liquid optical medium.

11. The method of claim 10, and comprising applying the liquid optical medium to the LEDs.

12. The method of claim 10, and comprising applying the liquid optical medium to the channel.

13. The method of claim 10, wherein individual LEDs in the array of LEDs do not contain a package structure and/or wherein individual LEDs in the array of LEDs do not include integrated encapsulant over the individual LEDs.

14. The method of claim 10, wherein the elongated solid body further comprises a light diffusive portion.

15. A lamp module fabricated according to the method of claim 10.

16. A method of fabricating a lamp module, comprising:
co-extruding an elongated optical component comprising a wavelength conversion layer and an optical component layer, wherein the elongated solid body comprises an interior chamber;
applying a liquid optical medium to the interior chamber;
assembling the elongated optical component to an array of LEDs; and
curing the liquid optical medium.

17. The method of claim 16, wherein individual LEDs in the array of LEDs do not contain a package structure and/or wherein individual LEDs in the array of LEDs do not include integrated encapsulant over the individual LEDs.

18. The method of claim 16, wherein the elongated solid body further comprises a light diffusive portion.

19. A lamp module fabricated according to the method of claim 16.
